(19) United States
(12) Patent Application Publication
(10) Pub. No.: US 2011/0052155 A1
(43) Pub. Date: Mar. 3, 2011

(54) METHODS FOR PRODUCING LOW-COST, HIGH-QUALITY VIDEO EXCERPTS USING AN AUTOMATED SEQUENCE OF CAMERA SWITCHES

(76) Inventors: Justin Desmarais, Montreal (CA); Tony Nimeh, Geneva, NY (US)

(21) Appl. No.: 12/552,875

(22) Filed: Sep. 2, 2009

(51) Int. Cl. H04N 5/00; G11B 27/00; H04N 5/93; H04N 5/77

(52) U.S. Cl. 386/290; 386/E05.003; 386/223; 386/280

(57) ABSTRACT

The present solution provides intelligent and effective systems and methods for meeting new people online for the purpose of social and business networking through the use of a video-based online usage platform. In various embodiments, the methods comprise intelligent and cost-effective processes for conducting interviews of clients, e.g., filming and producing of video clips demonstrating their personality, character traits, communications skill and other skills. In certain embodiments, the inventive systems provide for intelligent and cost effective production of video clips of a client being interviewed through a real-time automated video-production method. The online video networking system also provides an intelligent usage platform allowing the broadcasting of client-interview video clips and user-generated content online. Lastly, the video networking system comprises an intelligent usage platform providing for searching and browsing of online client-interview video clips and user-generated content.

### FIELD OF THE INVENTION

The present application generally relates to systems and methods for online social and professional networking. In particular, the present application relates to the production of high-quality video excerpts or profiles of interviewed clients. The systems and methods provide for meeting new people through posting an online profile or through searching and browsing other clients' online profiles.

### BACKGROUND

Networking can be an important and integral part of living in society. Networking is defined by Whatis.com as the practice of expanding the number of one's business and/or social contacts by making connections through individuals. Many personal and professional objectives necessitate the use of networking as a tool to enable the achievement of various goals and objectives. In brief, there are two main categories of benefits derived from networking: professional and personal. Professional goals and objectives necessitating networking as a tool include the following: career advancement, academic and business development, customer attraction and retention, productivity enhancement, profitability enhancement, transaction facilitation, new business creation and the rendering of goods and service. Personal goals and objectives necessitating networking as a tool include entertainment, discovering new aspects of life, learning about one's own self, feeling more connected to others and one's self, feeling more alive, finding a fulfilling romantic relationship, developing rewarding friendships, enhance one's reputation and presence in community, and make social contributions.

With the recent gain in use and popularity of the internet, there have been many attempts at solving the existing challenges of real-life networking through online means and tools. Given the lack of efficiency and direct means of communication inherent to real-life networking, and given the seemingly endless capacity of the internet to add value through higher efficiency, mass communication and direct interactions, many have attempted to solve real-life networking’ challenges with internet/online tools. Unfortunately, little success has been achieved so far from such attempts. Although many so-called networking sites have appeared over the past decade, many are ineffective at duplicating real-life situations nor improving the effectiveness and efficiency of real-life networking (on the basis of time required, energy required, skill required, need for intermediation, and cost).

### SUMMARY

The present solution relates to systems and methods for online professional and personal networking In various embodiments, methods and systems are described for stimulating a client (also referred to herein as a subject) to communicate through an interview or any other form of communication form (e.g. presentation, monologue, short answers to questions), and producing a high-quality client video of that client while communicating. The client video can be representative of a subject's appearance, personality, character traits, communications skill and soft skills. In various embodiments, the client video is produced through a real-time automated video production process. The client video can be provided to an online usage platform, which can provide for online broadcasting of the video and user-generated content. The usage platform can include a database comprising a plurality of client videos and user-generated content representative of multiple subjects. In various embodiments, the usage platform provides for online searching and browsing of client videos and user-generated content associated with the client videos.

In various aspects, the online video networking system 5 provides for intelligent and cost-effective systems and methods for conducting interviews of clients and forming client videos. In various embodiments, interviews include filming and producing a plurality of video segments of a client which can be viewed separately, edited, and/or combined with other video segments to form a video clip. In other embodiments, video clips are automatically produced by recording from a plurality of cameras at different time segments one camera feed at a time to produce one video clip that includes a plurality of camera feeds. A video clip can be representative of a client's appearance, presentation, personality, character traits, communications skill and soft skills. Plural video segments can be combined to form a client video.

A client interview can comprise a conversational interview for which the client pre-selects a series of conversation themes from a database comprising a set of categories, sub-categories, and themes. Each selected theme can be linked to a series of conversation topics by a system managing the database. In certain embodiments, the client is not exposed prior to an interview to conversational topics which are selected from the database for the client. Non-exposure to conversational topics beforehand can provide a level of spontaneity during an interview. The conversational topic can be submitted to the client for the first time during the interview, and the client asked to discuss the topic for a first selected period of time. The conversational topic can be selected at random by a topic selector in communication with the database. A plurality of multiple conversational topics can be submitted sequentially to the client to generate a conversation between an interview host and the client for a second selected period of time. Various aspects of the interview can be filmed and/or recorded. The recording and production of a client video can be automated. In some embodiments, the client video is editable and produced in part by the client, e.g., produced from a home computer via the internet.

Aspects of the online video networking system 5 include a cost-effective interview which provides the client with a host with whom to communicate and interact during the interview; comprises a conversational style interview to ensure a natural and comfortable conversation; customizes the conversational topics according to the client's interest by allowing the client to choose conversation themes and yet provides spontaneous conversation by submitting unknown topics to the client during the interview; minimizes labor costs associated with interview preparation by asking the client to choose conversation themes; provides for short interviews to improve efficiency of the process; and keeps the host's interventions to a minimum to allow more air-time for the client and ensure a high success rate of video clips despite randomness and automated generation of the video clips.

Although generally described as an Interview, the communication delivered by a client can take various shapes and forms and can be stimulated through different ways (e.g.: may be an interview, a presentation, a monologue, a prompted commentary, questions and answers, answers to pre-recorded questions, etc . . . )

In various embodiments, the online video networking system 5 includes systems and methods for filming and producing video clips of a client being interviewed through a real-time automated video production method. The video system may use a plurality of cameras having various angles and frames/zooms, switching between camera feeds during each video clips. The camera switches may be fully automated according to a pre-determined set of random sequence and duration of each switch according to a specific programmable set of principles, parameters, limitations, and guidelines described hereinafter. In some embodiments, the decision of when the switch occurs is unrelated to the actual content of the video. The automation of these camera switches resulting in the full automation of the production of video clip (e g taking the human element out of the decision of when a camera switch actually occurs) results in a significant cost reduction of producing such a video clips.

The automation of video clip production can comprise any combination of the following elements: using high-quality filming equipment, e.g., multiple high-quality cameras, quality lighting and quality sound capture; filming simultaneously with multiple cameras with multiple camera angles, frames and focuses; automatically producing video clips of an interview conducted with the client during a preselected period; beginning each video clip with an audio and video fade-in such that viewers have a smooth transition into the conversation despite a random start point of the video clip in an ongoing conversation, e.g., mid-sentence; ending each video clip with an audio and video fade-out such that viewers have a smooth transition out of the ongoing conversation despite a random end point of the video clip in the conversation, e.g., mid-sentence; executing automatic camera switches according to a switch database; starting each video clip with the feed from a first camera focused on the client's whole body to allow the viewer to gain a first impression of the client's body language; providing a second camera frame within a video clip which is fed from a second camera with a field of view of a client's face and shoulders, e.g., to allow the viewer to foster a sense of intimacy with the client through a better appreciation of the client's facial expressions; forming a video clip in which the total duration of feed from the second camera is greater than the duration of the feed from the first camera; executing camera switches over a selected camera-switch time interval which avoids rushed and abrupt aspects in the produced video clip; obtaining video from a selected camera over a selected camera-filming interval, the camera-filming interval selected to avoid loss of attention and/or loss of interest by a viewer randomizing camera switches so that the video appears non-automated to the viewer spacing video clips by a video-clip spacing interval to soften switching between topics and including in a produced interview video a plurality of video clips. In certain embodiments, the client chooses video clips to include in an interview video.

The online video networking system 5 further comprises an intelligent usage platform for production and management of client videos. The usage platform can comprise a computing or distributed computing system which can be in communication with any combination of the following networks: a local area network (LAN), a medium area network (MAN), a wide area network (WAN). In various embodiments, the usage platform provides for online distribution or broadcasting of client videos and user-generated content associated with client videos. The usage platform can include software applications which can be run on the usage platform or distributed and run on systems in communication with the usage platform. The usage platform can provide online searching and browsing of client videos and user-generated content. The usage platform can comprises one or more online servers which host databases of client videos and client-generated content. The servers can include web portals permitting, through restricted access, manipulation and customization of client data stored on a server.

In various embodiments, the online video networking system provides for an intelligent and cost effective method for conducting interviews of clients, and for filming and producing video clips demonstrating their personality, character traits, communication skills, and soft-skills. In some embodiments, a conversational interview style is used during the client interview. In some embodiments, a topics-driven interview style is used wherein topics to be discussed are submitted to a client. In some embodiments, the topics submitted to the client during the interview are assigned to the client according to themes selected by the client on an online web portal, which are the result of a themes selection method. In some embodiments, a client chooses from an online web portal a series of conversation themes, to be discussed at a client interview, by selecting one category from a series of available categories, then one subcategory from a series of subcategories included in the selected category, then one theme from a series of themes included in the selected subcategory. In some embodiments, the themes selected by a client prompt an automated and random system selection of one conversational topic for each conversation theme selected by the client. In some embodiments, the system-assigned conversational topics are labeled by a unique identifying code that can be recognized by a computer to allow the computer to display the topic to be submitted to the client during the interview.

In some embodiments, a database of conversation topics is located on an online-accessible server organized by (a) conversation categories, (b) conversation sub-categories and (c) conversation themes, and is used to choose conversation topics to be submitted to a client during the client interview. In some embodiments, there is a series of conversation categories each comprising a series of subcategories, a series of conversations subcategories, each comprising a series of themes, and a series of conversations themes, each comprising a series of conversational topics.

In some embodiments, a topic is an affirmative statement to which there is no right or wrong answer, designed to trigger a conversation or discussion, such as the telling of a story, the sharing of opinions or views, the relating of an experience, or the sharing of thoughts related to the submitted topic. In some embodiments, the conversation categories are broad in scope and encompass most possible human conversations and are based on human needs and interests. In some embodiments, the conversation subcategories are broad in scope and encompass most possible human conversations related to a specific category, based on human needs and interests. In some embodiments, the conversation themes are broad in scope and encompass most possible human conversations related to a specific subcategory and based on human needs and interests. In some embodiments, the interview format comprises submitting a series of conversation topics to a client and in asking the client to discuss each conversation topic for a predetermined amount of time, e.g., about one minute. In some embodiments, the client interview comprises a short interview, e.g., lasting about 5 minutes in duration.

In some embodiments, a database of conversation topic codes and matching conversation topics is accessible from a video studio computer for the purposes of displaying the client-assigned topics to the interview host. The topic codes generated by the system can be used by the interview host to determine and display conversational topics assigned to the client according to the themes chosen by the client. In some embodiments, the interview host reads from a computer screen the interview topics one at a time, leaving the client a predetermined amount of time to discuss each topic. In some embodiments, no host is provided and the system is fully self-serve (e.g. the client scans his own barcode), such as a kiosk. In some embodiments, the client reads directly from an on-screen display the topics being displayed one at a time or all at once. In some embodiments, the system plays a recording of the topics to the client. In some embodiments, a pre-recorded virtual host serves the topics to the client in a sequential manner.

In some embodiments, the system of conducting interviews comprises a local video studio where clients have to travel to and undergo an interview for the purpose of producing a series of video clips. In some embodiments, the client schedules an appointment for the production of the video clip. In other embodiments, the client may not need to schedule an appointment. In some embodiments, the client may not need to travel to a studio and may undergo the process from home using on-server or downloadable applications.

The video studio can comprise microphones used to transmit the client's voice during the interview, cameras to transmit video footage of the interview where one camera's frame is focused on the client's overall body and another is focused on the client's face. The video studio can also comprise a computer to receive the feeds from cameras and microphones, a screen to display information from the computer, furniture to allow a comfortable disposition for the client and the interview host, a background décor to ensure an aesthetically pleasing background for the interview. In some embodiments, the client being interviewed is positioned facing the cameras and the host.

In various embodiments, the video networking system provides for an intelligent and cost effective system for producing video clips of a client being interviewed. In some embodiments, the system comprises an intake method for receiving multiple audio and video feeds into a computer from multiple sources including multiple camera feeds for video intake to the computer where the cameras are connected to the computer via a fire wire cable, a USB cable or any other connection method available between a camera and a computer (e.g. Serial Digital Interface-BNC, Display Port, High-Definition Multimedia Interface—HDMI, Digital Visual Interface—DVI, Mini-DVI, Micro-DVI, Component Video, Open LDI, VGA, S-Video, Composite video, SCART, CGA, MDA, HGC, EGA). The system can further include multiple microphone feeds for audio intake to the computer via audio cables or any other connection method available between a microphone and a computer. In some embodiments, the video production system comprises a database comprising the duration of camera switches, e.g., time durations for capturing video segments during an interview session. The database can further include information for a video production sessions, where a production session comprises the series of video clips produced for one client. In some embodiments, the duration of recording of each audio-video feed and video segment for each video clip in each session is specified in the database. In certain embodiments, the duration of each pause following the sequence of frames and switches to separate the recording of two sequential video clips is also specified in the database.

In some embodiments, the video production system comprises an automated effective and cost-efficient video clip generation system where several video clips are produced from the filming of several excerpts of a short client interview, e.g., an interview lasting about 5 minutes. Each video clip produced may include part of one or more topic discussions generated by submitting a series of topics to the client.

In some embodiments, the video production system includes a predetermined delay before the start of the production of the first video clip. In some embodiments, the real-time production of short video clips comprises capturing a video clip for a duration range of about 20 to about 45 seconds. In some embodiments, the audio-video recording of feeds from cameras and microphones occurs according to a switching database where the duration of feed recordings is stipulated in the database.

In some embodiments, each video clip begins with an audio and video fade-in to allow for the viewers to have a smooth transition into the conversation despite a random start point of the video clip in the conversation, e.g., a video clip could start mid-sentence, and to allow for the automated random start and end point of a video clip. In some embodiments, each video clip ends with an audio and video fade-out to allow for the viewers to have a smooth transition out of the conversation despite the random end point of the video clip in the conversation, e.g., a video clip could end mid-sentence, and to allow for the automated random start and end point of a video clip.

In some embodiments, the recording of feeds is channeled through and controlled by a camera switching system, which is controlled by the video production software and associated settings. In some embodiments, the video production system includes a camera switching system allowing for the recording of sequential audio-visual feeds for pre-determined durations to produce video clips in real-time comprising several camera switches within each video clip. In some embodiments, the switches database is designed such that a video clip starts with the feed from the camera focused on the whole body to allow the viewer to gain a first impression of the person's body language as a whole. Subsequently, the second camera frame within a video clip is the feed from the camera focused on the face, to allow the viewer to foster a sense of intimacy with the client through a better appreciation of the client's facial expressions. In some embodiments, the total duration of feed from the camera focused on the client's face is of greater duration than the duration of the feed focused on the overall body of the client given the importance of facial expressions when assessing personality traits. In some embodiments, each switch should not be shorter than about 5 seconds to avoid giving the viewer a rushed and abrupt experience; and each switch should not be longer than about 20 second to avoid loss of attention and loss of interest from the viewer's part. In some embodiments, switches occur in an apparently random manner so as to seem un-automated to the viewer.

In some embodiments, the video production system comprises a system of adjusting settings that control the video production software such as: fade-in and fade-out rate and duration; delay duration between the code reading and the beginning of the first video clip; number of video clips per session; video and audio recording bit-rate; selecting the switches database to be used; the topics database to be used, the logo file to be used.

In some embodiments, the video production system includes a host that operates the video production software in an efficient and effective method including launching the video production software application; scanning a V-ticket to read a code presented in the V-Ticket by the client; reading topics displayed on the computer screen; and closing the application. In some embodiments, the client controls and operates the video production software. In some embodiments, the video production system includes a system for displaying the conversation topics assigned by the system and coded by topic codes on the computer screen to enable the interview host to read them to the client during the interview. The conversational topics can be determined by scanning the V-Ticket with a code reader; matching the topic codes with the corresponding topics by the video production software accessing the topics database; and displaying topics on the computer screen to be read by the host.

The video networking system also provides for an intelligent usage platform providing for the broadcasting of client interview video clips and user generated content online. In some embodiments, the usage platform includes an initial online registration process for clients prior to the interview and video production process; creation of online client profile for each client comprising an assigned unique user identification number as well as personal information such as name and email address; uploading of video clips of a client produced at a video studio; creation of a printed communication instrument between an online server hosting the usage platform and the local video studio to allow for client identification at the video studio; enabling the labeling of the produced video clips and communication to the interview host of the topic codes assigned by the system according to conversation theme selection by the client to enable the host to display the assigned topics on the computer screen and read them to the client to stimulate a conversation during the interview. In some embodiments, the registration process occurs after the production of the video clips and is linked to a user identification number assigned during the video production process.

In some embodiments, the usage platform makes use of a printed communication vehicle, e.g., a V-ticket (Video Ticket), which is produced by the usage platform following the online conversation theme selection process by the client and which contains written content information as well as a code, e.g., a barcode. In some embodiments, the written content information comprises the client name; themes chosen by the client; studio location information; instructions to client related to the overall process and next steps to be taken by the client; topic codes; a unique user identification number assigned to the user; and client video studio visit number. In some embodiments, the code encodes the client name, the unique user identification number assigned to the client, a client video studio visit number, and the topic codes.

In some embodiments, the usage platform provides for embedding client video clips into a client online profile using an identification method for the matching of video clips with the appropriate client online profile using the client identification number. The usage platform can further provide for labeling of produced video clips and other personal information.

The video networking system also provides for an intelligent usage platform providing for the searching and browsing of online client interview video clips and user-generated content. In some embodiments, the usage platform comprises a web-based technical platform allowing for information and file storage as well as the operating of applications related to a website for the enabling of the operations related to the searching and browsing of online profiles and videos. In some embodiments, the system comprises a website or web portal accessible online by users and administrators and a server allowing for the hosting of a website, databases, multimedia files, video clips, and other information and data. In some embodiments, the usage platform comprises a registration process for new members where the client enters full name, email address, password, and the system generates a unique user identification number for the client

In some embodiments, the client selects several conversation themes to guide the conversation during the in-studio client interview, whereby for each theme, the client chooses a conversation category from the topics database according to client's interests and preferences, then chooses a conversation subcategory from a series of subcategories linked to the category chosen, from the topics database, then chooses a conversation theme from a series of themes linked to the subcategory chosen, from the topics database.

In some embodiments, the usage platform provides functionalities for companies, professionals or students to post and search business networking content in an online profile. In some embodiments, the usage platform provides functionalities for individuals to post and search personal networking content for social relationships and dating purposes.

In some embodiments, the usage platform provides for accessing key functionalities online according to privacy settings, such as searching by name or other key words, sending messages. In some embodiments, the usage platform allows pre-authorized invitation acceptance to avoid the need to accepted a large number of network invitations from other clients/members by specifying the domain name and company name of members whose initiation to join a specific type of network is to be automatically accepted by the system. In some embodiments, the usage system allows sending multiple invitations to avoid the need to send a large number of network invitations to other clients/members by automatically sending invitations to join a client's network to all clients having an email address with a specific domain name or at a specific company.

In some embodiments, the usage platform provides for uploading of user generated content, and user generated media files. In some embodiments, the usage platform provides for public profile viewing, professional profile viewing according to which professional networks the client belongs, and private profile viewing according to which private networks the client belongs.

### BRIEF DESCRIPTION OF THE DRAWINGS

The foregoing and other objects, aspects, features, and advantages of the present invention will become more apparent and better understood by referring to the following description taken in conjunction with the accompanying drawings, in which:

FIG. 1A is a block diagram of an embodiment of a client video production system;

FIG. 1B is a block diagram of an embodiment of a client video production system;

FIG. 1C is a block diagram of an embodiment of a registration module;

FIG. 1D is a representation of an embodiment of a conversation themes selection module;

FIG. 1E is a block diagram of an embodiment of a topics database;

FIG. 2A is a block diagram of an embodiment of a studio for producing video clips;

FIG. 2B is a block diagram depicting a camera setup according to one embodiment of the client video production system;

FIG. 3A is a representation of the production of V-tickets according to one embodiment of the client video production system;

FIG. 3B is a representation of a Barcode production process according to one embodiment of the client video production system;

FIG. 3C is a block diagram of an embodiment of information contained in a V-ticket;

FIG. 3D is an illustrative example of the layout of a V-ticket;

FIG. 4A is a block diagram of an embodiment of a client video production system;

FIG. 4B is a block diagram of an embodiment of a camera switching system;

FIG. 4C is a representation of an embodiment of video clips generation;

FIG. 4D is a block diagram of an embodiment of a camera switch sequencing database;

FIG. 4E is a representation of an embodiment of video production software;

FIG. 4F is a block diagram of an embodiment of video production settings;

FIG. 4G is an illustrative example of user-interface screens for the video production system;

FIG. 4H is an embodiment of a user-interface screen for the video production system;

FIG. 5A is a block diagram of an embodiment of a usage platform;

FIG. 5B is a block diagram of an embodiment of a usage platform according to client type;

FIG. 5C is a block diagram of an embodiment of a usage platform according to basic functionalities;

FIG. 5D is a block diagram of an embodiment of a usage platform according to client type;

FIG. 5E is a an illustrative example of a user-interface screen for privacy settings;

FIG. 6A is a flow diagram of a method for producing client videos according to one embodiment of the client video production system;

FIG. 6B is a flow diagram of steps practiced by a client according to one embodiment of the client video production system;

FIG. 6C is a flow diagram of a method for producing client videos according to one embodiment of the client video production system;

FIGS. 7A and 7B depict block diagrams of embodiments of computing devices; and

FIG. 7C is a block diagram of an embodiments of a networked computing environment.

The skilled artisan will understand that the figures are for illustration purposes only. It is to be understood that in some instances various aspects of the invention may be shown illustrated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

The features and advantages of the present invention will become more apparent from the detailed description set forth below when taken in conjunction with the drawings.

### DETAILED DESCRIPTION

### I. Introduction

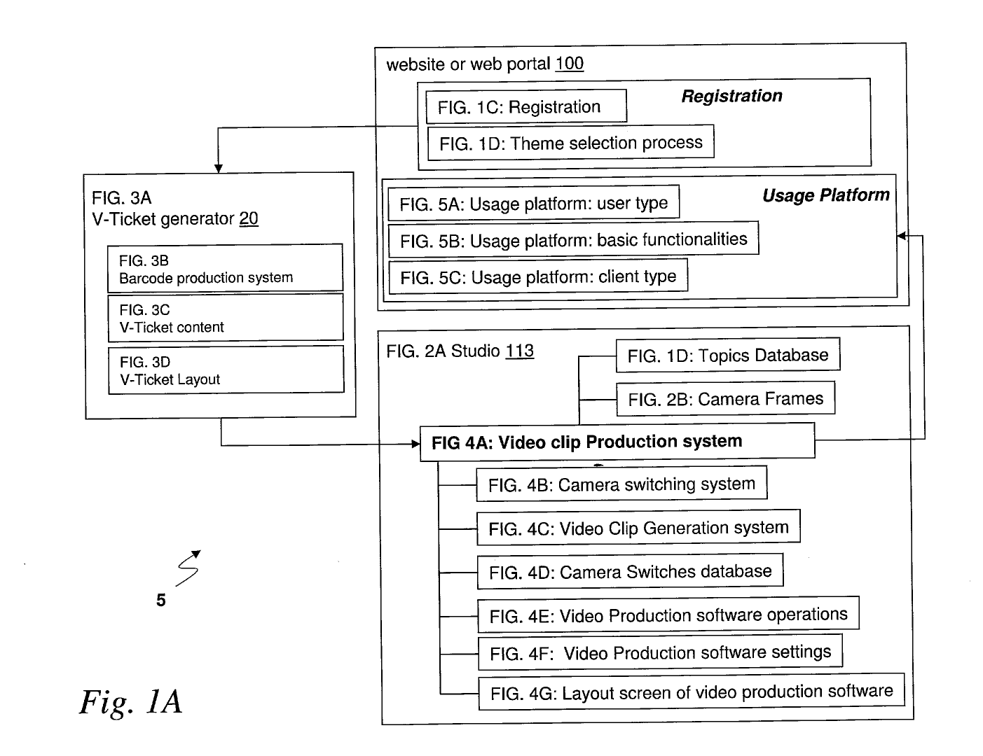

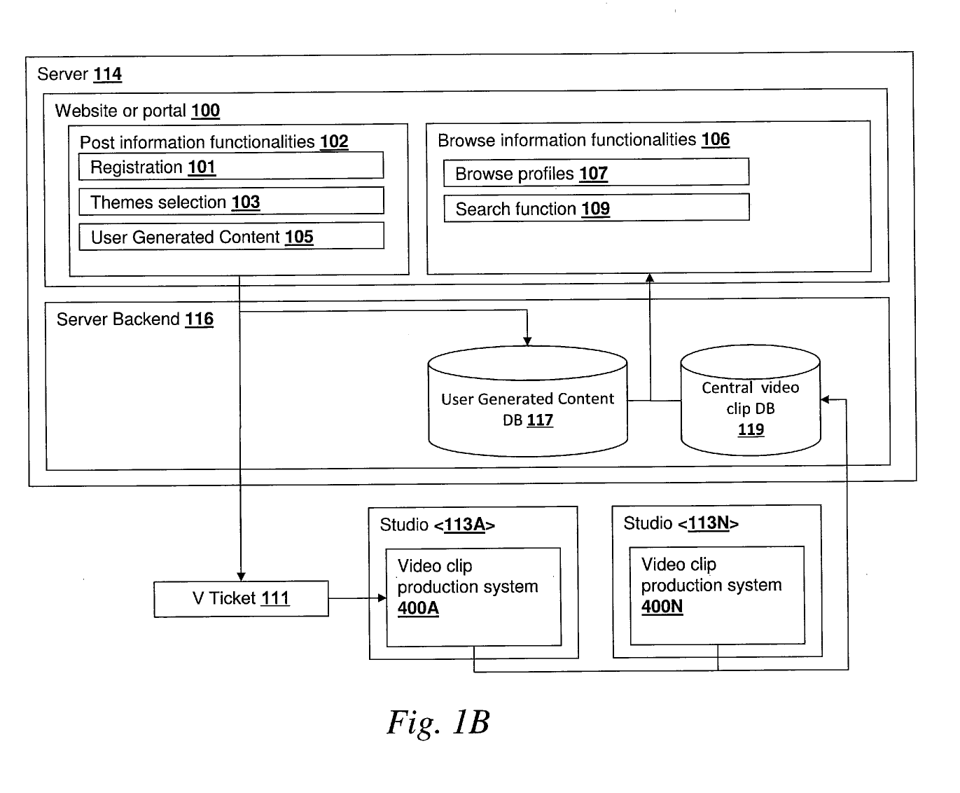

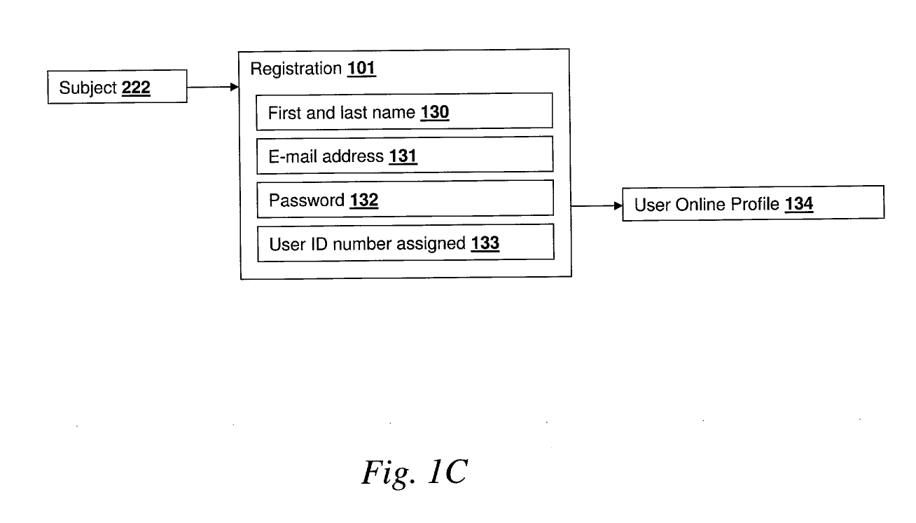

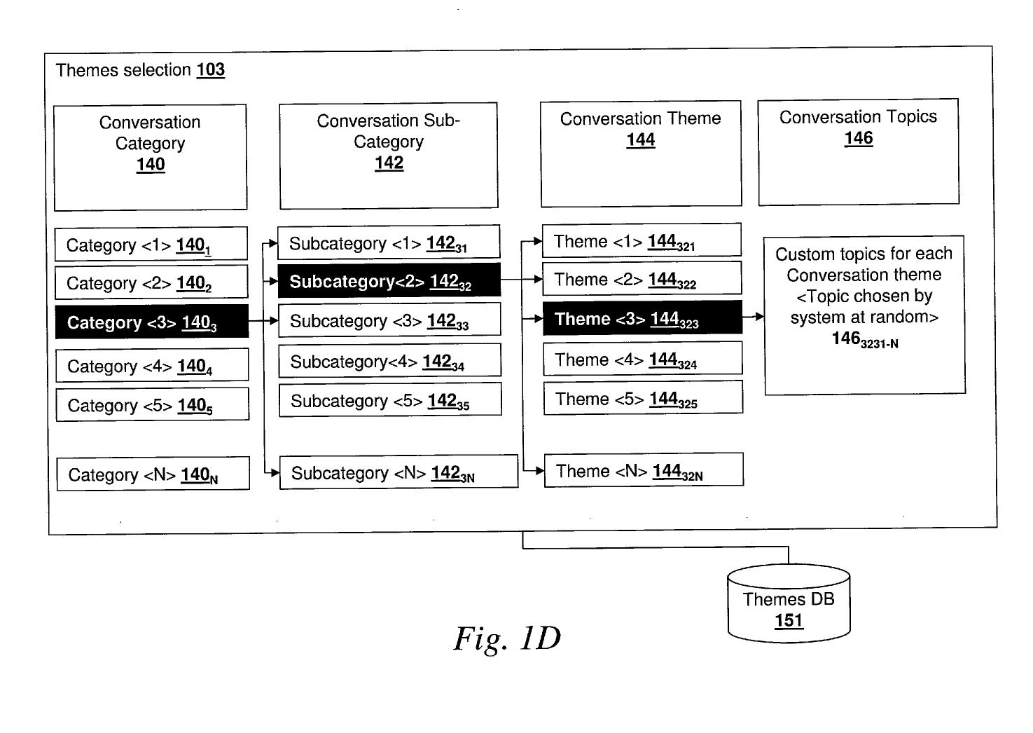

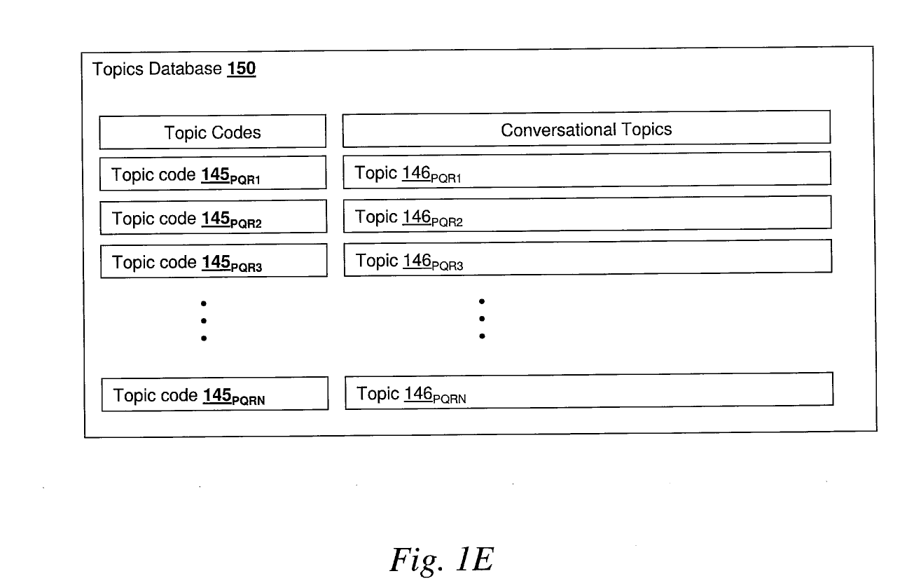

Referring now to FIG. 1A, embodiments of the present solution relates to the automated production of high-quality video representations of clients for purposes of professional or personal networking The online video networking system 5 comprises systems and methods for producing, managing and distributing client videos and client-generated content.

In certain embodiments, the online video networking system 5 provides for intelligent and effective meeting of new people online for the purpose of social and business networking through the use of a video-based online usage platform. The online video networking system 5 can provide for an intelligent and cost-effective method for conducting interviews of clients for the filming and producing of video clips demonstrating their personality, character traits, communications skill and soft skills. The online video networking system 5 can also provide an intelligent and cost effective system for producing client videos through a real-time automated video production method. The online video networking system 5 can provide an intelligent usage platform providing for the broadcasting of client interview video clips and user-generated content online. Additionally, the online video networking system 5 provides an intelligent usage platform allowing the online searching and browsing of client videos and client-generated content.

Certain illustrative embodiments of the online video networking system 5 are described below. It is, however, expressly noted that embodiments of the present solution are not limited to these embodiments, but rather the intention is that the additions and modifications to what is expressly described herein also are included within the scope of any of the inventions herein. Moreover, it is to be understood that the various embodiments described herein are not mutually exclusive and can exist in various combinations and permutations, even if such combinations or permutations are not expressly made herein, without departing from the spirit and scope of the invention.

These illustrative embodiments of the automated video production system and usage platform described herein provide a comprehensive system for intelligent, high quality and cost effective production of video clips of clients for the purpose of online networking In one illustrative embodiment, the system allows clients to obtain a high quality video of themselves and publish the video on the internet via a usage platform. The client video production system can be used for self-promotion purposes in corporate, professional or personal contexts. In certain embodiments, the system allows clients to search for and browse the video clips and profiles of others on the internet.

### II. Interpersonal Networking

It would be appropriate at this point to examine the intricacies of real-life networking psychological dynamics and to attempt to evaluate why existing online tools have not been successful at delivering the promised value.

Although beneficial in virtually all spheres of life, there are four main challenges to networking: (1) time required (2) energy required (3) skill required, and (4) need for intermediation. Networking is a time- and energy-consuming activity and a challenging art to master. One important challenge in meeting new people with a specific set of characteristics is the need to leverage an already existing network of known people through whom the unknown people can be met. The already known people must act as intermediaries to meet new people. Such an intermediated referral system can be time and resource intensive, with no guarantee of success. For example, if John knows Mary and Mary knows Luc, John would need to ask Mary to introduce him to Luc if John wants to meet Luc. In a context where many new people are to be identified and met in a short period of time, such a referral system is not an appropriate tool since the system is not well adapted to efficient and direct communication.

Alternatively, there are contexts in society where such introductions are forgone, such as professional networking events, social gatherings, parties, and gatherings of people with common interests. At such events, one can approach unknown people without a reference from an already known person. Although such professional events are effective at meeting new people belonging to a specific professional group or with common interests, they only occur relatively occasionally. Furthermore, they are time and energy intensive since they require travel and a certain time commitment to the exclusion of any other activities, e.g., professional networking events can last for two or three days at a time.

### II.A. Real-Life vs Online Networking

With the recent gain in use and popularity of the internet, there have been many attempts at solving the existing challenges of real-life networking through online means and tools. Given the lack of efficiency and direct means of communication inherent to real-life networking, and given the seemingly endless capacity of the internet to add value through higher efficiency, mass communication and direct interactions, many have attempted to solve real-life networking’ challenges with internet/online tools. Unfortunately, little success has been achieved so far from such attempts. Thus although many so-called networking sites have appeared over the past decade, we do not believe any are very affective at duplicating real-life situations nor improving the effectiveness and efficiency of real-life networking (on the basis of time required, energy required, skill required and need for intermediation).

### II.A.1. Real-Life Networking

To gain a better understanding of the gaps that remain to be filled by the current value proposition of online networking media, the basic psychological dynamics integral to meeting a new person in a networking context are described in detail. We have observed and concluded that there are three important sequential steps that occur when a person <A> meets a previously unknown person <B> for networking purposes: step (1) Person <A> evaluates person <B>; step (2) Person <B> evaluates person <A>; and step (3) Persons <A> and <B> explore potential opportunities that could be beneficial to both.

Step (1): Person <A> evaluates person <B> All human interactions are built upon a base of interpersonal affinity. Without such affinity, there is little chance that there will be a long-lasting interaction of any type. For this reason, prior to approaching person <B>, person <A> commonly engages in a short passive observation of person <B> that may last a few seconds. The purpose of this initial period of passive observation is to form a personal opinion about person <B> based on a multitude of factors including general appearance, communication skills, apparent professional competence and thought clarity and self expression. In short, Person <B>'s soft-skills are being assessed by person <A> to determine weather or not there is the potential foundation of personal affinity for a future relationship to flourish. If person <A> assesses that there is little chance for personal affinity, he/she may abort the process and scan the room for another potential person to meet. If the answer is <yes>, person <A> may approach person <B> to proceed to the next step: Person <A> approaches person <B> to initiate conversation.

Step (2): Person <B> assesses person <A> When person <B> is approached by person <A>, he/she will engage in the same assessment process as previously described in step (1). Although person <B> does not have the luxury of a passive and focused observation period, he/she nevertheless attempts very quickly to assess person <A>'s personality, character and soft-skills. The result of this evaluation will determine the ultimate outcome of the conversation. If person <B> concludes that there is little chance for personal affinity with person <A>, he/she will most probably shorten the initiated contacted and re-direct attention to someone or somewhere else. However, if person <B> assesses that there is a baseline of personal affinity, he/she will deepen the conversational engagement to proceed to step (3)

Step (3): Mutual acceptance and search for collaboration If both persons <A> and <B> find that there is a baseline of personal affinity based on their initial character evaluations, the conversation would progress through the sharing of increasingly important and interesting content elements to explore the potential for collaborative opportunities. Although such a conversation would remain abridged in the context of a professional networking event, the conversation is nevertheless an important exchange that will probably be continued at a later point in time. As such, contact information are exchanged the successful meeting is concluded.

It is important to note that in real-life situations, although personal affinity assessments are extremely important, they tend to be very short in duration, lasting merely a few seconds; hence the classically quoted importance of the first four seconds when meeting someone for the first time.

### II.A.2. Online Networking

Having described above the basic step-wise dynamics inherent to meeting a new person at a networking event, we can now examine the challenges faced by the current online networking media.

Step (1): Person <A> attempts to assess person <B> Most online social networking websites offer their members to post information about themselves as well as media content such as pictures (user-generated content). When person <A> attempts to assess the potential for affinity with person <B>, he/she is challenged by the inability to make such an assessment. There is simply too little information available to perform such an evaluation. Person <A> is confronted with two choices: either approach person <B>, e.g., send an email, despite insufficient information to make a proper assessment of personal affinity or abort the process. Naturally, there is inherent risk in proceeding with the process: of initiating contact despite the lack of personal affinity may result in time waste and unpleasant surprises. These outcomes may often be related by people who try online dating and job-hunting. Such experiences may limit the value proposition delivered by modern-day online dating and job-hunting sites.

Most often however, people limit themselves to interactions with people with whom they have a prior real-life relationship, i.e., people they already know before seeing them online. For example, LinkedIn's policy explicitly asks its members not to contact people with whom they have no prior relationship. LinkedIn's User agreement includes the following statement “Don't invite people with whom you have no prior relationship to join your network’. (See www.linkedIn.com User Agreement, Section 11, LinkedIn User DOs & Don'ts.) Facebook members also generally limit themselves to interacting online with people they already know in real-life rather than meeting people online for the first time.

For the sake of this exercise, let us examine what happens if in fact person <A> decides to contact person <B> despite the lack of information needed to form a proper character evaluation: step (2).

Step (2): Person <B> attempts to assess person <A> When Person <B> is contacted online by a previously unknown person, he/she will attempt to perform an evaluation of person A through reading person <A>'s email, reading his/her profile information and viewing his/her pictures. Five possibilities may occur at this point in time: Person <B> may (i) correctly assess that there is no affinity, (ii) correctly assess that there is affinity, (iii) incorrectly assess that there is no affinity, (iv) incorrectly assess that there is affinity, or (v) not form an assessment because of lack of information.

Even in the case where there actually is affinity between persons <A> and <B>, there are significant chances that the encounter might not occur depending on person <B>'s risk tolerance level might be too low to actually proceed to next steps. Furthermore, given the lack of information, person <B> may decide to abort the process due to an incorrect evaluation.

In most cases, online media have not succeeded in consistently providing enough information to people about other people such that they could perform a satisfactory character and personality evaluation and assess weather or not there is personal affinity. Given that personal affinity is the foundation of human relationships and interaction, the inability to assess affinity is a significant barrier that prevents people from meeting others online for the first time. To this day, most online networking platforms serve as tools to communicate with an existing network more efficiently and effectively through leveraging the scaled communication flexibility allowed by the internet. However, there is no effective scaled manner of meeting people for the first time online yet.

### II.B. Attributes and Shortcomings of Online Networking

The current online networking sites leverage the internet to deliver a value proposition focused on mass communication with, and management of one's already existing network. Such online networking attributes can be a compelling and powerful value proposition, because of the significant organizational skills normally required to manage one's network. These communication and management capabilities were not available to lay people prior to wide use of the internet. Therefore, the main value proposition of the current online networking sites is relationship management: the improved management and communication of an already existing network.

The term “networking” has recently been freely used to mean communicating with one's already existing network as well as expanding one's network by meeting new people. Such an amalgamation is unfortunate because it leads to diluting the important and distinct value proposition of meeting new people. For example, calling Facebook a social networking website prevents the acknowledgment that although Facebook is effective for communicating with people a user already knows, Facebook is sub-optimal for creating new connections and meeting new people. The actual value proposition of Facebook is not “networking” (creating a new network) but rather relationship management. The current online players in networking are limited to employment websites such as monster.com and dating websites such as match.com. Such websites aim to connect people that do not have a previously existing relationship. The effectiveness and efficiency of such players is sub-optimal given the tools they use to help people make a character assessment of unknown individuals, e.g., self-generated text and photos by users.

Over the past five to ten years, many advances and innovations took place in online communication and services. Despite these advances, there remains a significant gap in the ability of online media to replicate real-life networking. Online tools could replicate real-life networking and eliminate some of the challenges inherent thereto (time required, energy required, skill required, and need for intermediation) would be of great value to society given the added advantages afforded by online tools such as instant and direct mass communication.

The main reason for the shortcomings of online media is the inability to respect basic psychological elements and dynamics inherent to the networking process. The main goal of networking is to build a network, i.e., a web of connections between oneself and others that could be leveraged for various purposes (personal or professional). Building such a network entails meeting individuals that possess specific qualities and attributes, that are unknown to oneself; thereby adding them to one's network. The current state of the art in online social networking falls significantly short of allowing the effective building of such a network.

Although the mainstream online social networking websites do not offer an effective way of meeting unknown people, job hunting sites such as monster.com and dating sites such as match.com attempt to provide such a value proposition but they are often unsuccessful in providing users with an accurate impression of the unknown person to be met. Failure to provide an accurate impression often leads to the need for meeting in person people that have been initially contacted online to perform a personal affinity assessment. The online website therefore serves as a platform for an initial contact, but does not fulfill the personal affinity assessment, which leads to meeting several people in person before finding a person with whom there is personal affinity which causes much time and energy loss. Such an online networking process is often more inefficient than real-life networking

As an example, managers seeking new employees may interview many candidates found on monster.com in the hope of finding one with whom there is potential for personal affinity in addition to professional competence. A lengthy interview process can take up to six months or more and cost both time (interview time) and opportunity cost (unfilled position). If there was a way of screening potential candidates directly online for personal affinity before an interview is scheduled, less time would be wasted on inviting and meeting with non-compatible candidates and the interviewing success rate would be higher. Managers lack an effective tool that would allow them to directly make a decision based on their assessment of a candidate in a short and concise manner. Such challenges and inefficiencies lead to a multitude of inefficient and costly alternatives, such as resorting to head-hunters and specialized recruiting agencies that impose a significant financial burden on companies.

In another example, singles may go online to meet new people. Much time and effort is spent on attempting to make an assessment of the personality traits and character of a potential candidate by reading user-generated-content (UGC) that the user has himself/herself posted online. Such information is inherently biased and even when the information is objective, the information rarely allows for a personality assessment to be made. Posting pictures is now the norm on many dating websites to give an initial impression of the physical appearance of the potential candidate. However, pictures are not and adequate medium for providing personality and character information and may mislead the viewer, leading to a wrong first impression. Both quality and quantity of information contained in pictures is limited. In fact, in many instances people cannot be recognized in person despite having shared their picture online. Furthermore, pictures simply cannot provide any information about what a person “feels like” in real-life. A person's personality cannot be captured by a still camera. Personality traits can only be communicated through a dynamic interaction the person may have with another. Only through a dynamic interaction can such things as thought reactions, mannerisms, speech patterns, facial expressions, attention span, and body language be assessed.

### II.C. Online Networking Incorporating Videos

Recognizing the limitation of photography, some have made initial attempts at using videos as a means of communicating an impression of who they are to others online. There are two main categories of attempts made so far with video technology for networking and self-promotion purposes: (1) non-professional attempts (home-made videos) and (2) professional attempts. The advantages and disadvantages of each are discussed in the sections that follow.

### II.C.1. Non-Professional Videos

Non-professional attempts at making a video of one's self generally use often less effective and sophisticated means of making a self-produced video clips with the help of a webcam or a camcorder. Such attempts are often unsuccessful at achieving the desired effects because of four potential reasons: (a) sub-optimal equipment, (b) lack of interviewer, (c) low-quality production process, and (d) sub-optimal content.

### II.C.1.a. Sub-Optimal Equipment

First, the quality of the camera used significantly impacts the video clip quality. A non-professional camera or a webcam gives a low-quality capture of images which results in a low-quality video. The video quality significantly impacts the impression given by the user to the viewer. Additionally, in most non-professional contexts, only one camera is used rather than multiple cameras. The lack of different angles, focuses and zooms has a significant impact on the quality of the video clip. In professional productions, multiple cameras are used to mimic the natural tendency of the brain to assess a client from different angles and zooms to accumulate enough data and compute an overall impression of the client being evaluated. The lack of multiple angles limits the information being gathered. For example, a large frame is needed to capture the body of the client. Such frame is important because the view allows the assessment of body language being communicated during the observed interaction. However, a body frame does not allow for sufficient focus on the face to capture facial expression. Therefore, there is the need for a second frame focusing on the face to allow the viewer to gain information from facial expressions. In addition, non-professional attempts lack the décor and lighting equipment needed, which significantly impact the video quality. Lastly, non-professional attempts lack the necessary equipment to perform a satisfactory audio capture. In summary, sub-optimal equipment impacts the quality of the video clip (and thereby the impression of the user) through sub-optimal camera quality, lighting, audio capture and number of cameras used.

### II.C.1.b. Lack of Interviewer

Non-professional attempts (home made) lack the presence of an interviewer. The user will often attempt to speak directly into the camera. Such attempts produce a sub-optimal video quality for two main reasons: difficulty for a non-trained lay person to speak directly to a camera, and difficulty of expressing one's self when there is no one listening.

It is very difficult to speak to a camera. For human communication to occur, there is a need for a polar dynamic to be present: the sending polarity (e.g.: speaker) and the receiving polarity (e.g. listener). A sending polarity needs to connect with a receiving polarity for communication to flow through speech or other means. When speaking into a camera, the speaker is to imagine a listening party that will be viewing/receiving the communication at a later time. In such cases, the speaker is in fact “acting” because he/she is not actually communicating with anyone at the time where the <sending> of the communication occurs. Such “acting” is difficult to produce unless one is trained in the art, e.g., a professional actor.

The psychological dynamics of communication and self expression require the presence of a listening host. The absence of such a host most often prevents the guest from delivering an accurate impression of his/her communication skills and general personality.

### II.C.1.c. Low-Quality Production Process

The lack of a production process often results in a suboptimal product. Filming quality and/or editing quality can be poor. Such a suboptimal product can negatively impact a viewer's experience and the impression he/she will have of the client.

### II.C.1.d. Sub-Optimal Content

For self-made videos, the conversation topic typically consists of the description of one's own CV rather than an actual conversation topic. Many have difficulties talking objectively and in an interesting manner about one's own self. Such conversations are often less natural than a conversation about a topic of interest to both parties. Many non-professional attempts are negatively impacted by the fact that the user attempts to film him/herself discussing his own CV rather than a conversation topic unrelated to him/herself.

### II.C.2. Professional Videos

Professional attempts at producing video clips vary in quality and effectiveness. Professional video systems are non-standardized, and hence make it difficult to compare one person with another given the unfair advantage a specific person might have through a higher quality production process. Also, the mistake is often made on the level of content as previously described in section II.C.1—whereby the conversation topic revolves around the subject him/herself.

The cost of producing such video clips and delivering such a value proposition can be prohibitive for mass production since conventional means may require: (1) an interviewer, (2) interview content preparation, (3) an elaborate filming process including multiple simultaneous audio and video recording, (4) a lengthy and costly production process, (5) an uploading process to provide a finished product to an online platform where such video clips can be shared and viewed, e.g., uploading to a website.

### II.D. Summary of Prior Interpersonal Networking Offerings

In an online or remote interpersonal networking setting, the networking system should allow subjects to evaluate and be evaluated by new people online before meeting in person. In a preferred networking environment, four steps of meeting new people are met: (1) evaluation and assessment of a person to be met, (2) approaching the person to be met, (3) being evaluated and assessed by the person to be met, and (4) communicating with the person to be met to evaluate potential opportunities.

Previously, there have been two categories of on-line networking videos produced: non-professional videos and professionally produced videos. The non-professional videos can suffer from non-standardization, inadequate quality, and be self-directed. The previous professional videos can require high cost and/or investment of time. Each of these shortcomings can deter many potential clients of the online networking modalities.

Many mainstream online social networking sites have yet to provide a quality and cost-effective modality for evaluation and assessment of a person to be met.

### III. Cost-Effective Online Video Networking System

The online video networking system 5 is well positioned to fill the gap in the current online social networking market by providing an intelligent and effective system for meeting new people online. The online video networking system 5 includes production and online management and distribution of client videos, and can be used for social and business networking purposes. Embodiments of the present solution provides a high quality online social networking platform that people can use to expand their already existing networking by meeting new people online.

In various embodiments, clients and users of the online networking system can use client videos to communicate to strangers various aspects of a client's personality and soft skills as to allow strangers to gain a basic first impression of what they are like in person.

There are a number of benefits of the online video networking system 5 as now will be described: (1) the online video networking system provides new opportunities to clients to be contacted by new people, (2) the online video networking system provides clients a new tool for finding and contacting new people online with the added advantage of screening them through performing a personality and personal affinity assessment prior to contacting them, and (3) in all contexts where it is impractical or infeasible to meet in person for business or social purposes, and where several people may interact via telecommunications media such as telephone, online chatting, email, the online video networking system can provide a means by which people interacting without meeting in person can gain a deeper level of familiarization with each other (e.g. customer support over the phone by a distant customer support agent can be more satisfying if the client has gained familiarity with the customer service agent through viewing his online video). Such a networking system can reduce much of the time normally lost when attempting to initiate first contact with an unknown person using existing networking tools and can provide many of the benefits normally exclusive to meeting someone in-person without the investment and inconvenience of having to do so such as gaining familiarity, gaining a deeper appreciation for, assessing the credibility of, and assessing the trustworthiness of someone (e.g. a sales person with whom it may only be possible to interact over the phone or a consultant from a different region or country).

The online video networking system 5 also provides a platform and culture that encourages other clients of the website to contact new people. The platform can be beneficial because clients can be directly contacted by potential customers, partners, and associates with minimal efforts. The networking system provides means for others to screen a potential contact before contacting him/her, thereby reducing the chances of an unproductive encounter. Screening of potential contacts can be beneficial by enabling clients to avoid an initial unproductive exploratory screening encounter. The networking system provides a modality in which members can be contacted without prior referral. Contacting with prior referral can be beneficial by rendering the clients more accessible by a much larger pool of people than through their current network referral channels.

The online video networking system mimics certain dynamics of real-life networking events with more flexibility and without the costs and time commitment necessary. This can be beneficial by allowing clients to network more often at lower cost and time commitment than required for real-life networking events. The online video networking system provides a modality in which clients or users can search people by characteristic, and make a personality assessment in a few seconds. The video networking system can be beneficial by providing to clients and users, at their fingertips, multiple opportunities to quickly screen and find people with whom there can be natural personal affinity.

In various embodiments, the system is advantageous in that the system allows clients to bypass traditional means of networking through intermediation and face-to-face meetings, and proceed to directly search for, screen and meet selected individuals. In certain aspects, the online video networking system has similarity to online real-estate and travel brokerage services. Such online services can provide a modality for clients to efficiently screen, select, and schedule actions for particular items of interest to the client from the comfort of a client's dwelling and on the client's own schedule prior to meeting with a broker. In other embodiments, the system can be used as a substitute to meeting someone in person when such a meeting is too costly (e.g. airfare costs), non-feasable (e.g. time needed to travel), too difficult (e.g. not enough time).

Further details of the online video networking system and its various aspects will now be described.

### III.A. System Overview

Referring now to FIG. 1A, a block diagram depicting a general embodiment of a client video production system 5 is shown. FIG. 1A depicts overall system components and indicates subsequent figures used to further describe various components of the system. In certain embodiments, the system comprises three components: a website or web portal 100 providing client or user access to the client video production system, a V-ticket generator 20 and a video studio 113. The website or web portal 100 can provide online registration as well as access to the usage platform for client videos production or viewing, and for generation of client content. The V-ticket generator 20 provides a link between a client accessing the system 5 and a video studio 113 to be visited by the client. The video studio 113 comprises certain equipment and a V-ticket reader used in the production of client videos.

In operation, a client can access the client video networking system 5 through the website 100. The client can interface with a registration module 101 and themes selection module 103 to provide information to the system 5 for the generation of a V-ticket 111. The client can then print out the V-ticket 111 and take the ticket to the studio 113. The V-ticket can include information relating to particular conversational topics unknown to the client, as described below. At the studio 113, the V-ticket can be read by a V-ticket reader to provide information used during the production of a client video. Multiple video clips can be recorded, in an automated manner, of the client conversing on the particular conversational topics encoded in the V-ticket 111. The client can later access the video clips online to choose a preferred client video. The preferred client video can then be provided to the system 5 for management, distribution, and restricted access viewing.

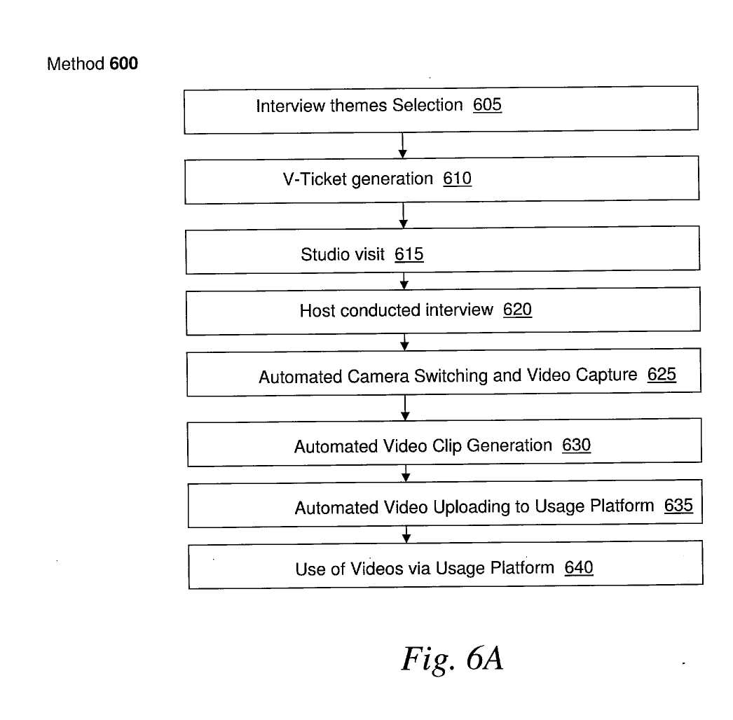

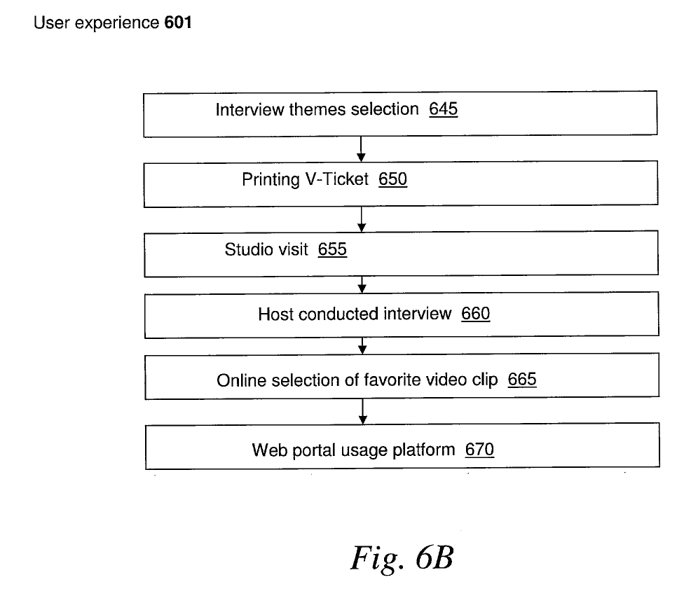

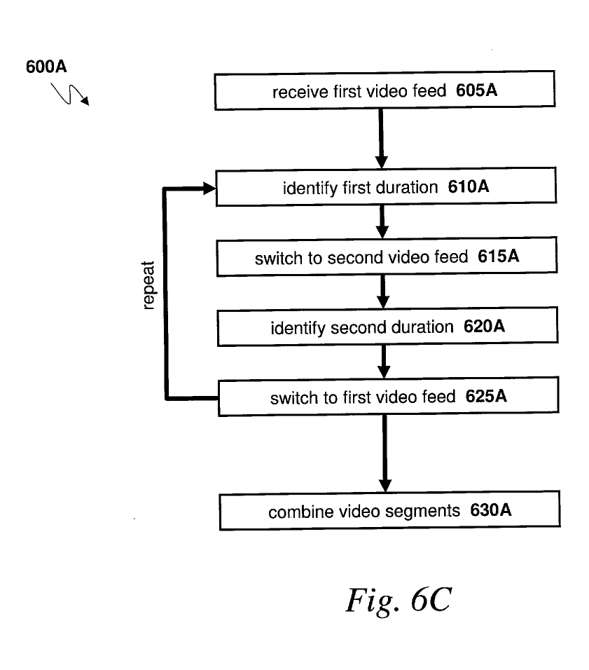

Two embodiments of methods for the online video networking system 5 are shown in FIGS. 6A-6B. FIG. 6A depicts a flow diagram of an embodiment of a method of producing a client video using the systems described herein. In certain embodiments, the method comprises: providing data to a client for the selection of interview themes (step 605), generating data for a V-ticket (step 610); receiving a client at a studio (step 615); providing a host-conducted interview for the client (step 620); capturing video and switching cameras during the interview (step 625); generating video clips (step 630); uploading video clips to a usage platform (step 635); providing access to video clips managed by the usage platform (step 640)

FIG. 6B depicts a flow diagram of an embodiment of a method of making a video for networking according to the teachings herein. In certain embodiments, the method comprises: selecting interview themes (step 645), printing a V-ticket (step 650); visiting a studio (step 655); participating in a host-conducted interview (step 660); selecting online preferred video clips (step 665); and accessing a usage platform which manages the video clips (step 670).

FIGS. 1B-1D depict additional embodiments of the client video networking system. As shown in FIG. 1B, the website or web portal 100 comprises two modules: a post information module 102 and a browse information module 106. In certain embodiments, the post information module 102 comprises software, firmware, hardware or a combination thereof in operation on a processor. The browse information module 106 can comprise software, firmware, hardware or a combination thereof in operation on a processor. The post information module 102 can include a registration unit 101, a conversation theme selection unit 103, and a user-generated-content (UGC) unit 105. The browse information module 106 can include search unit 109 and browse profiles unit 107.

A first step in using the system for clients comprises accessing the registration unit 101. The registration unit can provide creation of a client data record for a client using the system 5. Such a record can act as an anchor for all subsequent interactions and information/content modifications for the client accessing the system. As illustrated in FIG. 1C, the registration module 101 can comprise a set of data records. As an example, the registration module 101 can include a first and last name 130 data record representative of a client's first and last name, an e-mail address record 131 representing an e-mail address at which to contact the client, a password record 132 containing a client-created password for accessing the system 5 on a restricted basis. The password can be associated with the client's username and/or full name. The registration module 101 can also include a client ID number assignor 133. Once the client has created a client data record in the system 5, additional information, e.g., future choices, client generated content, video clips, various multimedia files, can be added to the client data record at any time, and the record can be modified at any time by the client having access to the system.

In operation, a client or subject 222 accessing the system 5 can enter basic personal information via the registration module 101. The registration module can be accessed online. The basic information can include a first and last name of the client, a preferred e-mail address for contact purposes, and a password for accessing the client's account. Additional or less information can be provided in some embodiments via the registration module 101. The registration unit 101 can store the first and last name in the first and last name 130 data record, store the e-mail address in the e-mail address record 131, and store the password in the password record 132. The client ID number assignor 133 can automatically assign a unique client identification (ID) number to the client. The system 5 can create a new record associated with a client, or replace an existing record, after receipt of client information. During or after completion of registration, the system 5 can generate an online profile 134 for the client. The online profile 134 can comprise a composite of client-provided information and be representative of the client.

In certain embodiments and referring again to FIGS. 1B and 1C, after completion of the registration process the client 222 accesses the theme selection unit 103 to choose a plurality of conversation themes 144 that are of interest to the client. The number of conversation themes 144 selected by the client can be any value from two to one dozen or more. In some embodiments, five conversational themes 144 are selected. The selection of conversational themes by the client 222 is a particular advantage of the online video networking system 5. Client selection of conversational themes provides for efficient and effective management of interview content for clients and interview hosts. A client selecting their own conversation themes 144 can be confident in his/her ability to appear knowledgeable during an interview, and can be assured that conversation topics to be discussed will be of interest to him/her. Furthermore, client-selection of conversational themes 144 alleviates the interviewer 220 from extensive interview preparation which would add additional costs to the process.

FIG. 1D depicts an embodiment of a conversation themes selection module 103. In certain embodiments, the themes selection module accesses a conversation category database 140, a conversation subcategory database 142, a conversation theme category database 144, and a conversation topics category database 146. Any or all of the conversation category database 140, the conversation subcategory database 142, the conversation theme category database 144, and the conversation topics category database 146 can be stored in a themes database 151 accessible by the networking system 5. In various embodiments, a plurality of conversation categories 140_{1-N}, conversation sub-categories 142_{P1-N}, and conversation theme categories 144_{PQ1-N} are provided to a client 222 accessing the system 5. The client can select a first predetermined number of conversation categories from the conversation category database 140, a second predetermined number of conversation sub-categories from the subcategory database 142, and a third predetermined number of conversation themes from the conversation theme category database 144. The networking system 5 can then select a fourth predetermined number of conversation topics from the conversation topics category database 146 randomly based on the conversation themes chosen by the client 222.

Once the client 222 has chosen a predetermined number of conversational themes 144_{PQR}, the networking system 5 makes a random selection of conversational topics from the conversation topics category database 146. The conversational topics 146_{PQR1-N} can comprise data representing a variety of topics grouped by conversational themes. In certain embodiments, specific topics codes 145_{PQR1-N} can be associated with conversational topics 146_{PQR1-N} (as illustrated in FIG. 1D). The conversational topics 146_{PQR1-N} and topic codes 145_{PQR1-N} can be stored in a topics database 150 accessible by the networking system 5. The topic codes 145_{PQR1-N} can be encoded in a barcode 344 that is provided with a V-ticket 111. In some embodiments, a topic code 145_{PQRS} is printed on a V-ticket in the form of a bar code, an encrypted code, or any form and type of code. A V-ticket can provide communication between the website or web portal 100 and a studio 113, and any computing device or system at the studio, and functions similarly to the way an airline boarding pass communicates information from the central ticketing process to the boarding agent in an airport. When a V-ticket 111 is presented at a studio 113, the video production system 400 reviews the topic codes 145_{PQR1-N} to identify conversational topics 146_{PQR1-N} in the topics database 150. The identified conversational topics 146_{PQR1-N} can then be provided to the client 222. In some embodiments, the topics 146_{PQR1-N} are provided to the client by a live interviewer 220. In some embodiments, the topics 146_{PQR1-N} are provided to the client 222 by being displayed on a screen either simultaneously or sequentially with or without the presence of a live interviewer. In some embodiments, the topics 146_{PQR1-N} are provided to the client 220 by being played from a pre-recorded sound file or generated in real-time by a text-to-speech application or software sequentially. In some embodiments, the topics 146_{PQR1-N} are provided to the client 220 by being played from a video-recorded “virtual host” either pre-recorded or computer generated in real-time. In some embodiments, the topics 146_{PQR1-N} are provided simultaneously. In some embodiments, the topics 146_{PQR1-N} are provided to the client 220 in sequence separated by a predetermined time interval. In some embodiments, the 146_{PQR1-N} are provided to the client 220 in sequence, and are prompted by the client (e.g.: client pushes a button when ready for next topic). In some embodiments, the topics 146_{PQR1-N} are provided to the client 220 in sequence and are prompted by a prolonged silence or a spoken code (e.g. “next question please”) detected by the computer. The conversational topics 146_{PQR1-N} can be submitted in any sequence to the client 222 to stimulate conversation during the interview 451.

In some embodiments, the client 222 expresses him self in response to the topics 146_{PQR1-N} submitted though a conversation with a host. In other embodiments, the client delivers a monologue, or a presentation, or a speech, or a “talk”, or an act to a host or directly to the camera, or to no one specifically.

As the client 222 begins expressing him/herself in response to the topics submitted, the video production system 400 at the studio 113 produces a predetermined minimum number of video clips. In some embodiments, the video production system 400 can then name and label each clip with the client ID number 133 and send the clips to a central video clip database 119 on a server 114. In other embodiments, the video production system 400 can send the clips directly to a folder of the client profile which resides on the server 114 in a streamlined fashion to avoid further processing by the server (e.g. through modifying the file uploading protocol according to the client-specific information received from the V-Ticket) After receiving video clips, the server 114 can associate the clips with a particular online client profile 134 using the client ID number 133. The client 222 can then access and view the produced video clips directly online, choose preferred clips, and utilize various functional features of the usage platform.

Clients can also create user-generated content (UGC) 105—which can contain text, photos and videos. They can also leverage other functionalities, e.g., access a send and receive message module 518, to communicate with other clients and users of the system 5. All UGC and messages can be viewed from a website accessing the system 5. There are two types of multimedia files that a client 222 can have on the website: (1) client-generated and (2) system generated. System generated content consists of video clips that are created in a film studio of an interview that the client undergoes for the purposes of creating a client video of himself/herself. Such a video can capture certain personality traits of a client in a succinct and communicative manner, and provide for the efficient and effective communication and sharing of such information with various interested parties on a mass scale.

### III.B. V-Ticket

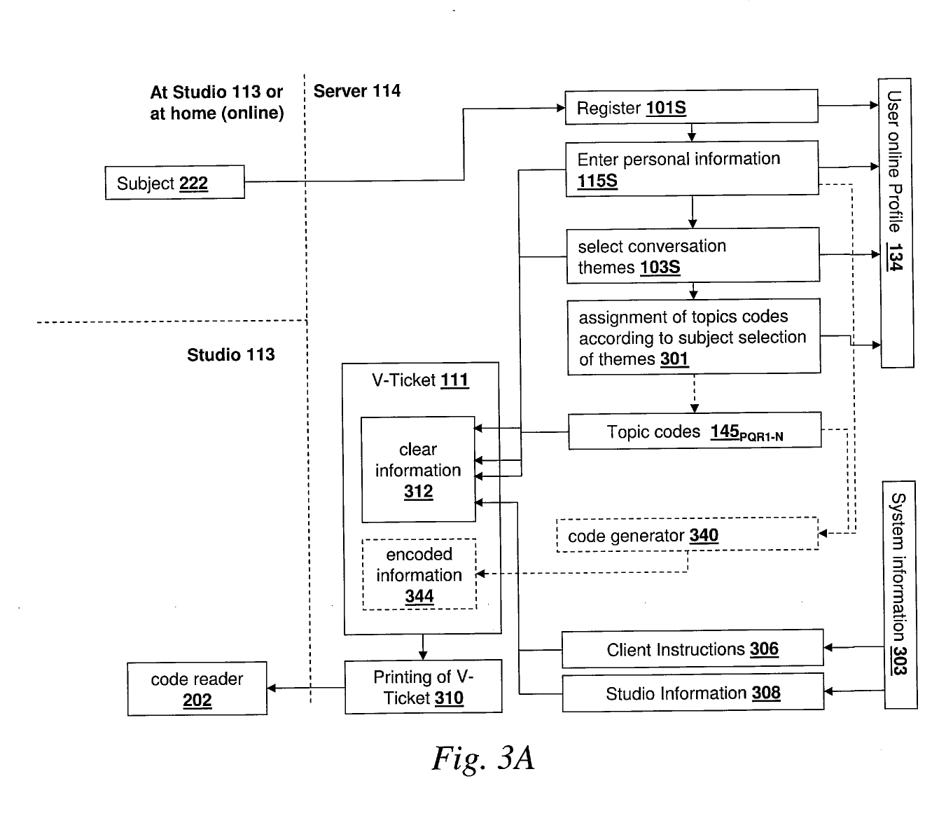

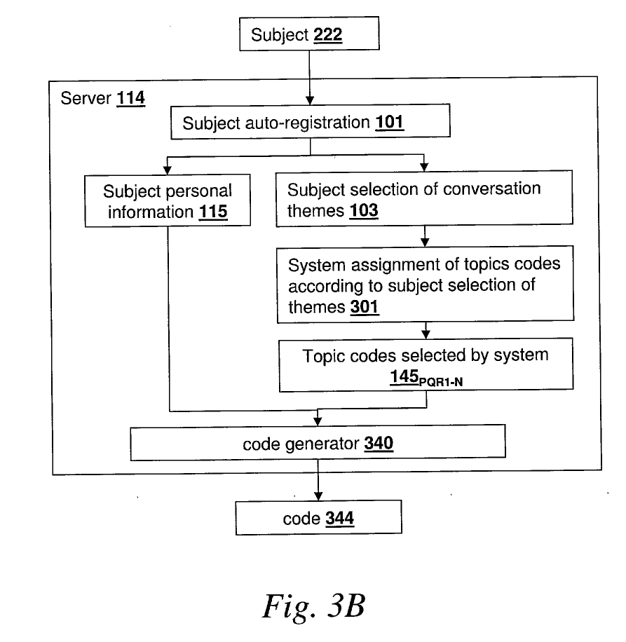

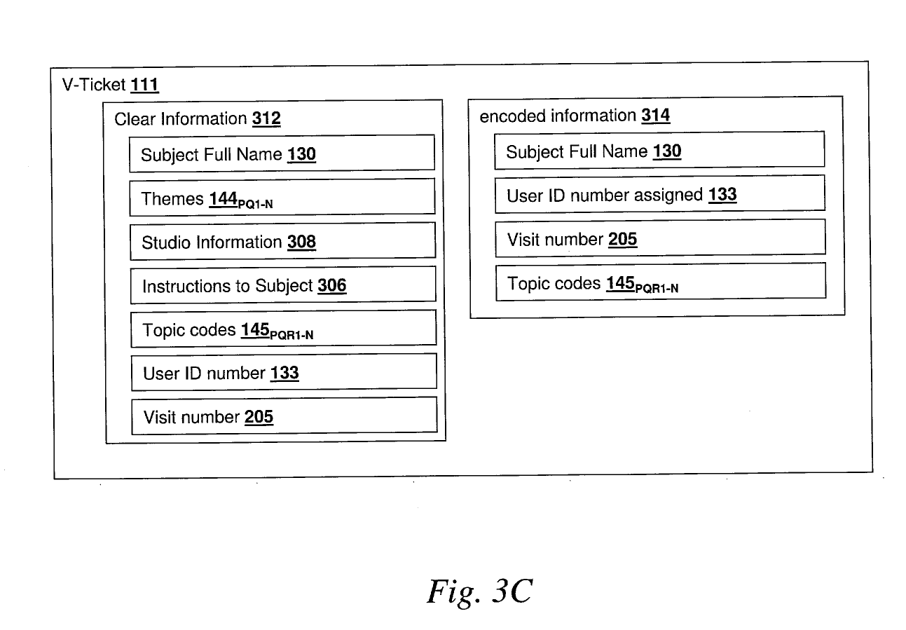

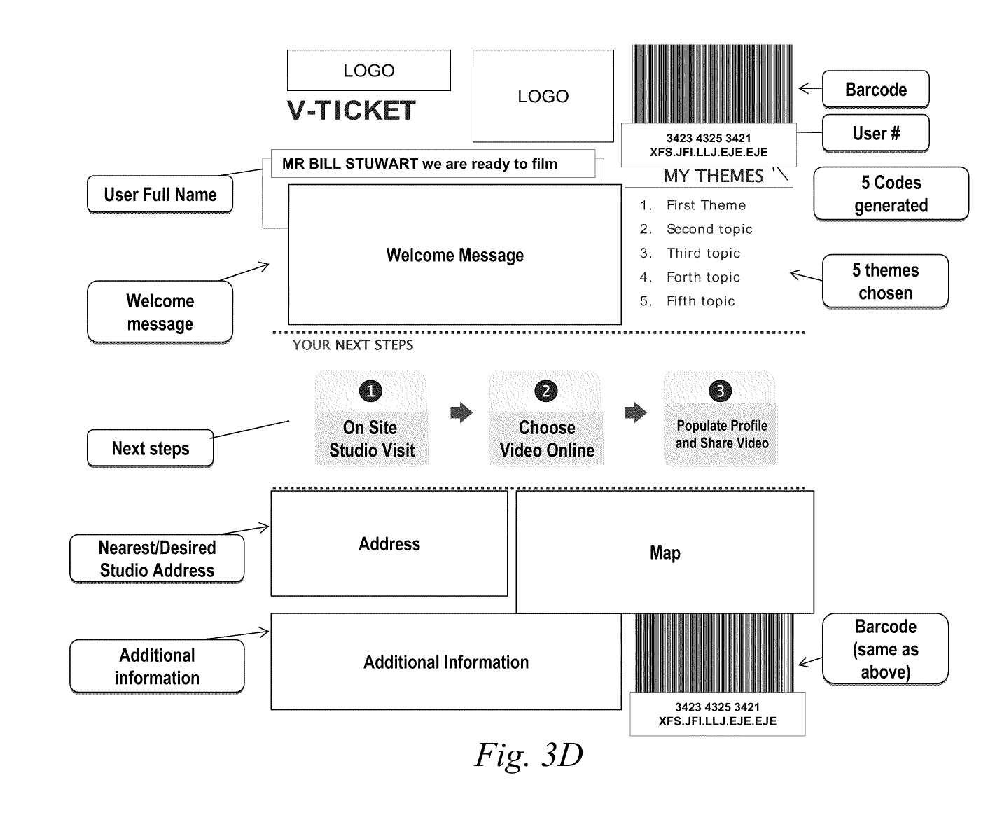

In various embodiments, the online video networking system 5 includes the generation and use of a V-ticket 111. FIG. 3A is a representation of the production of V-tickets according to one embodiment of the networking system 5. After a client completes the themes selection process, the system 5 can display a representation, e.g., a graphical display as depicted in FIG. 3D or a print-out copy, of a V-ticket 111 to the client. The V-ticket can include various informational content, an example of which is depicted in FIG. 3C. More or less information can be included in the V-ticket. In various embodiments, the V-ticket 111 comprises encoded information identifying conversational topics selected for the client. In some embodiments, the client is asked to print the V-ticket 111 and to present the ticket to a host of a studio when visiting the studio for participation in a client interview and video production process. In some embodiments, the V-ticket 111 comprises a confirmation code. The confirmation code can be any alpha-numeric representation. The client can be asked to provide the confirmation code to a host of a studio when visiting the studio for participation in a client interview and video production process.

FIG. 3A represents an embodiment of the production of a V-ticket 111. In certain aspects, the V-ticket comprises a communication vehicle between a server 114 providing access to the online video networking system 5, the server 114 containing all client information including his/her theme choices 144 and assigned conversational topics 146, and the studio host 220 who will conduct an interview with the client 222. In certain embodiments, the V-ticket production comprises registering 101S by a client 222 with the online networking system 5, entering personal information 115S by the client 222, and selecting a first predetermined number of conversation themes 103S, by the client 222. The process can further include automatically assigning 301 a second predetermined number of conversational topics 146_{PQR1-N} and identifying conversational topic codes 145_{PQR1-N} according to the client's selection of themes. Any combination of information entered by the client, e.g., personal information, theme choices, client generated content, and assigned conversational topics can be identified in the client online profile 134. To compile information for a V-ticket 111, the video networking system 5 can use the assigned topic codes 145_{PQR1-N}, any combination of information from the client's online profile 134, and additional system information 303. Additional system information 303 can comprise client instructions 306, e.g., date and time of interview, length of interview, printing of V-ticket, confirmation code, items to bring to interview, etc., and studio information 308, e.g., address of studio, directions to studio, map of studio area, nearby landmarks, hours of business, studio environment, picture of studio, etc. The production of a V-ticket in some embodiments includes printing or storing 310 of a V-ticket by the client and providing the V-ticket at a studio 113 for reading by a code reader 202. In some embodiments after a V-ticket has been produced using the video networking system 5, the client can execute instructions to print 310 the V-ticket that he/she can take to the studio 113. At the studio the V-ticket can be scanned by the code reader 202 and communicated to the video networking system 5. In some embodiments, the client can store the V-ticket on a memory device which can be taken to the studio 113 and read by the code reader 202.

An embodiment of an encoding process is depicted in FIG. 3B. In certain embodiments, a client 222 provides information to an application in operation on a processor. The application can reside on the server 114 or can be provided to a client's computer or processing device, e.g., a mobile phone, mobile internet device, smartphone, personal digital assistant, tablet PC, wireless handheld device, or similar device, from a server 114. In various embodiments, the encoding process comprises receiving, by a registration module 101, registration information. The received registration information can be provided by a client 222. The process can further comprise receiving, by the application, personal information 115; providing, by the application, a conversation themes selection module 103 to the client; and identifying, by the application, a predetermined number of conversational topics 146_{PQR1-N}. The process can further comprise identifying, by the application, topic codes 145_{PQR1-N} for each conversational topics 146_{PQR1-N}; and providing, by the application, the topic codes 145_{PQR1-N} and personal information 115 to an encoder 340. The encoding process can further comprise generating, by the encoder 340, encoded information 344 or graphically encoded (e.g. by a two dimensional or a one dimensional barcode) to include with a V-ticket. In various embodiments, the encoded information 344 is generated by the encoder 340 such that the encoded information can be decoded by a code reader 202 accessible at the studio 113.

In certain embodiments as illustrated in FIG. 3C, the content of the V-ticket is in two forms: clear information 312 and encoded information 314. The clear information 312 can include client full name 130, conversational themes 144_{PQR} chosen by the client, studio information 308, instructions to client 306, conversational topic codes 145_{PQR1-N}, a client ID number 133, and a confirmation or visit number 205. The visit number 205 can be used by the networking system 5 to log the different visits a client makes to the studio. The encoded information 314 can comprise any type of linear barcode, any type of two-dimensional barcodes or matrix barcodes, an alpha-numeric encrypted code, or any combination of the aforementioned codes. In some embodiments, the encoded information comprises electronically, magnetically, or electromagnetically encoded data which can be stored on a memory device. In certain embodiments, the encoded information can be representative of any combination of the following items: the client's name 130, an ID number 133 assigned to the client by the system 5, the visit number 205, and the topic codes 145_{PQR1-N} identified by the system 5 for the client.

FIG. 3D is a graphical illustration of an embodiment of a V-ticket which may be printed by the client. In some embodiments, a V-ticket is not printed. As an example, a V-ticket can comprise data stored on a memory device which is taken by a client 222 to a studio 113. The memory device can be accessed by the networking system 5 at the studio 113 to obtain information pertinent to a client's visit. In some embodiments, the information for a V-ticket is stored on the networking system 5 and the client 222 is provided with a confirmation code. The client can provide the confirmation code upon visiting a studio to access information on the stored V-ticket. In some embodiments, the graphical barcode is sent to the mobile device of the client, such as a mobile computing device or cellular telephone device, and the barcode is read directly by the studio barcode reader from the client's mobile device.

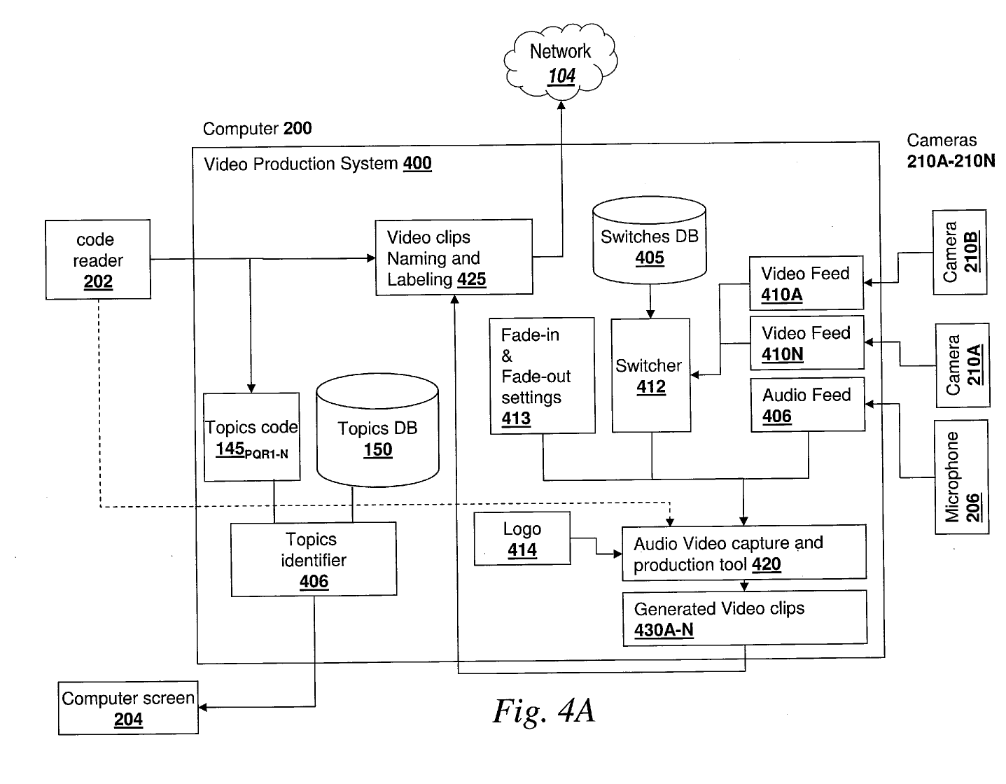

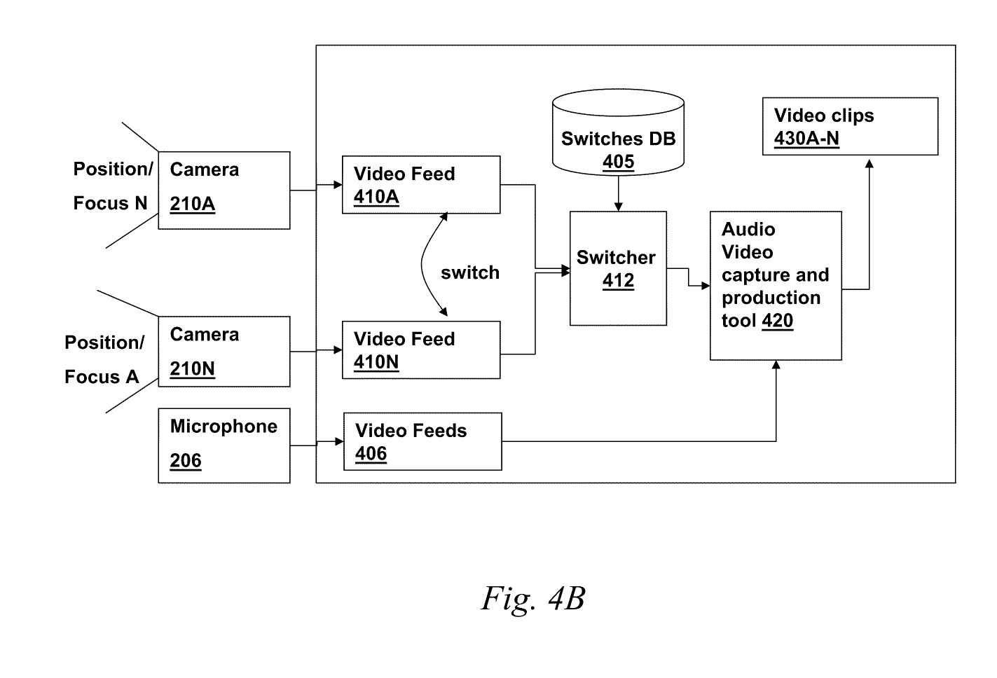

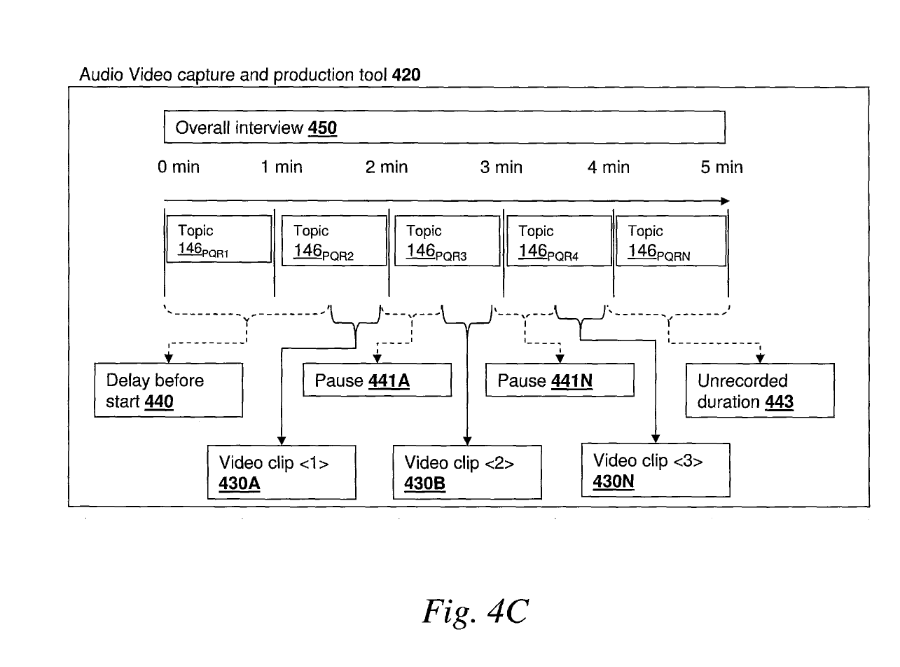

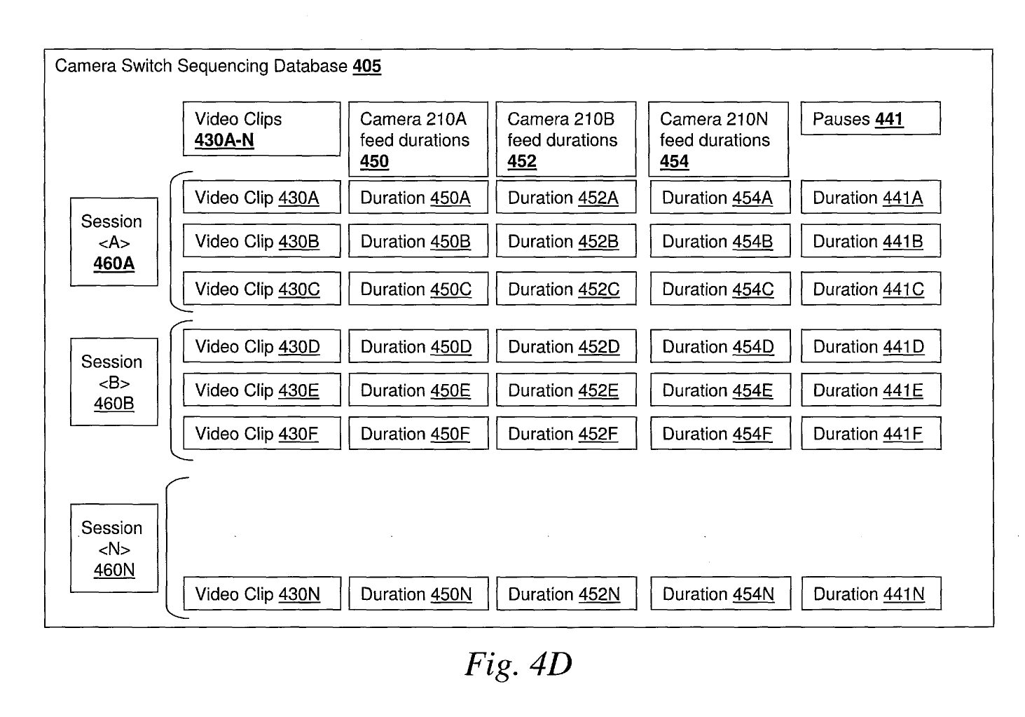

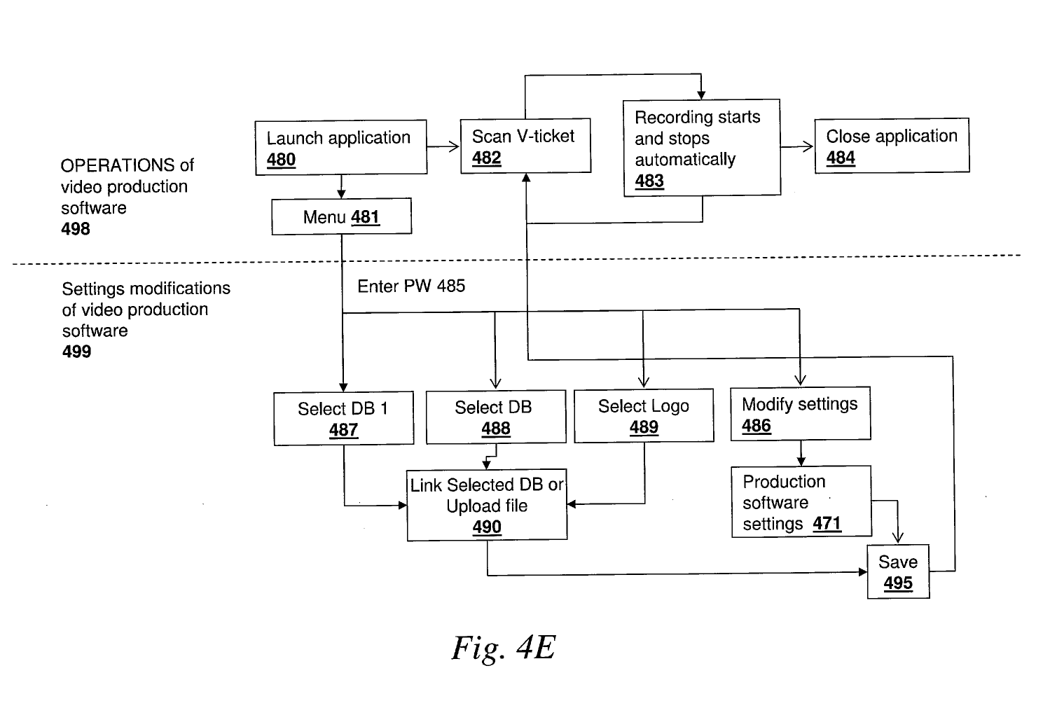

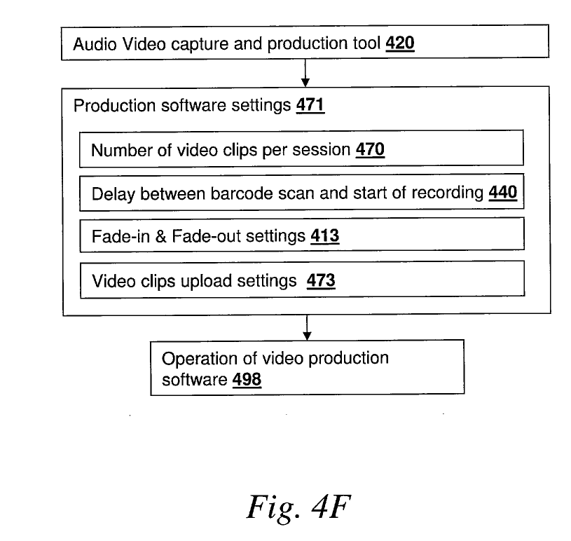

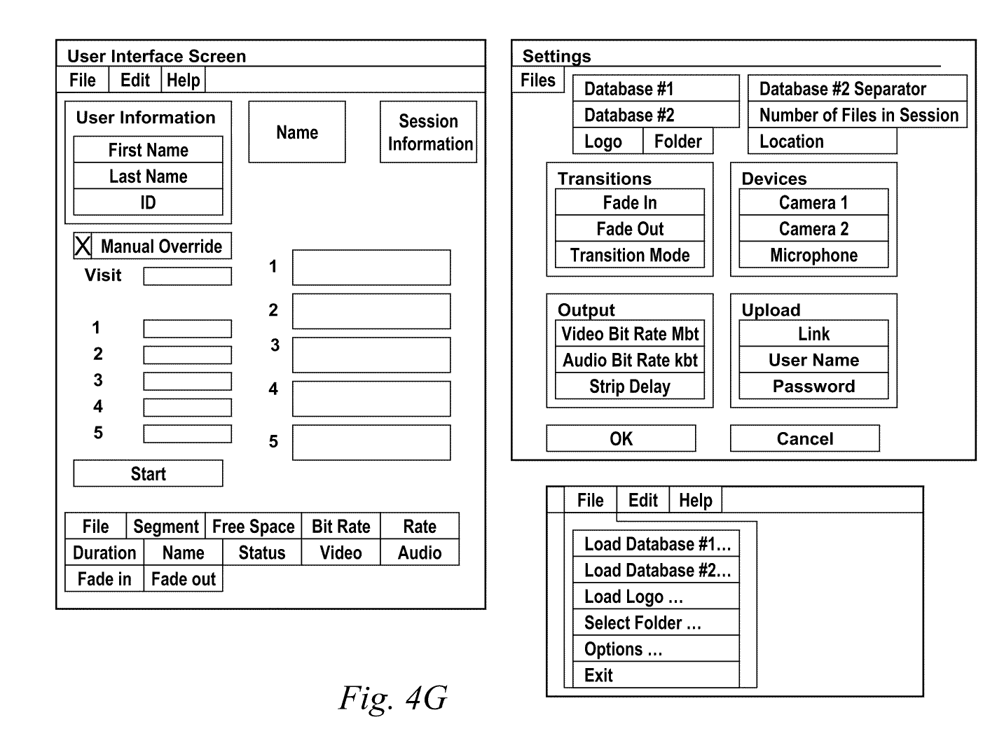

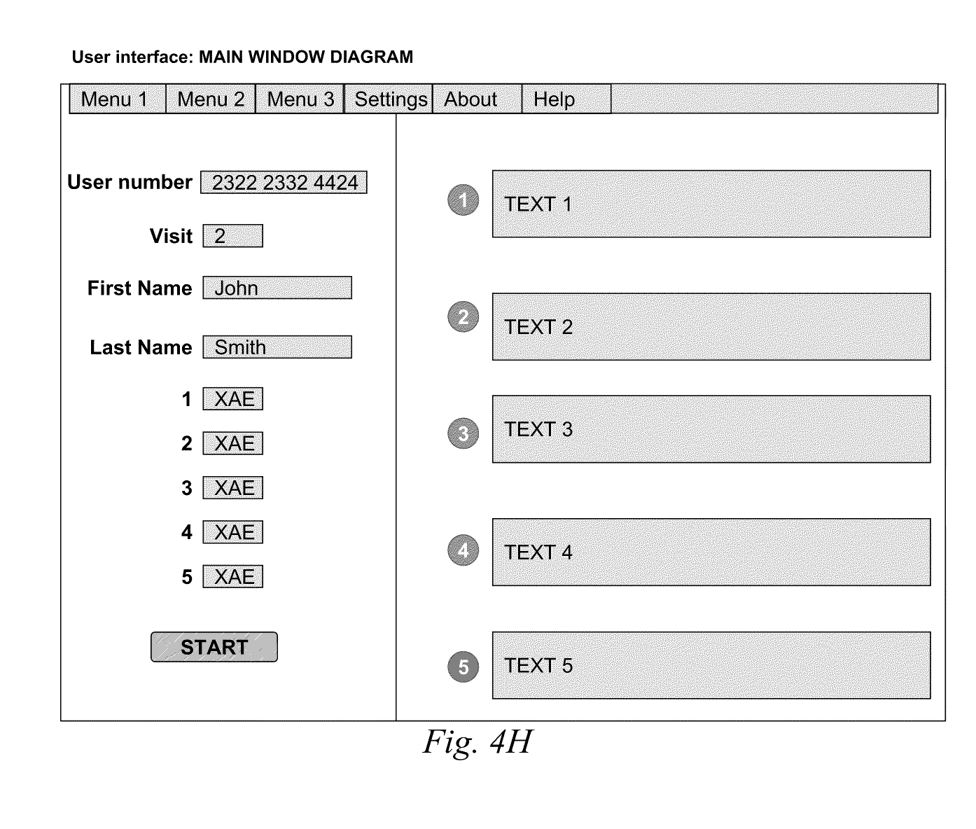

In certain embodiments and referring to FIG. 4A, the V-ticket 111 can provide prompting for the video production system 400 to start recording and producing video clips of a client interview, e.g., the video production system 400 can identify to the client 222 and host 220 that the interview is about to begin, and subsequently provide conversational topics 146_{PQR1-N} to the host 220 and record the interview. The V-ticket can also provide information to a video clip naming and labeling module 430 for the production of video clips, e.g., client name and related information to assign to the video clips produced during an interview. In certain embodiments, data comprising each video clip is labeled with information provided by a V-ticket. The naming and labeling can be used by the video networking system 5 to assign any received video clips to a correct client 222, so that the client can later access the video clips.

In various embodiments, information provided with a V-ticket 111 is used within the framework of the video networking system 5 for a plurality of processes. As an example, information from the V-ticket can be used to (1) admit a client to an interview session, (2) identify video clips produced during an interview with the client, (3) prompt the video production system 400 to start the video recording and production processes related to the interview, and (4) identify the conversational topics 146_{PQR1-N} used during the interview for the client.

It will be appreciated from the foregoing description that the V-ticket 111 provides for effective and secure communication to an interviewer 220 of conversational topics assigned to a client 222 by the video networking system 5. The conversational topics can be provided to the interviewing host 220 by the client 222 without the client being able to identify the actual conversational topics. Lack of prior knowledge of the topics by the client can prevent the occurrence of an artificial or staged interview, e.g., the client cannot prepare in detail for the particular conversational topics and thereby curtail or eliminate spontaneity during the interview. The encoding of conversational topics on the V-ticket 111 can ensure a smooth and effective transmission of information to the host 220 while keeping the actual topics undisclosed to the client 222.

### III.C. Studio

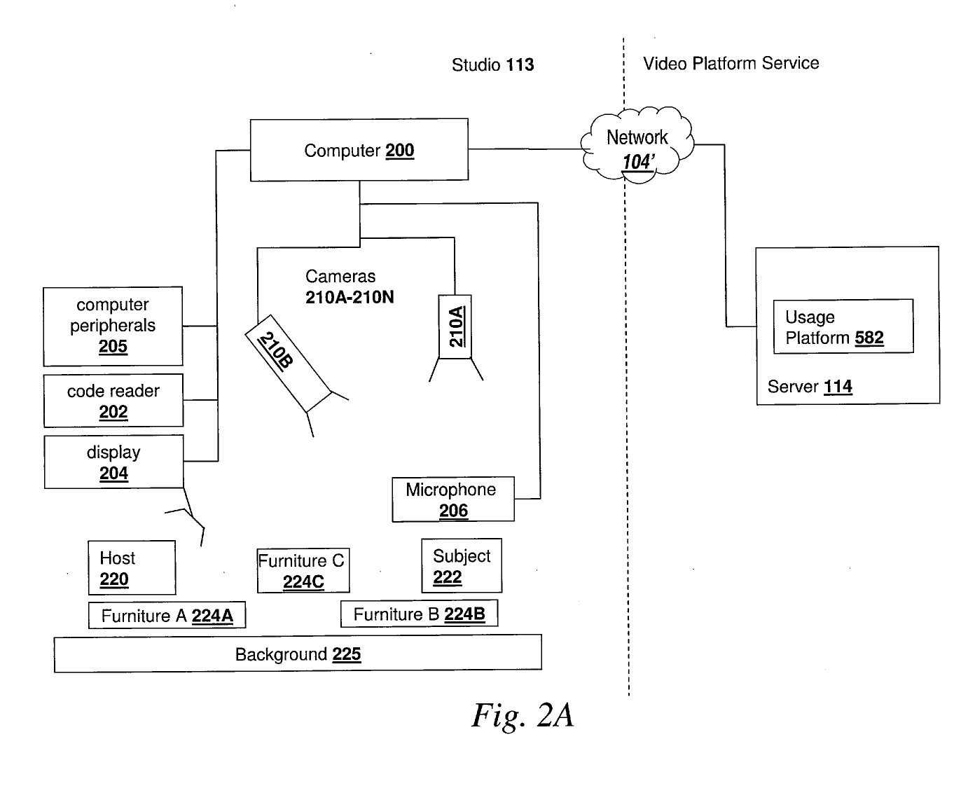

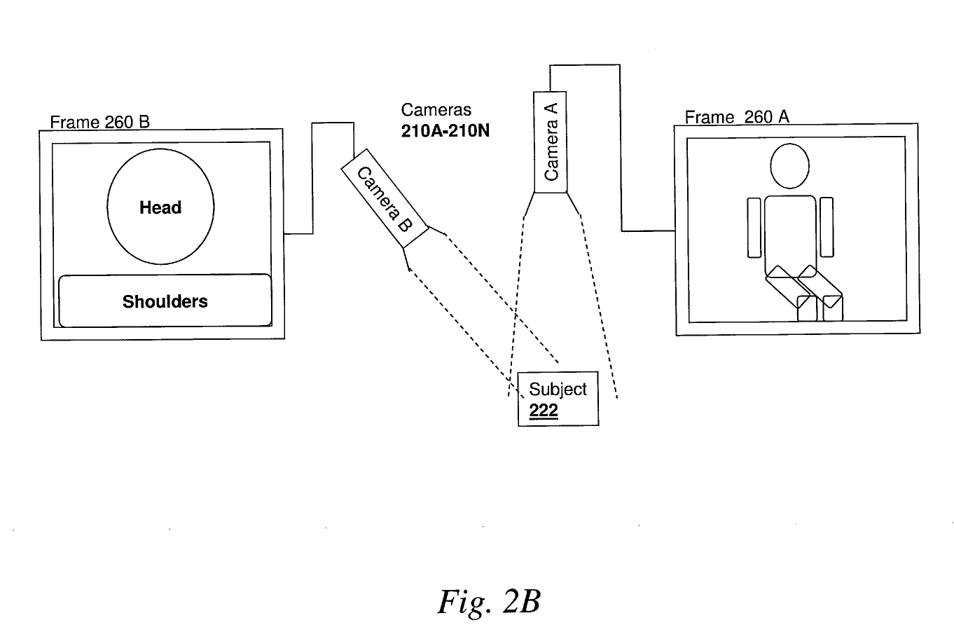

In various embodiments, the video networking system comprises a studio 113 in which client interviews are conducted. FIG. 2A is a block diagram of an embodiment of a studio 113 for conducting client interviews. As shown in the embodiment of FIG. 2A, the studio 113 comprises a computer 200 linked to a network 104 which provides access to a usage platform 500A of the video networking system 5. The usage platform 500A can be resident and in operation on a server 114, or downloadable, in part or in whole, to the computer 200. The studio 113 can further comprise multiple cameras 210A-N in communication with the computer 200, a code reader 202 in communication with the computer 200, a video display 204 in communication with the computer 200, and a microphone 206 in communication with the computer 200. In some embodiments, multiple microphones 206 are in communication with the computer and can be disposed with the multiple cameras 210A-N.

Various aspects of the computer 200 are now described. The following description of the computer 200 or computing machine 700 also can be descriptive of any component of the video networking system 5 which receives and/or processes electronic data. For example, the following description relating to a computer can apply to a server 114 hosting the usage platform, a camera 210 or aspects thereof used to record an interview, and the code reader 202 or aspects thereof.

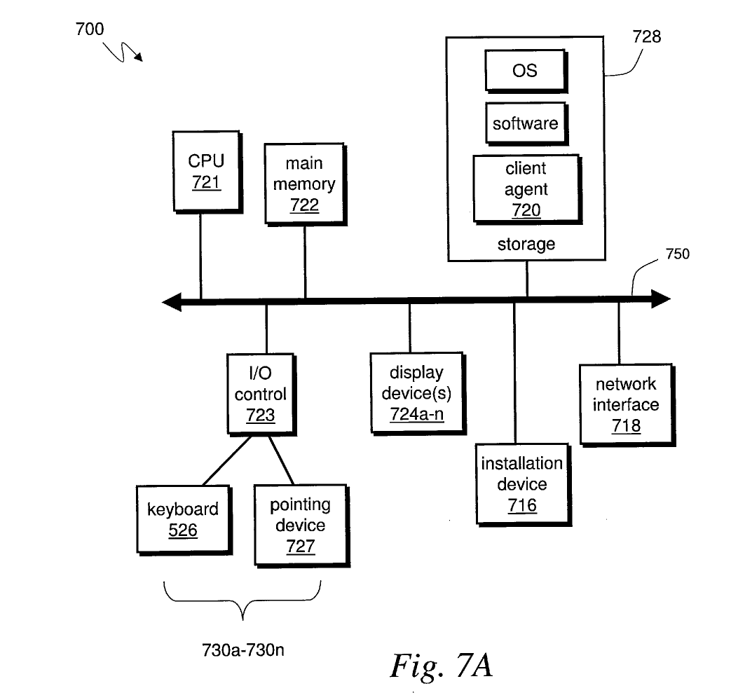

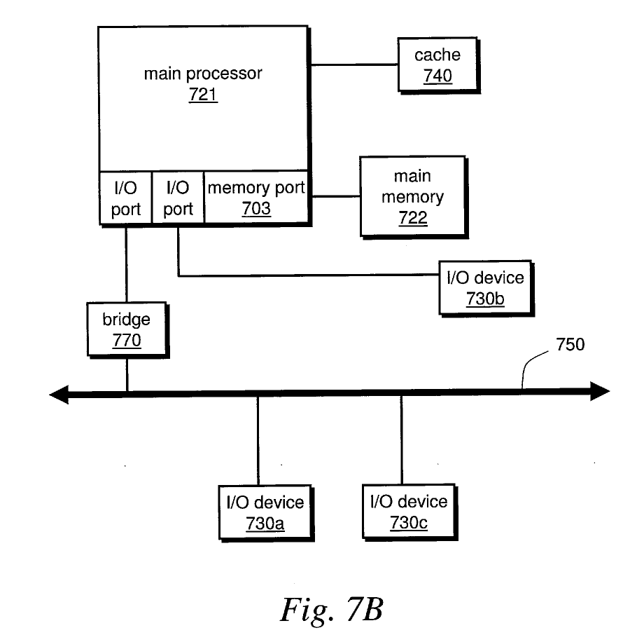

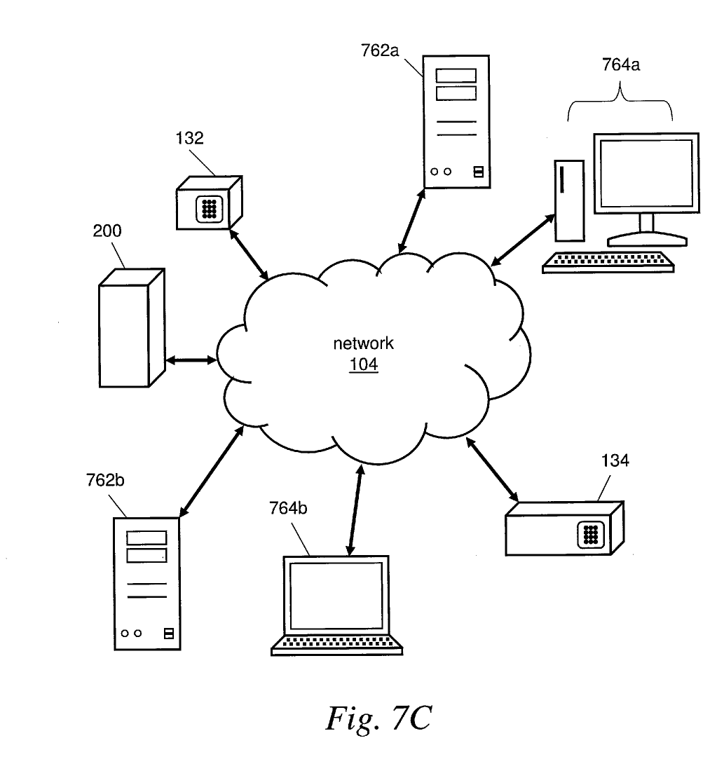

In certain embodiments, the computer 200 comprises a computing device or machine 700 as depicted in FIG. 7A. Included within the computing device 700 is a system bus 750 that communicates with the following components: a central processing unit 721; a main memory 722; storage memory 728; an input/output (I/O) controller 723; one or more display devices 724a-724n; an installation device 716; and a network interface 718. In one embodiment, the storage memory 728 includes: an operating system, software routines, and a client agent 720. The I/O controller 723, in some embodiments, is further connected to a key board 726, and a pointing device 727, e.g., a computer mouse. Other embodiments may include an I/O controller 723 connected to more than one input/output device 730a-730n.

FIG. 7B illustrates an additional embodiment of a computing device 700. Included within the computing device 700 is a system bus 750 that communicates with the following components: a bridge 770, and a first I/O device 730a. In some embodiments, the bridge 770 is in further communication with the central processing unit 721, where the central processing unit 721 can further communicate with a second I/O device 730b, a main memory 722, and a cache memory 740. Included within the central processing unit 721, are I/O ports, a memory port 703, and a main processor.

Embodiments of the computing machine 700 can include a central processing unit 721 characterized by any one of the following component configurations: logic circuits that respond to and process instructions fetched from the main memory unit 722; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits capable of executing the systems and methods described herein. Still other embodiments of the central processing unit 721 may include any combination of the following: a microprocessor, a microcontroller, a central processing unit with a single processing core, a central processing unit with two processing cores, or a central processing unit with a plurality of processing cores.

One embodiment of the computing machine 700 includes a central processing unit 721 that communicates with cache memory 740 via a secondary bus also known as a backside bus, while another embodiment of the computing machine 700 includes a central processing unit 721 that communicates with cache memory via the system bus 750. The local system bus 750 can, in some embodiments, also be used by the central processing unit to communicate with more than one type of I/O devices 730a-730n, as well as various studio instruments, e.g., cameras, code reader, microphones, lighting equipment, camera motion control equipment. In some embodiments, the local system bus 750 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 700 include an I/O device 730a-730n that is a video display 724 that communicates with the central processing unit 721 via an Advanced Graphics Port (AGP). Still other versions of the computing machine 700 include a processor 721 connected to an I/O device 730a-730n via any one of the following connections: HyperTransport, Rapid I/O, or InfiniBand. Further embodiments of the computing machine 700 include a communication connection where the processor 721 communicates with one I/O device 730a using a local interconnect bus and with a second I/O device 730b using a direct connection.

Included within some embodiments of the computing device 700 is each of a main memory unit 722 and cache memory 740. The cache memory 740 will in some embodiments be any one of the following types of memory: SRAM; BSRAM; or EDRAM. Other embodiments include cache memory 740 and a main memory unit 722 that can be any one of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device capable of executing the systems and methods described herein. The main memory unit 722 and/or the cache memory 740 can in some embodiments include one or more memory devices capable of storing data and allowing any storage location to be directly accessed by the central processing unit 721. Further embodiments include a central processing unit 721 that can access the main memory 722 via one of either: a system bus 750; a memory port 703; or any other connection, bus or port that allows the processor 721 to access memory 722.

One embodiment of the computing device 700 provides support for any one of the following installation devices 716: a floppy disk drive for receiving floppy disks such as 3.5-inch, 5.25-inch disks or ZIP disks, a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 720, or any portion of a client agent 720. The computing device 700 may further include a storage device 728 that can be either one or more hard disk drives, or one or more redundant arrays of independent disks; where the storage device is configured to store an operating system, software, programs applications, or at least a portion of the client agent 720. A further embodiment of the computing device 700 includes an installation device 716 that is used as the storage device 728.

Furthermore, the computing device 700 may include a network interface 718 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 700 includes a network interface 718 able to communicate with additional computing devices via any type and/or form of gateway or tunneling protocol such as Secure Socket Layer (SSL) or Transport Layer Security (TLS). Versions of the network interface 718 can comprise any one of: a built-in network adapter; a network interface card; a PCMCIA network card; a card bus network adapter; a wireless network adapter; a USB network adapter; a modem; or any other device suitable for interfacing the computing device 700 to a network capable of communicating and performing the methods and systems described herein.

Embodiments of the computing device 700 can include any one of the following I/O devices 730a-730n: a keyboard 726; a pointing device 727; a mouse; a gesture-based remote control device; an audio device; trackpads; an optical pen; trackballs; microphones; drawing tablets; video displays; speakers; inkjet printers; laser printers; and dye-sublimation printers; or any other input/output device able to perform the methods and systems described herein. An I/O controller 723 may in some embodiments connect to multiple I/O devices 730a-730n to control the one or more I/O devices. Some embodiments of the I/O devices 730a-730n may be configured to provide storage or an installation medium 716, while others may provide a universal serial bus (USB) interface for receiving USB storage devices such as the USB Flash Drive line of devices manufactured by Twintech Industry, Inc. Still other embodiments of an I/O device 730 may be a bridge between the system bus 750 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 700 can connect to multiple display devices 724a-724n, e.g., multiple displays in studio 113, in other embodiments the computing device 700 can connect to a single display device 724, while in still other embodiments the computing device 700 connects to display devices 724a-724n that are the same type or form of display, or to display devices that are different types or forms, e.g., one display can be a 56″ high-resolution main display while others can be standard video monitors and/or flat panel displays. Embodiments of the display devices 724a-724n can be supported and enabled by the following: one or multiple I/O devices 730a-730n; the I/O controller 723; a combination of I/O device(s) 730a-730n and the I/O controller 723; any combination of hardware and software able to support a display device 724a-724n; any type and/or form of video adapter, video card, driver, and/or library to interface, communicate, connect or otherwise use the display devices 724a-724n. The computing device 700 may in some embodiments be configured to use one or multiple display devices 724a-724n, these configurations include: having multiple connectors to interface to multiple display devices 724a-724n; having multiple video adapters, with each video adapter connected to one or more of the display devices 724a-724n; having an operating system configured to support multiple displays 724a-724n; using circuits and software included within the computing device 700 to connect to and use multiple display devices 724a-724n; and executing software on the main computing device 700 and multiple secondary computing devices to enable the main computing device 700 to use a secondary computing device's display as a display device 724a-724n for the main computing device 700. Still other embodiments of the computing device 700 may include multiple display devices 724a-724n provided by multiple secondary computing devices and connected to the main computing device 700 via a network.

In some embodiments of the computing machine 700, an operating system may be included to control task scheduling and access to system resources. Embodiments of the computing device 700 can run any one of the following operation systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; and WINDOWS 7; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system capable of running on the computing device and performing the operations described herein. One embodiment of the computing machine 700 has multiple operating systems installed thereon.

The computing machine 700 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In certain embodiments, the computing machine 700 can be a mobile device such as any one of the following mobile devices: a JAVA-enabled cellular telephone or personal digital assistant (PDA), such as the i55sr, i58sr, i85s, i88s, i90c, i95c1, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. Still other embodiments of the computing environment include a mobile computing device 700 that can be any one of the following: any one series of Blackberry, or other handheld device manufactured by Research In Motion Limited; the iPhone manufactured by Apple Computer; any handheld or smart phone; a Pocket PC; a Pocket PC Phone; or any other handheld mobile device supporting Microsoft Windows Mobile Software.

In certain embodiments, the computer 200 as described above functions as a client machine within a local area network or a wide area network. In some embodiments, the computer 200 functions as a server in a local area network or a wide area network. Plural computers, servers and/or studio instruments can be in communication with the computer 200 through a local area network, medium area network, and/or a wide area network. An embodiment of a network 104 is depicted in FIG. 7C. It will be appreciated that any node of the network can be connected to another network, e.g., to a WAN, a MAN, or LAN.

When configured to function as a client machine, the computer 200 can in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; a Telnet client; or any other type and/or form of executable instructions capable of executing on the computer 200. Still other embodiments may include a computing environment with an application that is any of either server-based or remote-based, and an application that is executed on a server 762a on behalf of the computer 200. Further embodiments of the computing environment include a server 762a configured to display output graphical data to the computer 200 using a thin-client or remote-display protocol. In one embodiment, the computer 200 is a virtual machine such as those manufactured by XenSolutions, Citrix Systems, IBM, VMware, or any other virtual machine able to implement the methods described herein.

The computing environment can, in some embodiments, include plural servers 762a, 762b, where the servers are: grouped together as a single server entity, logically-grouped together in a server farm; geographically dispersed and logically grouped together in a server farm, located proximate to each other and logically grouped together in a server farm. Geographically dispersed servers within a server farm can, in some embodiments, communicate using a wide area network (WAN), medium area network (MAN), or local area network (LAN), where different geographic regions can be characterized as: different continents; different regions of a continent; different countries; different states; different cities; different campuses; different rooms; or any combination of the preceding geographical locations. In some embodiments the server farm can be administered as a single entity or in other embodiments can include multiple server farms. The computing environment for the computer 200 can include more than one server grouped together in a single server farm where the server farm is heterogeneous such that one or a subgroup of servers is configured to operate according to a first type of operating system platform (e.g., WINDOWS NT, manufactured by Microsoft Corp. of Redmond, Wash.), while one or more other servers are configured to operate according to a second type of operating system platform (e.g., Unix or Linux).

In some embodiments, the computer 200 is located in a computing environment which includes one or plural servers configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server configured to operate as an active direction; a server configured to operate as application acceleration application that provides firewall functionality, application functionality, or load balancing functionality, or other type of computing machine configured to operate as a server. In some embodiments, a server can include a remote authentication dial-in user service such that the server is a RADIUS server. Some embodiments include a server with the following functionality: receives requests from a computer 200, forwards the request to a second server, and responds to the request generated by the computer 200 with a response from the second server; acquires an enumeration of applications available to the client machines 764a, 764b within the network and address information associated with a server hosting an application identified by the enumeration of applications; presents responses to client requests using a web interface; communicates directly with the computer 200 to provide the computer 200 with access to an identified application; receives output data, such as display data, generated by an execution of an identified application on the server.

Another embodiment includes a server configured to execute an application so that the server may function as an application server such as any one of the following application server types: an email server that provides email services such as MICROSOFT EXCHANGE manufactured by the Microsoft Corporation; a web or Internet server; a desktop sharing server; or a collaboration server. Still other embodiments include a server that executes an application that is any one of the following types of hosted servers applications: WEBEX provided by WebEx, Inc. of Santa Clara, Calif.; or Microsoft Office LIVE MEETING provided by Microsoft Corporation.

In one embodiment, a server on the network, or the computer 200 functioning as a server may be a virtual machine such as those manufactured by XenSolutions, Citrix Systems, IBM, VMware, or any other virtual machine able to implement the methods and systems described herein.

It will be appreciated that the computer 200 may function, in some embodiments, as a client node seeking access to resources provided by a server 762a on the network, or as a server providing other clients 764a, 764b, and/or studio instruments on the network with access to hosted resources. One embodiment of the computing environment includes a server that provides the functionality of a master node. As an example, the computer 200 may communicate with other client machines through the master node server. One embodiment of the computing environment includes the computer 200 that communicates over the network requests for applications hosted by a master server or a server in a server farm to be executed, and uses the network to receive from the server output data representative of the application execution.

The network 104 between the computer 200 and a server, client, and/or instrument is a connection over which data is transferred between the computer 200 and the server, client, or instrument. In various embodiments, the network connects the computer 200 with client machines, instruments, and/or servers. The network 104 can be any of the following: a local-area network (LAN); a metropolitan area network (MAN); a wide area network (WAN); a primary network comprised of multiple sub-networks located between the client machines and the servers; a primary public network with a private sub-network; a primary private network with a public sub-network; or a primary private network with a private sub-network. Still further embodiments include a network that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network that includes a wireless link where the wireless link can be an infrared channel or satellite band; or any other network type able to transfer data from the computer 200 to client machines and/or servers and vice versa to accomplish the methods and systems described herein. Network topology may differ within different embodiments, possible network topologies include: a bus network topology; a star network topology; a ring network topology; a repeater-based network topology; and a tiered-star network topology. Additional embodiments may include a network of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

In various embodiments, the computer 200 receives plural video feeds from the cameras 210, and receives one or more audio feeds from one or more microphones 206. The computer 200 also is adapted to receive information from the code reader 202. In various embodiments, the computer 200 manages operation of all software and hardware associated with the video production system 400 and display a control panel providing a user interface with the computer 200. The computer 200 can also provide text prompts for viewing on display 204 to an interviewer 220 during an interview with a client. The text prompts can include the conversational topics 146_{PQR1-N} retrieved from the topics database 150.

In some embodiments, the computer hosts one or more databases for operating the video production system 400. For example, the computer may include a topics database 150, a camera switching database 405, and/or a logo picture file 414. In various embodiments, the computer 200 is in communication with a network 104 through which the computer can upload video clips and other data generated by the video production system 400. The video clips and data can be uploaded to the usage platform 500A.

In some embodiments, the computer 200 controls the cameras 210A-N used to film a client interview. As an example, the computer 200 can issue electronic commands to the cameras to adjust camera features such as zoom, position, focus, aperture, contrast and brightness settings and viewing direction. Camera setting controls can be modified by commands input by the interviewer 202, or can be modified according to an automated filming protocol provided by a video setting code in operation on the computer 200.

The studio 113 can further include a computer video display 204 and other computer peripherals such as a keyboard and mouse 205. The display 204 can be the main display for the computer 200 and the video production system 400. The display 204 can further provide a graphical user interface for operating the video production system 400. The display 204 can also display the conversational topics 146_{PQR1-N} identified for a client participating in an interview. The interviewer 220 can view the topics on the display 204 and submit them verbally to the client one at a time. When the client completes the discussion of one conversational topic, the host shall read the next topic from the screen. The keyboard and mouse 205 can provide additional devices for a host 220 to operate the computer 200 and the video production system 400. In some embodiments, the host 220 provides input to a graphical user interface with the keyboard and mouse 205. In certain embodiments, the keyboard and mouse 205 comprises a handheld mouse controller which is used to point at and select various items on a graphical user interface.

The studio can include a code reader 202. The code reader 202 can comprise a 2D barcode reader, a linear barcode reader, or any device adapted to read the encoded information 344 on V-ticket 111. The code reader 202 can include the latest technological functionalities enabling the code reader 202 to read two-dimensional barcodes encoding both text and numbers. Such technological functionalities can permit efficient encoding and/or decoding of the topic codes 145_{PQR1-N} as well as the client information 115 as depicted in FIG. 3B. Upon reading the coded information 344, the code reader 202 transmits information to the computer 200. The receipt of encoded information 344 by the computer 200 can initiate processes associated with the production of a client video, e.g., prompt a host 220 to call the client into an interview session and provide a “start interview” toggle to the host 220. The “start interview” toggle can be activated by a host 220 to initiate the automated interview and video clip production process described below in reference to FIGS. 4A-G. In certain embodiments, the client 222 is not provided with a host (e.g. fully automatic process). The system may initiate processes associated with the production of a client video, e.g. prompt the client 222 to talk about specific topics 146 and press a button or say a command to bring up the next topic or talk until the next topic automatically appears on a screen while the video clips are being filmed and produced.

In some embodiments, the studio includes video display in a public waiting area. The computer 200, after receiving coded information 344, can determine an approximate waiting time for each client based upon availability of interviewers 220. The approximate waiting time can be displayed on the public display, or electronically messaged to each client.

Any of the cameras 210A-N can comprise a web camera, a digital video camera, a standard definition camcorder, or high definition camcorder. As an example, a camera 210 can include internal memory and a USB or Ethernet interface apparatus, or firewire interface or composite or component connections or any other video connection from a video camera to a computer for placing the camera in communication with the computer 200. The camera 210 can include optical and/or digital zoom and a multi megapixel CMOS recording array. The camera can further include a built-in microphone, or one or more audio jacks for connecting microphones. In some embodiments, the cameras 210A-N comprise mini-DV standard definition cameras. The cameras can be connected directly to the computer 200 via an audio/video connection (e.g. Firewire, USB, Component, Composite, S-Video, or any other data cable to allow optimal streaming functionalities of video and/or audio from the cameras into the computer). In some embodiments, the cameras 210A-N are in wireless communication with the computer 200. A camera data feed is recognized by software of the video production system 400, captured and recorded, and used to produce video clips representative of segments of the client interview. The cameras 210A-N can be located at different positions, have different viewing angles, focus and field of view. In some embodiments, viewing angles and fields of view of the cameras are selected by the client, e.g., selected online and included with information provided on the V-ticket. In some embodiments, camera features and filming aspects are automatically controlled by the computer 200 during an interview. The camera 210 can be mounted on a fixed apparatus, e.g., a tripod, or can be mounted on motion-control apparatus. The motion-control apparatus can be controlled by the computer 200 to move one or more cameras 210A-N during an interview session.

The camera 210A-N may be any type and form of camera. In some embodiments, the camera 210A-N is a Mini-DV Camera capable of capturing, reproducing and transmitting a audio/video stream to a such as the ones made by Panasonic, Canon, Sony. In some embodiments, the video cameras 210A-N are Full HD cameras capable of capturing and reproducing, and transmitting an audio/video stream to a computer such as the ones made by Canon, Sony, Panasonic.

An embodiment of camera framing of a client during an interview is depicted in FIG. 2B. For this embodiment, two cameras provide video feed to the computer 200 (not shown). A first camera frame 260A has a field of view capturing a majority of the client's body in the frame. A second camera frame 260B has a field of view capturing substantially the client's head and shoulders in the frame. Additional cameras providing various viewing angles and fields of view can provide additional video feeds to the computer 200 in other embodiments.

The microphone 206 may be any type and form of microphone and may be located or positioned in any desired manner. In certain embodiments, the microphone 206 is an on-body microphone which can perform effective sound capture from the client 222. In other embodiments, the microphone is an on-stand microphone positioned on a table, hung from the ceiling, or positioned on the floor. The microphone can be positioned as close to the client's mouth as possible without impeding view of the client's face. The microphone can be connected directly to the computer 200 via electronic or optical cabling, or by a wireless connection. In various embodiments, the video production system 400 is adapted to receive and recognize audio feed from each microphone 206 as shown in FIG. 4A.

The studio 113 can further include a visual background 225. The background 225 can be an aesthetically pleasing arrangement of objects in one embodiment. In another embodiment, the background is a neutral background, e.g., a blue screen. The background is composed of a certain arrangement of objects and colors that will be a part of the filmed frame of the camera surrounding the client 222. In some embodiments, the background 225 comprises electronic images or designs selectable by the client and is added electronically to video clips.

Various kinds of furniture 224 can be included in the studio 113. The furniture can comprise at least a first comfortable chair 224B facing a camera and a second chair 224A. The chairs can be at an angle towards each other. The arrangement of chairs can allow the host 220 and the client 222 to converse with each other while remaining visible to one or more cameras. As such, a viewer of a client video will be able to observe the interview from an optimal view point. Additional furniture 224C, e.g., a table, can be included in the studio.

### III.D. Interview

Although generally described herein as an interview, the term “interview” includes any communication or self-expression or talking or speech or mannerism or body language expressed by a client 222 in the context of and for the purpose of being filmed for the production of one or multiple video clips. The self-expression of a client through talking may be answers to questions, a presentation, a “talk”, a monologue, a dialogue, a public discourse, a speech, a group interaction, an act, a prompted recitation, a dialogue, a “chat” or an interview of any kind For example, a client may be asked to give a presentation lasting 2-5 minutes, 5-10 minutes, 10-15 minutes about a specific topic. Also, a client may be asked to answer specific questions. Also, a client may be asked to converse on a topic for a pre-determined amount of time (e.g.: 30-60 seconds, 1-2 minutes, 2-5 minutes). The self-expression of a client is however not limited to talking or speaking, since it may include listening, thinking, pondering, waiting, expressing facial expressions and demonstrating body language. All these are included in the term “Interview” for the purposes of the teachings contained herein.

In various embodiments, an interview of a client 222 is carried out at the studio 113 under the direction of a host 220. In certain embodiments, the client 222 is required to schedule an appointment to visit the studio for the production of his/her video clips. In other embodiments, the client may show up at any time within opening hours with no prior appointment. In certain embodiments, the host 220 is an employee that will receive the client 222 and will operate the video production system 400. The host 220 can explain the interview process to the client 222, and may or may not direct the code reading of a client's V-ticket 111. In various embodiments, the host 220 reads conversational topics 146_{PQR1-N} displayed on the computer screen 204 during the interview. In some embodiments, profiles of a plurality of hosts are provided, by the video networking system 5, to the client 222 during or after a client's registration and the client can select a host 220 based upon the profiles for an interview session. In certain embodiments, the host 220 is not an employee, e.g., the host is a friend or acquaintance of the client. The client 222 can identify a non-employee host during or after the client's registration, and the video networking system 5 can provide interviewing instructions to the identified host 220 prior to an interview. The client-identified host, after reviewing the instructions, can perform any or all of the above mentioned tasks relating to the interview.

In various embodiments, the video filming and production of a client 222 is carried out at a studio 113 without the presence of a host 220. The client 222 is instructed by the system to express himself/herself on the topics 146_{PQR1-N} by the system upon the scanning of the barcode on a V-Ticket. The system serves the topics 146_{PQR1-N} through on-screen display or playing pre-recorded audio or audio/video recordings of the topics 146_{PQR1-N} to the client 222.

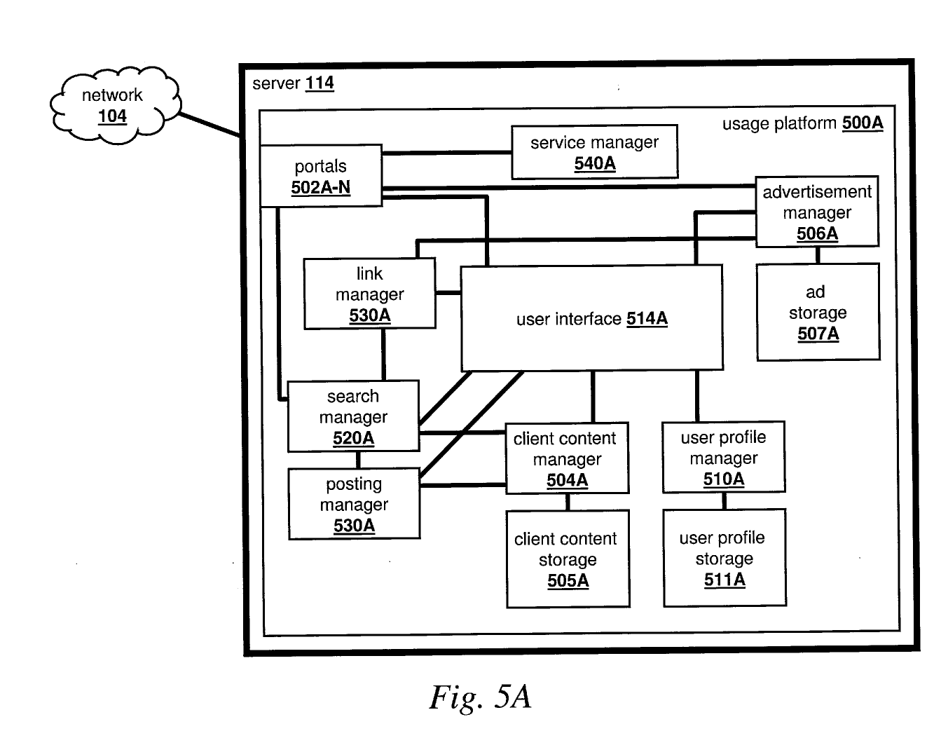

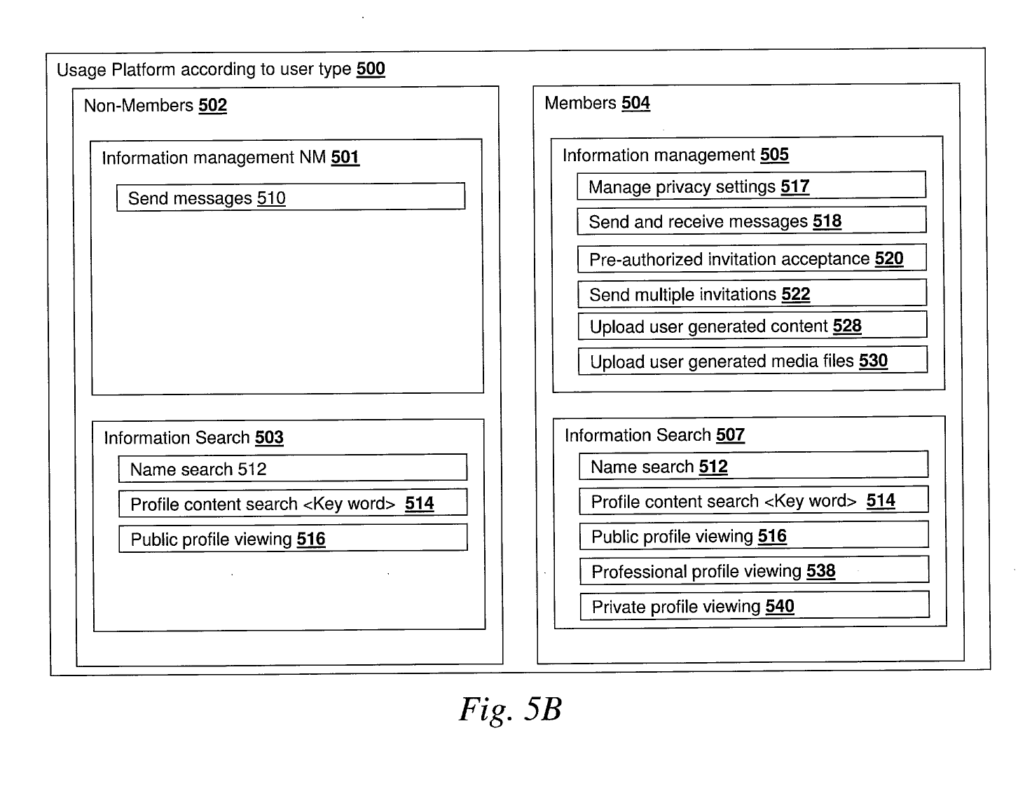

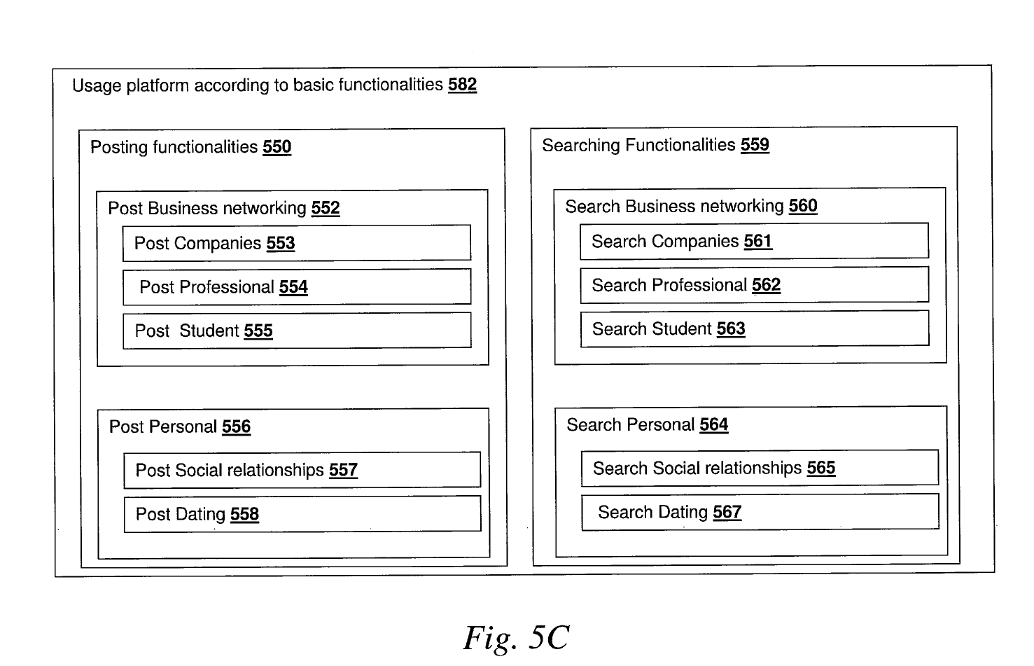

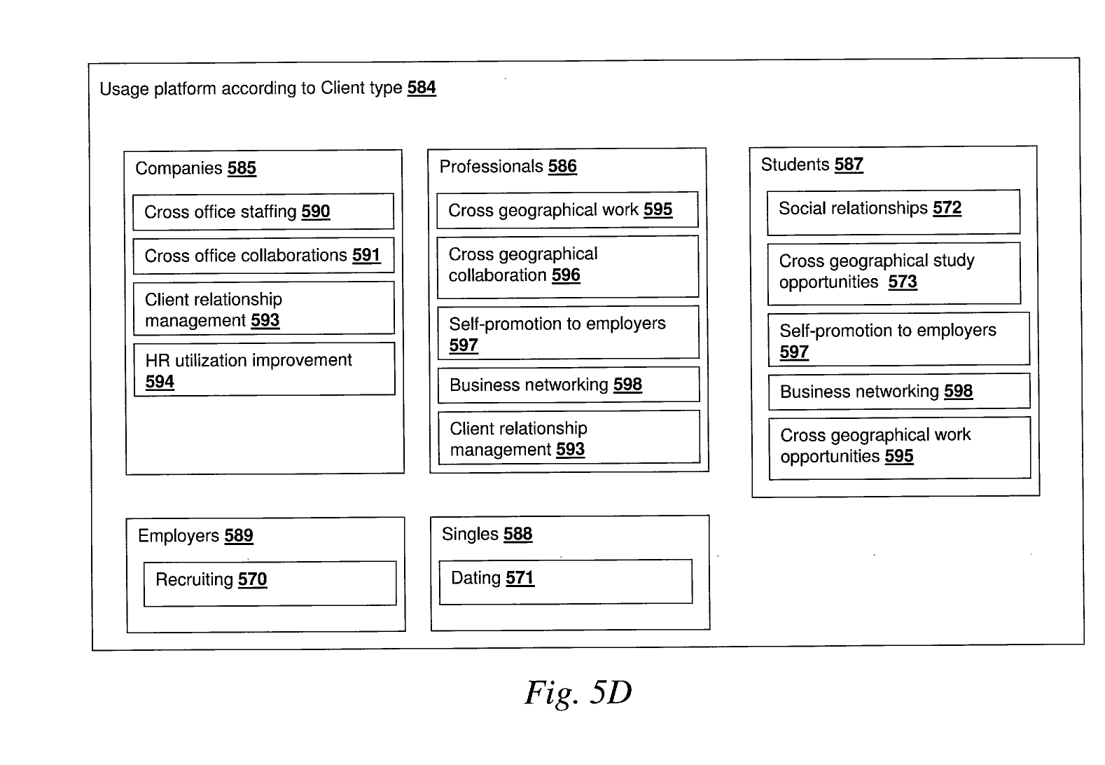

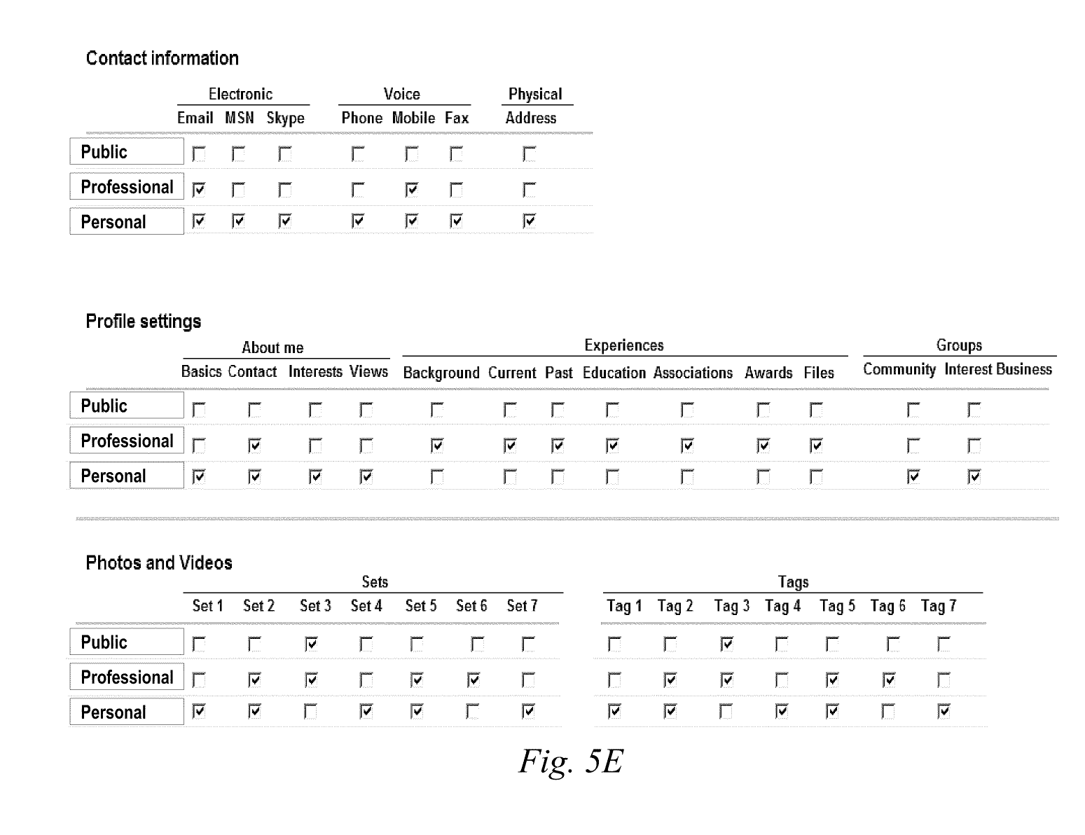

The client 222 can be any person who has registered with the video networking system 5. In some embodiments, the client may pay a flat fee and/or subscription fee for access to the video networking system 5. The client can be a young adult, adult, or senior citizen. The client can be any person wishing to benefit from the video networking system 5 and the usage platform 500A as described in FIGS. 5A-5D.

In various embodiments, an interview of the video networking system 5 is carried out according to a preselected format. For human communication to occur, there is a need for a polar dynamic to be present: the sending polarity and the receiving polarity. A sending polarity needs to connect with a receiving polarity for communication to flow through speech or other means. Therefore, the client 222 should connect with a listening party (interviewer 220) for communication to flow from the client 222 to the interviewer. Such a communication flow or interview style can enable the viewer of a video clip of the interview to make an assessment of the client 222.

In some embodiments, the interview style for allowing client 222 to communicate his/her personality and soft skills is a “conversational interview”. In other embodiments, the exchange between the client 222 and the host is a In such an interview, the client engages in an informal but serious conversation with the host 220. A conversationalist interview style allows for clients to engage in creative thinking and self-expression in a genuine and natural manner. The conversational interview style can be achieved through asking the client to converse about an open-ended conversation topic rather than asking a specific question with a right/wrong answer. Conversational topics can be submitted to the client during the interview, and the client can be asked to discuss these topics in an informal manner.

Some interpersonal elements that can be encompassed by such a conversation are: relating a story, explaining a concept or a distinction, communicating an opinion, etc. Certain advantages of this style of interview can include: providing a format in which the client can be engaged in a conversation in a relaxed, non-threatening manner, and eliminating a conversation directed to “right” or “wrong” answer to the subject being discussed. Such an interview format can allow the client 222 to appear in a favorable manner during the interview and put him/her at ease. When the client is at ease, there are greater chances that his/her personality will shine forth unhindered by the inhibitive and suppressive psychological elements present in stressful exchanges.

To stimulate a lengthy answer to a short question, we have created an interview format that significantly differs from the traditional question/answer format. Instead of asking a traditional question to the client 222, the host 220 submits a conversational topic that the client is asked to discuss for a predetermined period of time. The client is instructed to either tell a story, give an opinion, or in any other way, shape or form, converse about the topic for the predetermined period of time. In various embodiments, the topic submitted to the client is not provided in a question form. The topic can simply comprise a statement that is designed to trigger a series of memories, opinions or stories that the client 222 can relate to the host 220. For example, one topic can be “favorite Seinfeld episode” to a client who has chosen “Sitcom comedy” as a conversation theme. The client can be asked to converse about a “favorite Seinfeld episode” for the predetermined period of time. In such an embodiment, the client can elect to tell a story of his/her favorite Seinfeld episode, but may also talk about a friend's favorite Seinfeld episode, or may even simply converse about not having a favorite Seinfeld episode because he/she does not watch Seinfeld and go on talking about how everyone seems to watch Seinfeld and how he/she feels about that. As such, the submitted conversational topic is simply a stimulus for the client 222 to converse and communicate with the host 220 and general audience who may subsequently view the recorded interview. The content of the conversation can be varied, not predetermined, and of lesser relevance. Aspects of the conversation, e.g., communication between the client 222 and host 220, client facial expressions, client body language, client mannerisms and expressions, can be captured during the interview and provide a vehicle through which the client's personality will shine. A subsequent viewer of the video can then be able to make an assessment regarding an affinity he may or may not have with the client.

One benefit of the interview style of the online video networking system 5 is that the host 220 talks very little and the client 222 does most of the talking, e.g., gets most of the air-time. The interview format can guarantee that the client 222 will have a majority of air time talking independently of where automated camera cuts and/or switches occur. In other words, the interview style of the online video networking system 5 is highly compatible with an automated filming and production process described elsewhere herein.

An additional benefit of the interview style of the online networking system is that the interview style can avoid a self-directed, CV-style type of interview and provide topics with which a number of viewers may have familiarity. The interview style can be more appealing to a viewer of the interview. A conversational topic can be more interesting when the viewer has preconceived notions about the topic, because a familiar topic can allow the viewer to instantly relate to and understand, sometimes in an intimate manner, the conversation at hand. For example, if the conversation topic is “favourite Seinfeld episode” and the viewer regularly watches Seinfeld, the viewer will readily relate to the conversation and be more interested in what the client 222 has to say than if the client is talking about a topic that has no impact or relation to the viewer, such as where the client 222 went to school or the client's previous employment history.

The interview format of the online video networking system 5 comprises an interview in which the client 222 has a certain level of comfort and familiarity with topics to be discussed during the interview. The level of comfort and familiarity can be assured by allowing the client 222 to preselect items of conversation which will relate to conversational topics raised during an interview. Pre-selection of items of conversation can be done by the client 222 accessing the video networking system 5 online In various embodiments, the networking system 5 comprises a proprietary conversational topics database and a theme selection module 103 which the client 222 uses to structure the conversational format of the interview.

In various embodiments, an effective virtual context of evaluating and assessing an unknown person is through a filmed interview. The interview style can comprise a conversational interview where the client 222 has pre-selected a series of conversation themes from a databases comprising a set of categories 140, sub-categories 142, and themes 144. Each theme 144_{PQR} is linked to a series of conversation topics 146_{PQR1-N} as described further below. In various embodiments, the client 222 is not exposed to conversational topics 146_{PQR1-N} which have been assigned to the client. Non-exposure to conversational topics can ensure a level of spontaneity during the interview. Each conversational topic is submitted to the client 222 for the first time during the interview, and the client is asked to discuss the topic for a first predetermined period of time, e.g., a time interval between about 30 seconds and about 90 seconds, between about 1 minute and about 2 minutes, between about 1 minute and about 5 minutes, between about 2 minutes and about 10 minutes. Other periods of time for each conversational topic can be preselected by the networking system 5, the client 222 or the host 220. A predetermined number of conversational topics 146_{PQR1-N} are submitted sequentially to the client 222 to generate a conversation between an interviewer 220 and the client 222 for a second predetermined period of time, e.g., a time interval between about 2 minutes and about 6 minutes, between about 4 minutes and about 12 minutes, between about 10 minutes and about 30 minutes. Other periods of time for a total interview length can be preselected by the networking system 5, the client 222 or the host 220.

In various embodiments, conversational topics are provided to the host 220 via the studio display 204. Each topic 146_{PQR1-N} can be displayed on the screen. The screen can further display a time indicator, indicating an amount of time allocated for the current conversational topic and/or an amount of time remaining for the current topic. In some embodiments, a time indicator, e.g., a clock, or indicating lights, can also be provided for viewing by the client so that the client can determine an amount of time allotted and an amount of time remaining for a conversational topic. In certain embodiments, the video networking system 5 also provides “talking point” prompts on the display 204 for optional use by the host 220 during the interview. For example, if there is a lull in conversation by the client, the host may utilize a talking point to re-stimulate the client's conversation.

Such an interview style can enable a subsequent viewer of the recorded interview to make an assessment of the client's communication skills, personality and personal affinity in general through viewing the client's interaction with the host during the interview. The pre-selection of conversation themes 144_{PQ1-N} by the client 222 and automatic prompting of topics to the interviewer can prevent a substantial investment of energy and time by the host 220 in preparing for such an interview. Theme pre-selection and automatic prompting can reduce personnel costs associated with a hired interviewer 220 and thereby provide for a low-cost method of achieving a dynamic, customized, and client-targeted interview.

To enable a conversational interview, the content being discussed during the interview needs to be aligned with the client's interests. Traditional ways of identifying such interview topics would be for the host to perform prior research on the client using the client's CV and/or other material related to the client including online searches to identify subject matters of relevance to the client 222. Client-directed research can be a cost intensive way to identify topics of interest to the client. We have devised an innovative way for conversational topic identification for each client 222. We have created a proprietary database of conversation topics that spans a broad range of subject matters and interest areas. The conversational topics database 146 is linked to a conversational themes database 144. Clients are directed to choose a predetermined number of themes from the themes database 144. Each theme is linked to a plurality of conversation topics. Although the client 222 chooses the conversation themes, he/she does not know which specific conversational topic will be provided to him/her during the interview. Choice of conversation themes but not of conversational topics allows the client to chose the specific conversation theme, but does not allow him/her to prepare an answer for the specific conversational topic to be discussed. Precluding prior preparation assures a level of spontaneity and naturalness associated with answering a question or the first time.

During the interview, a predetermined number of conversational topics will be submitted to the client 222 to stimulate a discussion, which can be filmed. The conversational themes database 151 is organized in such a way to cover a broad range of conversational areas. To build such a database, we based the database on human needs and interests ranging from basic needs to higher level needs such as needs for fulfillment and spiritual needs. We then supplemented the database with other conversation topics that might be of interest to an individual familiar with a particular area of conversational themes.

By way of example, to facilitate the choice amongst a seemingly endless array of conversation topics, we chose a first predetermined number of categories for the categories database 140 of conversational areas based on human needs and interests such as basic needs, entertainment, and spirituality. We then identified a second predetermined number of subcategories to each category to create a subcategory database 142. The subcategories were chosen to be as broad as possible to cover the wide range of conversation topics possible within each category 140_{1-N}. We also identified a third predetermined number of conversational themes for each subcategory to create a conversational themes database 144. The conversational themes were also designed to be as wide as possible to cover a range of conversational topics within each subcategory. We then identified a plurality of conversation topics for each conversational theme to create a conversational topics database 146. Conversational topics were created such that they have no right or wrong answer but rather stimulate the client 222 to discuss and convey thoughts that are conjured up by the topic. For instance the client 222 might remember a story or an incident related to the conversational topic, e.g., “overdressing” can evoke a story related to overdressing at an event. The client 222 might also have views and thoughts around a topic that he might wish to express that are unrelated to any stories or experiences from the past. The objective of presenting the client with a conversational topic is to stimulate the client 222 to express and communicate thoughts or to relate experiences in an intelligible and self-expressive manner so as to allow the viewers to gain a sense for the client's personality and soft-skills.

The theme selection module 130 can provide access to a plurality of databases relating to conversational topics. In certain embodiments, the theme selection module accesses a conversation category database 140, a conversation subcategory database 142, a conversation theme database 144, and a proprietary conversational topics database 146. In some embodiments, there are fewer databases, e.g., a conversation category database 140 and a conversational topics database 146. In some embodiments, there are more databases, e.g., an additional database comprising talking points relating to conversational topics. The structure of the databases can be hierarchical. As an example, the conversation category database 140 can comprise a first predetermined number of conversation categories, e.g., fishing, history, sports, religion, music. The conversation sub-category database 142 can comprise a second predetermined number of sub-categories for each conversational category, e.g., fresh water fishing, salt-water fishing; ancient history, medieval history, modern history; contact sports, non-contact sports, recreational sports; Judaism, Christianity, Islamism, Atheism, Buddhism, Hinduism; classical music, non-classical music. The conversation theme database 144 cam comprise a third predetermined number of themes for each sub-category, as can be appreciated in view of the foregoing examples. The conversational topics database 146 can comprise a fourth predetermined number of conversational topics for each theme, as can also be appreciated. In certain embodiments, there are about 15 categories in the category database 140, each category relates to about 15 subcategories in the subcategory database 142, and each subcategory relates to about 15 themes in the themes database 144. Each theme relates to a number of conversational topics in the conversational topics database 146.

As depicted in FIG. 1D, the client 222 can choose online a conversation category 140₃. Once chosen, the system can automatically display the subcategories associated with the chosen category. Once a subcategory is chosen, the system can automatically display the themes associated with the chosen subcategory. Once the theme is chosen, the theme can be recorded in the client's profile 134. The client can then be prompted to repeat the process until a predetermined number themes are chosen, e.g., between about 2 themes and about 6 themes, between about 4 themes and about 12 themes. As an example, and referring to FIG. 1D, if client chooses category <3> 140₃, subcategories 142_{31-N} are displayed. If client chooses subcategory 142₃₂, then themes 144_{321-N} are displayed. If client chooses theme 144₃₂₃, the theme is then logged in the system and he/she repeats the process to chose an additional predetermined number of themes.

Once the client has chosen a predetermined number of themes, the video networking system 5 automatically assigns at random a conversational topic to each chosen theme according to the topics 146_{PQR1-N} associated with each theme 144_{PQ1-N}. Continuing with the example above for theme 144₃₂₃, the system 5 selects at random a conversational topic from the list of topics 146_{3231-N} associated with theme 144₃₂₃. The conversational topics are not revealed to the client 222 before the interview, and will be submitted to the client by the host during the interview to stimulate a conversation.

During the interview, a series of video clips 430 is produced by the video production system 400. In certain embodiments, to produce a series of video clips of the client 222, the client 222 is asked to read a script, or perform a presentation, or answer a series of questions, or to perform a performance or an act, or to in any other way, shape or form, express himself/herself with the purpose of being filmed for the production of a series of video clips.

In various embodiments, to produce a series of video clips of the client 222, the client participates in the interview for a predetermined amount of time, e.g., about 5 minutes, at the studio 113. In some embodiments, prior to the interview, the host 220 informs the client 222 that he will get a first predetermined amount of time, e.g., 5 minutes, to discuss all of a plurality of conversational topics identified by the video networking system 5 from the themes the client chose online. The client 222 can be informed that he/she will be allowed a second predetermined amount of time to discuss each topic. The second predetermined amount of time can be the first predetermined amount of time divided by the number of topics to be discussed during the interview. During the interview, the host 220 can ask the client 222 to converse for about the second predetermined amount of time about each conversational topic: If the client talks for a longer duration about a topic, he/she can risk missing the opportunity of discussing all topics selected. If the client talks too little about each topic, he will risk having less material than needed for the production of the video clips. The client is therefore incentivized to attempt to converse for about the second predetermined amount of time for each topic presented to him/her.

In certain embodiments, the client 222 is provided with a trigger mechanism, e.g., an electronic signaling device, to signal when the client is about to or wishes to finish conversation of a particular topic and begin conversation of a new topic. In such an embodiment, the client 222 can moderate the second predetermined amount of time, and provide a signal to the video production system 400 to fade out of a particular topic's discussion.

The interview process and topic presentation process of the online video networking system 5 is designed such that if a specific conversational topic is of little interest to the client 222, the client will spend less time discussing it. Conversely, if another topic is of particular interest to the client, he/she will spend more time discussing it. Therefore, there is a natural selection of conversational topics discussed during the interview such as more time is necessarily spent on topics that are of greater interest to the client. The interview process significantly increases the chance that the random automated production of video clips coincides with a subject that is of great interest to the client. We have thus designed a system that statistically maximizes the chances of producing video clips on an automated basis that are highly interesting and lively, and which are conducive to illustrating a client's communication skills. In various embodiments, the interview methods described above minimize or eliminate extensive research or preparation by the host 220 for each client 222, thus providing a cost-effective interview process.

In various embodiments, when the client 222 visits the video studio 113, he/she submits a V-ticket 111 in preparation for the interview. As described above, the V-ticket 111 contains the codes of a predetermined number of conversational topics assigned to the client 222 by the video networking system 5. At the studio 113, the video production system 400 can match each one of the topics codes with the appropriate conversational topics. In some embodiments, the host receives the V-ticket 111 having the topic codes. The host 220 can provide the V-ticket 111 to the video production system 400, e.g., scan the ticket with the code reader 202. After receiving the topic codes, the video production system 400 can access the themes selection database 151 to determine conversational topics associated with the topic codes. In some embodiments, the themes database 151 resides on the local studio computer 200. In some embodiments, the local computer 200 accesses the themes database 151 over a network 104. In various embodiments, the video production system 400 displays the conversational topics on the display 204, which can be read by the host 220 but not by the client 200. In some embodiments, the display is located so that both the host and client can read the conversational topics as they are presented to the client. In some embodiments, the client and audience/viewers can read the topic being discussed on a screen. Once displayed, the conversational topics can be read by the host 220 to the client 222 one at a time to ensure a smooth and stimulating conversation. In some embodiments, all conversational topics are displayed on the display 204 at the start of an interview. In some embodiments, the conversational topics are displayed one at a time in response to an electronic “trigger” signal provided by the client 222. In some embodiments, the conversational topics are displayed one at a time after the predetermined amount of time allocated for each topic elapses. In some embodiments, the topics are displayed on a screen by the system. In some embodiments, the topics are pre-recorded audio files and are played back to the client so that he/she can hear them when appropriate. In some embodiments, the selected topics are pre-recorded video files of an actor presenting the topics that are played back to the client on a video display where either the client or client and audience can view the playback of the topics.

### III.E. Filming and Production of Client Video

In various embodiments, a client video produced from an interview as described above conveys a client's personality, character traits, communications skill and soft skills. A person's personality cannot be effectively captured by a still camera. Personality traits are best portrayed and communicated through a dynamic interaction a client may have with another person. Through a dynamic interaction, such things as thought reactions, mannerisms, speech patterns, facial expressions, attention span, and body language can be assessed. In order to capture such a dynamic interaction, in some embodiments, the video networking system 5 records and produces video clips of client interviews.

A client's soft skills, including personality traits and communication skills, are a subjective set of skills and can be difficult to assess. Furthermore, they are only displayed as a dynamic set of reactions and interactions observable only in a communication setting or interaction with another person. A client's communication style can be evaluated to gather information about the client, because one's communication style can provide a gateway to that person's internal space. Furthermore, a client's communications can reveal information about the client's educational level, general competencies, attention level, ability to relate to others, thought patterns and general personality and character traits. In some instances, assessments of personal affinity can be made in a very short period of time if the person is observed while communicating with another person. The client videos produced in accordance with certain teachings herein can provide a viewer with information useful for assessing various soft skills of the client.

In various embodiments, production of a client video begins with a client 222 visiting a studio 113 adapted for operation with the video networking system 5. In some embodiments, the client 222 completes a registration process, selection of conversation themes and creation of the V-ticket 111 using a home computer with online access prior to visiting the studio, or a computer station located in the waiting area of the studio. The computer station at the studio can also have online access to a network 104. In some embodiments, the client 222 completes the registration process, selection of themes and creation of the V-ticket using a computer at a remote location with online access. In some embodiments, the client 222 completes the registration process, selection of themes and creation of the V-ticket using any portable electronic device having access to an application or code provided by the video networking system 5. If the registration process is done from a remote location, the client 222 may travel to the closest studio location identified by the networking system 5 to participate in the filmed interview. If the client 222 registers at the studio 113, no traveling is needed. During an interview, video clips 430A-N are produced of the client 222, as described in detail below, and the video clips can later be reviewed and selected by the client for inclusion in a client profile, such as a client profile on the usage platform described below.

FIG. 2B is a block diagram of an embodiment of an arrangement of cameras at the studio for filming a client interview. In certain embodiments, there are at least two cameras disposed to capture in a first camera 210A a field of view of a majority of the client's body and in a second camera 210B a field of view of the client's head and optionally shoulders. The at least two camera views or frames can allow a viewer of the client video to gain an appreciation of both full body as well as facial expressions of the client. A camera frame covering a majority of the client's body, e.g., head to below the knees, can provide information representative of the client's 222 body language, posture, demeanor, mannerisms and ways of being. A camera frame focusing on the client's face in greater detail can provide information representative of the client's 222 verbal communication, facial expressions, and personality. Additional cameras can be disposed at the studio to capture additional details and aspects of the client 222 during the conversation.

As illustrated in the embodiment of FIG. 2B, two cameras are disposed at the studio 113 for filming the client during the interview. The first camera 210A can produce a frame 260A large enough to capture the client's body from the head to below the knees in a sitting position. The first camera 210A can be at an angle with respect to a front direction of the client's body, e.g., angled with view from the front right or left side of the client 222. The first camera 210A can be dedicated to capturing client's overall body language. In contrast, the second camera 210B can produce a close-up frame 260B of the client 222 from the top of the head to just below the shoulders. The second camera 210B can be directly aligned in front of the client facing the client's face, and can be at an angle from a forward direction of the client, e.g., at a small angle to the left, right, up or down directions from a direction directly forward of the client's face. The second camera 210B can be dedicated to focusing at the client's facial expressions. In some embodiments, one or more of the cameras 210A-N disposed to film the client 222 are mobile during the interview, e.g., moved by automated motion apparatus controlled by the video networking system 5.

In various embodiments, the online video networking system 5 provides systems and methods for intelligent, automated, real-time, and cost effective production of video clips 430A-N of a client 222 during an interview session at a studio 113. Various features of the video production system 400 contribute to a substantial reduction in labor and related costs associated with the filming and production of a client video. As an example, automation of video clip production, as described below, can eliminate the need for a hired audio-visual technician to operate cameras and sound recording devices and/or a post-production artist to perform cuts from various camera footage to produce one video clip from multiple camera feeds.

In various embodiments, the automation of video clips production is possible through the automation of the camera switches according a pre-determined set of random sequence and duration of each switch according to a specific programmable set of principles, parameters, limitations, and guidelines described hereinafter. In some embodiments, the decision of when the switch occurs is unrelated to the actual content of the video. As such, in some of these embodiments, the switch durations are not coupled to the content or the subject matter of the video. In some aspects, the switch durations are disparate from the interview or video. In other embodiments, the decision of when to switch may be based on the type and/or style of interview. The automation of these camera switches resulting in the full automation of the production of video clip (e g taking the human element out of the decision of when a camera switch actually occurs) results in a significant cost reduction of producing such a video clips.

The set of principles and guidelines for performing successful automated camera switches include but are not limited to: (1) ensuring high-quality filming equipment is used including multiple high-quality cameras, lighting and sound capture, (2) using multiple cameras with multiple camera angles, fields of view and focuses, (3) automatically recording, by the video production system 400, a predetermined number of video clips during an interview of the client, (4) beginning each video clip with an audio and video fade-in to allow for the viewers to have a smooth transition into the conversation despite the random start point of the video clip in the conversation, e.g., a video clip could start mid-sentence, and to allow for the automated random start and end points of a video clip, (5) ending each video clip with an audio and video fade-out to allow for the viewers to have a smooth transition out of the conversation despite the random end point of the video clip in the conversation, e.g., a video clip could end mid-sentence, to allow for the automated random start and end point of a video clip, (6) executing automatic camera switches according to a camera switching algorithm or database, (7) starting each video clip with the feed from the camera focused on a majority of the client's body to allow the viewer to gain a first impression of the client's body language, (8) ensuring that a second camera frame within a video clip is the feed from a camera focused on the client's face, to allow the viewer to foster a sense of intimacy with the client through a better appreciation of the client's facial expressions, (9) including in each video clip a total duration of feed from the camera focused on the client's face that is a greater duration than the duration of the feed focused on the overall body of the client given the importance of facial expressions when assessing personality traits, (10) ensuring that each camera switch should not be shorter than a first predetermined amount of time, e.g., 5 seconds, to avoid giving the viewer a rushed and abrupt experience, (11) ensuring that each camera switch is not longer than a second predetermined amount of time, e.g., 20 seconds, to avoid loss of attention and loss of interest by the viewer, (12) ensuring that camera switches occur in an apparently random manner so as to seem un-automated to the viewer, (13) ensuring that video clips are spaced by a third predetermined amount of time, e.g., 30 seconds, to allow for changing of conversational topics, and (14) ensuring that each session a predetermined plural number of video clips from which the client 222 can select one or more preferred clips to produce a client video.

In various embodiments, the camera switches are semi-automated according to the principles mentioned in these teachings, and semi-controlled by the client 222 and/or the interviewer 220 using a manual electronic signaling device. For example, the client or the host may indicate to the video production system via an electronic signal or queue when to make a camera switch, end a duration of a video feed or to change camera angles or other controls of any of the cameras.

FIG. 4A is a block diagram of an embodiment of a video production system 400. The video production system 400 can comprise software, firmware, hardware or any combination thereof in operation on a computer 200. In some embodiments, the video production system 400 is interfaced with additional software and/or hardware, e.g., network 104, code reader 202, display 204, microphone 206, cameras 210A-N, and video networking system 5 via internet 104.

In certain embodiments, the video production system 400 further comprises a plurality of cameras 210A-N and one or more microphones 206 providing video feeds 410A-N and audio feeds 406 to the studio computer 200. The video feeds are controlled by a switcher 412 which is linked to a camera switching database 405. An audio video capture and production tool 420 can receive data from the audio feed 406, video switcher 412, fade-in/fade-out settings 413, logo 414, and code reader 202. The audio video capture and production tool 420 can process the received data to produce video clips 430A-N. In some embodiments, one or more microphones 206A-N is disposed with one or more cameras 210A-N, and each camera provides audio and video feeds.

The switcher 412 can comprise an application, a program, a library, a device driver, a script, a task, a service, a process, or executable instructions executing on any type and form of hardware. In some embodiments, the switcher 412 comprises circuitry to perform any of the operations and functions described herein and ascribed to the switcher 412. In certain embodiments, the switcher 412 comprises instructions executing on a processor, e.g., on a processor of the computer 200 or on a processor of a computing machine in communication with the computer 200. In some embodiments, the switcher 412 comprises a combination of instructions executing on a processor and hardware in communication with the processor. In certain embodiments, the switcher 412 comprises an instrument adapted to receive plural video feeds 410A-N and data from a switching database 405 and provide a single video feed as output. The switcher can use the data from the switching database to switch between the plural received video feeds 410A-N and determine the length of each received video feed provided as output in the single video feed output stream from the switcher 412. The switcher 412 can comprise an electronically controlled video data switch. In some embodiments, the switcher 412 is adapted to receive both video feeds 410A-N and audio feeds 406A-N. In some embodiments, the switcher provides and/or receives a single audio feed output, which may or may not be combined with the video feed. In some embodiments, the switcher is a software application that dictates which feeds to record at any given point in time. In such embodiments, a predetermined amount of time can be recorded of each feed in a sequence, resulting in the effective switching between a plurality of audio and video feeds.

In some embodiments, data received from the code reader 202 prompts the audio video capture and production tool 420 to start the video capture and production process. Produced video clips 430A-N can be named and labeled by a naming and labeling tool 425 according to information input received from the code reader 202. The named and labeled video clips can be uploaded automatically, by the video production system 400, to the network 104.

The video production system 400 can also receive input from the code reader 202 and identify conversational topics 146_{PQR1-N} for an interview based on data received from the code reader 202 representative of the topic codes 145_{PQR1-N} for a client. As an example, after a barcode from a printed V-ticket 111 has been scanned, the topic codes 145_{PQR1-N} are matched against entries in a topic database 150 to determine conversational topics 146_{PQR1-N} for a particular client 222. In certain embodiments, a topics identifier module 406 identifies the conversational topics 146_{PQR1-N} to be displayed on the display 204 during the interview. Once displayed on the screen 204, the host 220 can read the conversational topics to the client 222.

In various embodiments, the switcher 412 accesses the switches database 405 to select a video feed from among the plurality of video feeds 410A-N to provide to the audio video capture and production tool 420. As such, the audio video capture and production tool 420 can be exposed to one video feed at a time and include the currently selected video feed in a produced video clip.

Aspects of camera switching will now be described. Standard and widely used techniques in video production relating to camera switching generally follow one of two types, none of which are automated: (1) movie production techniques and (2) live broadcast techniques. In a movie production technique, footage is filmed on a plurality of cameras separately and the final product is produced by selecting excerpts from each footage to be incorporated in the final product. Such a technique requires extensive post-production work and is time and cost intensive. On the other hand, live-broadcast production involves performing camera switches live for the purposes of television broadcasting and require a live operator that manually switches between camera feeds supplying the displayed/broadcasted image. In some “live-broadcasting” productions, the produced footage can be delayed by a short interval of time to provide a brief review and selection, by an operator, of a preferred section of footage. Although a live broadcasting technique allows for a real-time, or quasi real-time production to occur, live broadcasting requires the full-time presence of a skilled producer and therefore is also costly.

We have discovered that in the context of a client interview, high quality video clips can be obtained with automated electronic camera switches if the switches are executed according to certain principles and methods described below. The automated camera switching processes can provide for real-time production of video clips, e.g., without the need for recording footage from multiple cameras and subsequently editing and assembling desired footage, and also eliminate the need for a live producer, which can significantly decrease the cost of video clip production.

In various embodiments, the captured images from the cameras 210A-N are streamed directly to the video production system 400 without first being recorded by the cameras. In certain embodiments, the video feeds 410A-N are provided to a computer 200 on which the video production system 400 is in operation. The video production system 400 can then identify which camera feed to record and for how long. In this manner, production of video clips can be performed in real-time, according to a predetermined sequence of duration of switches between the different cameras, the duration of recording, and the pauses between recordings as depicted in one embodiment shown in FIG. 4C. This process of filming and producing video clips can greatly increase the efficiency and effectiveness of producing client videos. Automated video production methods present time-saving and cost-saving advantages compared to recording interview footage and manually producing the video clips subsequently in a non-automated manner.

In various embodiments, video clips 430A-N are produced automatically by video production system 400 according to predetermined durations and sequences of switches between a plurality of cameras. We have determined through research a set of guidelines for camera switches that can ensure an aesthetic and stimulating experience for the viewer, and that match best-in-class video production quality for interview videos produced by movie or live production techniques. Our research-derived guidelines include: (1) each video clip should begin with the camera frame covering the full body of the client 222 to allow a first overall impression of the client, (2) a majority, e.g., more than 50%, of the duration of each video clip should be derived from one or more cameras with fields of views restricted to the head or head and shoulders of the client so that facial expressions can be easily seen, (3) camera switches should not be shorter than about a few seconds, e.g., about 5 seconds, about 4 seconds, about 3 seconds, about 2 seconds, about 1 second, or about ½ second, to avoid a rushed presentation and experience for the viewer, (4) camera switches should not be longer than a few tens of seconds, e.g., about 10 seconds, about 20 seconds, about 30 seconds, to keep the interest and attention of the viewer, and (5) camera switches should occur in an apparently random manner so as to seem un-automated to the viewer. In various embodiments, the switcher 412 of the video production system 400 accesses a camera switching database 405 to automatically execute camera switches in accordance with these guidelines.

One reason for varying each video clip's sequences and duration is that each combination of duration and switches produces a different overall effect for each video clip. Clients can benefit from having the choice between video clips that have different sequences as certain sequences will be more complementary to different clients. Additionally, a viewing experience can be artistically more appealing and more interesting to have a high degree of variability between video clip switches to simulate the effect of a manual switching process—which is more aligned with the brain's patterns rather than a predictable and mechanical switching process.

We have developed the switches database 405 based on our premise that camera switches can be predetermined in the context of video production of an interview independently of the unfolding content of the interview itself. This premise was developed based on proprietary research that we performed with test subjects after careful study of a series of best-in-class interview productions and broadcasts.

To the inventors' knowledge, the real-time production of video clips using multiple feeds moderated automatically based upon a predetermined set of camera switches comprises an innovative approach to film production. As depicted in FIG. 4B, the use of a switcher mechanism 412 as an intermediary between multiple video feeds 410A-N and the audio video capture and production tool 420 provides for a technically efficient and cost-effective method of performing real-time production of video clips 430A-N. In various embodiments, the switcher 412 receives data from a camera switching database 405 and uses data from the database 405 to moderate the plurality of video feeds 410A-N provided to the A-V production tool 420. As an example, data from the database 405 is used by the switcher 412 to determine which video feed is provided to the production tool 420 and a time interval for providing the selected video feed. In this manner, a computer 200 can record only one feed even though multiple cameras may be in operation simultaneously. This process of film production can be done fully automatically and without human intervention, thereby substantially reducing or eliminating labor costs normally incurred for quality video production. This approach to film production is based in part on an assumption that, most of the time and when executed in accordance with the methods described herein, a camera switch can successfully occur anywhere within a video clip without the need for a professional artistic judgment of where to make a camera switch.

FIG. 4D is a block diagram of an embodiment of a camera switching database 405. As depicted in the figure, the camera switches for each video clip 430A-N can be encoded and described in one row, and can comprise a set of predetermined time durations for each camera 210A-N and a pause 441, e.g., a first duration 450A associated with a first camera 210A for a first video clip 430A, a second duration 452A associated with a second camera 210B for the first video clip 430A, . . . , and a pause duration 441 for the first video clip 430A. For example, video clip 430A can be comprised of footage or a video segment from a first camera 210A of a first duration 450A followed by a video segment from a second camera 210B of a second duration 452A followed by a video segment from a third camera 210N of a third duration 454A. The pause 441A can be used to create an unrecorded period, which can be added between the end of a first video clip 430A and the beginning of a second video clip 430B. In some cases an unrecorded period can be added between video segments from two cameras within a video clip, e.g., between video segments from camera 210B and camera 210N within video clip 430A.

In some embodiments, the durations 450A-N, 452A-N, 454A-N, and 441A-N are static values. For example, the values can be stored in a look-up table accessed by the switcher 412, or accessed by the computer 200 and provided to the switcher 412. Although the depiction of FIG. 4D shows one duration per camera per video clip, there can be plural durations per camera per video clip. The plural durations per camera can be of different values and selected at random by the switcher 412, or provided to the switcher, during production of each video clip. In some embodiments, the durations 450A-N, 452A-N, 454A-N, and 441A-N are dynamic values, e.g., random values assigned by a computer 200. In such embodiments, there may be only N, N+1 or N+2 duration values stored in the database 405, where N is the number of cameras and the one or two additional values correspond to pause durations between video clips and pause durations between camera switches. The switcher 412 can access, or be provided with, the N, N+1, or N+2 values for each video clip 430A-N currently in production. In certain embodiments, video feed from one or more cameras is used multiple times in the production of a video clip. In some embodiments, there are more camera switching events than the number of cameras 210A-N. In some embodiments, there are fewer camera switching events than the number of cameras.

The audio video production tool 420 provides for quality production of video clips 430A-N according to predetermined switches and pauses available from the switches database 405 as described above in reference to FIG. 4D. FIG. 4C is a representation of an embodiment of video clip generation during an interview session 450. Any times and portions of times shown in the figure are for heuristic purposes only, and can have different values in various embodiments of the online video networking system 5. An interview session 450 can last for an interview period of time, e.g., about 5 minutes as shown in the figure. During the interview, a predetermined number of conversational topics, e.g., about 5 topics, can be discussed. Each topic 146_{PQRN} can last a portion of the interview. As an example, each topic of 5 topics can last about 1 minute for a 5 minute interview. During the interview, at least a minimum number of video clips 430A-N will be produced, e.g., three video clips. The produced video clips can each be of a selected duration, e.g., between about 20 seconds and about 45 seconds in duration, interspersed by a predetermined pause duration, e.g., about 30 seconds. Through research and testing, we have determined that video clips lasting between about 20 seconds to about 45 seconds permit one to perform a personality assessment of an unknown individual and to create an impression of that individual's traits, mannerism, level of education, capabilities, soft skills, and communication dexterity. However, in certain embodiments, the duration of video clips can be shorter, e.g., up to about 5 second, up to about 10 seconds, up to about 15 seconds, up to about 20 seconds, or longer, e.g., between about 45 seconds and about 1 minute, between about 1 minute and about 2 minutes, between about 2 minutes and about 5 minutes. The video clips 430A-N can be of approximately the same duration or of different durations. The pauses 441A-N can allow for there to be a significant enough shift in the conversation to allow for each one of the three video clips to be significantly different in energy and in content from the others. The pauses 441A-N or unrecorded periods can be incorporated between each video clip 430A-N. In certain embodiments, the pauses 441A-N occur at transition points between conversational topics, e.g., encompassing the last few seconds of one topic and the first few seconds of a following topic. The pauses 441A-N can be of the same duration or of different durations. This method of recording and video clip production will give a varied sampling of the entire interview session 450.

In some embodiments, the timing of conversational topic transitions is fully automated, e.g., occurring on a predetermined time schedule as depicted in FIG. 4C. The time allotted for each conversational topic can of substantially the same value, or of different values. In some embodiments, the timing of conversational topic transitions is semi-automated, e.g., signaled to the video production system 400 by the client 222 or host 220 with a signaling device. When signaled by a client or host, the video production system 400 can initiate an end-of-clip process, e.g., fade out video, fade out audio, begin a pause.

In various embodiments, each video clip 430A-N begins with a fade-in and ends with a fade-out, both of which apply to both image and sound. Fade-in and fade-out processes can provide for seemingly smooth beginnings and ends to a video clip, even though the clip might start and end at random points in time in a discussion of a conversational topic during an interview session 450. The fade-in and fade-out processes can avoid an abrupt experience for a subsequent viewer of the video. Without fade-in and fade-out, beginning randomly a video clip at an opportune moment in the interview is difficult and primarily left to chance. Typically, the start of filming requires manually choosing a beginning and ending time, e.g., manually choosing the start of a video clip to coincide with the beginning of a new topic or new sentence. However, with the fade-in/fade-out features, there is no need to synchronize the beginning and ends of video clips 430A-N with specific event during the interview. Fade-in and fade-out routines are aspects of the online video networking system 5 which can permit the random timing of filming and automatic production of video clips during an interview session 450. In some embodiments, the audio video capture and production tool 420 performs a fade-in on the first feed's beginning while being recorded that lasts for a few seconds (e.g. 3 seconds or 4 seconds, or 5 seconds) in the beginning of the feed, and a fade out on the last feed's ending that lasts for a few seconds (e.g. 3 seconds or 4 seconds, or 5 seconds). In some embodiments, the fade-in and fade-outs affect both audio and video. In other embodiments, the fade-in and fade-outs only affect the audio but not the video. In other embodiments, the fade-in and fade-outs only affect the video but not the audio to give an audio pre-shadow of the conversation while the video is being faded in. The fade-ins and fade-outs are performed by the recording software application in the video production system once the switcher has determined which feed will be recorded. Any portion of the client production system may perform any of the control of the fade-ins and fade-outs. In some embodiments, the software application of the client production systems performs the fade-ins and fade-outs.

In some embodiments, there is an initial delay 440 between the start of the interview session 450 and the beginning of the first video clip to allow for the conversation momentum to gather and to allow the client 222 to become more comfortable in the overall process. The initial delay can be longer than a portion of time allotted to one conversational topic, or can be shorter than a portion of time allotted to one conversational topic. In some embodiments, a last portion 433 of the interview session 450 will not be recorded, since there can be a natural loss in energetic momentum while the client is anticipating the end of the interview. In some embodiments, the full interview session 450 is recorded. In some embodiments, multiple video clips are produced within a period encompassing discussion of one topic. In certain embodiments, the delay 440 before the start of the first video clip is controlled by system settings of the video production system 400 as described below in reference to FIG. 4F. In some embodiments, the durations of the pauses 441A-N following each video clip are determined in the switches database 405 as described above in reference to FIG. 4D.

In various embodiments, a plurality of video clips 430A-N are recorded and produced during the interview session 450. There can be a delay 440 from the start of the interview to the start of the first video clip 430A, unrecorded periods 441A-N between each video clip 430A-N, and an unrecorded period 443 near the end of the interview. This process of recording can provide for the production of multiple short video clips during an interview session 450. In certain embodiments, the number of video clips produced in an interview session can be determined by a system setting of the video production system 400. If the number of video clips per session is set to 4, then there will be 4 video clips recorded in one interview session 450 for a client 222. Once all the video clips 430A-N in one session have been recorded, the recording stops automatically. The recording will restart with the beginning of a next session, e.g., a new client, and will begin with a next video clip. For example, if a first session 460A for a first client 222A is executed with the recording of three video clips 430A-C, a second session 460B for a second client 222B can result in the production of video clips 430D-F.

Prior to, during, or after the video production system 400 generates a video clip, the video clip can be amended to include information that contains the client name, client number, and/or other information that enables the video networking system 5 to allocate the correct video clips 430A-N to the correct client account. The video clips and/or added information can be encrypted or not encrypted before transmission from the studio 113 over a network 104. In various embodiments, the client's video clips are provided to the video networking system 5, e.g., uploaded over the network 104, for accessibility to the client 222. In certain embodiments, the video clips 430A-N are automatically amended to include client information, processed for transmission to video networking system 5, and transmitted at the conclusion of an interview, so that the client 222 can have immediate access to the video clips. Immediate processing and transmission can maximize the efficiency of video clip posting and allow clients to instantly review the final product once the interview is completed.

In various embodiments, the client 222 reviews video clips, produced during an interview session 450, online and chooses the most favorable ones to include in a client video. Since the production of the video clips 430A-N comprises an automated or semi-automated process, and despite following researched filming guidelines and methods described about that should provide a high quality product, some video clips can have sub-optimal quality given the unpredictability of the conversations and individual characteristics during the interview session 450. A quality control mechanism is therefore helpful in establishing a satisfactory client video. To this end, each client 222 is provided with multiple video clips interspersed by pauses. Each client can review the video clips online to select one or more preferred video clips according to his/her taste and liking to include in a client video. The client 222 can then provide the quality control mechanism for final production of a satisfactory client video. By providing the client 222 with N video clips, there are at least N chances of producing a quality client video from the interview.

FIG. 4E is a flow diagram of an embodiment of video production software depicting certain operations 498 and settings 499 of the software. The video production software can be designed to facilitate a smooth and easy client experience focused on minimizing steps for both the host 220 and client 222. In certain embodiments, the host launches 480 software of the video production system 400 and scans 482 a first V-ticket 111A, e.g., scans a barcode on the V-ticket, provided by a first client 222A to identify topic codes 145_{PQR1-N} for the first client. In some embodiments, upon scanning of the V-ticket, the recording and production process associated with the first client's interview automatically starts. The host 220 and client 222A then participate in the interview until its completion. The filming and video clip production can end automatically according to settings of the video production system 400. When a second client 222B arrives for an interview, the host 220 can scan a second provided V-ticket 111B and the recording and production again can start and stop automatically. The process can be repeated for each client. When the host 220 has completed all interviews for one day, he/she closes 484 the application. The video production system 400 also includes settings modification functionality 499 which can be used to modify setting which affect the recording and video clip production process. The settings modification functionality 499 can be accessible through a menu 481 and the entering of a password 485. The settings modification functionality 499 can allow a user to select 487 a desired topics database 150 and/or select 488 a camera switch sequencing database 405, and/or select 489 a logo file linked to the video production system 400. Once a database is selected, the selected database is linked via linking step 490 to the video production system 400, and can be accessed to retrieve a plurality of parameters, commands and information as may be needed or used by the system. A system user can also modify 486 a series of settings 471 and save 495 the new settings for use by the video production system 400. In certain embodiments, the settings modification functionality 499 is only used to modify certain core settings of the video production system 400 and may only be rarely accessed by a host 220. In other embodiments, the information/data/parameters/commands contained in databases 150 and 405 may be incorporated into the application settings rather than separate files to be linked to it.

An example of modifiable settings are shown in FIG. 4F. Modifiable setting can include, without being limited to, number of video clips per session 470, delay between barcode scan and start of recording 440, fade-in and fade-out settings 413, which can include duration and rate of fade-in and fade-out, and video clips upload settings 473, which can include website backend source code to ensure a secure transfer of files from the video production system 400. FIGS. 4G-H depict embodiments of on-screen graphical user interfaces for operating the video production system 400 and modifying settings of the system.

FIGS. 6A-6C depict embodiments of methods for filming a producing client videos. FIG. 6A depicts a flow diagram of an embodiment of a method of producing a client video using the systems described herein. In certain embodiments, the method comprises: providing data to a client 222 for the selection of interview themes (step 605), generating data for a V-ticket (step 610); capturing video and switching cameras during the interview (step 625); generating video clips (step 630); uploading video clips to a usage platform (step 635); and providing access to video clips managed by the usage platform (step 640). The step of providing data to a client 605 can comprise providing data for registration to a subject or client 222. The provided data can comprise a graphical user interface through which a client 222 can provide registration data to the video networking system 5 and information for selecting conversation themes 144_{PQ1-N}. The step of generating data for a V-ticket 610 can comprise generating client-specific data to include with a V-ticket 111, as described elsewhere herein. The step of capturing video and switching cameras 625 is described in further detail below with reference to FIG. 6C. The step of uploading video clips 635 can comprise automatically uploading, by a computer 200, one or more video clips 430A-N produced by the video production system 400 to the usage platform 500A. The step of providing access 640 can comprise providing a user interface for a client 222 to access and review one or more video clips 430A-N.

FIG. 6B depicts a flow diagram of an embodiment of a method of making a video for networking according to the teachings herein. In certain embodiments, the method comprises: selecting interview themes (step 645), printing a V-ticket (step 650); visiting a studio (step 655); participating in a host-conducted interview (step 660); selecting online preferred video clips (step 665); and accessing a usage platform which manages the video clips (step 670). This method can be executed by a client 222.

FIG. 6C depicts an embodiment of a method 600A, for the video networking system 5. In particular, the method relates to camera switching and filming of a subject or client 222 undergoing an interview. In various embodiments, the method comprises: receiving (step 605A), by a computing device, a first video feed from a first camera having a first field of view of a subject undergoing an interview; identifying (step 610A), by the computing device, a first duration of a plurality of durations for receiving the first video feed from the first camera and switching to receiving a second video feed from a second camera, the second camera having a second field of view of the subject; and switching (step 615A), by a video switcher, the computing device to receiving the second video feed from the second camera responsive to receiving at least the first duration of the first video feed. In certain embodiments, the first field of view of the subjects comprises a view of a majority of the subject's body. The step of receiving 605A can further comprise receiving, by the computing device 200, a video stream or video and audio streams from a camera 210A. The stream or streams can pass through the switcher 412. The step of identifying 610A can further comprise providing to the switcher 412 data from a switching database 405 representative of a time duration for which a video stream from the first camera will be provided to the computing device 200. The step of switching 615A can further comprise configuring the switcher 412 to provide the video feed from the second camera to the computing device after the completion of the first duration. In certain embodiments, the step of switching 615A further comprises switching video feeds substantially immediately from the first camera to the second camera. In some embodiments, the step of switching 615A further comprises inserting a brief video fade-out and fade-in between the switching of video feeds from the first camera to the second camera. In some embodiments, the step of switching 615A further comprises inserting a brief video fade-out and fade-in and maintaining constant audio between the switching of video feeds from the first camera to the second camera. In some embodiments, the step of switching 615A further comprises an overlay video fade-out and fade-in between the switching of video feeds from the first camera to the second camera, e.g., fading out the first view of the subject while substantially simultaneously fading in the second view of the subject.

The method 600A can further comprise identifying (step 620A), by the computing device, a second duration of the plurality of durations for receiving the second video feed from the second camera and switching to receiving a first video feed from the first camera, and switching (step 625A), by the video switcher, the computing device to receiving the first video feed from the first camera responsive to receiving at least the second duration of the second video feed. In certain embodiments, the method 600A further comprises repeating steps 605A, 610A, 615A, 620A, and 625A, and combining (step 630A), by a video production system, a plurality of video segments from the first video feed and the second video feed to form a video clip.

### III.F. Usage Platform

The online video networking system 5 provides an intelligent usage platform 500A which provides for the broadcasting of client videos and client-generated content online. The usage platform also provides for online searching and browsing of client videos and client-generated content. The usage platform can comprise a web portal which provides for flexible manipulation and customization of client videos and client profiles. In certain embodiments, the usage platform grants public access to various features and data managed by the usage platform. In certain embodiments, the usage platform grants restricted access, e.g., access to registered clients only, to various features and data managed by the usage platform. A client 222 can use his/her client video and/or client generated content for social networking purposes via the usage platform. Multiple clients can use client videos and/or client generated content in a variety of contexts and situations such as social networking, business networking, and dating purposes.

The usage platform 500A can comprise a website or a web portal 100 in operation on a server 114. As an example, the usage platform 500A can comprise executable instructions and data, e.g., client profiles 134 and client videos, resident on a server 114 or on data storages devices or computing machines in communication with the server. Any or all of the executable instructions can execute on a processor of the server 114 or computing machine in communication with the server, or some executable instructions can be transmitted over the internet 104 to a client machine for execution thereon.

Referring now to FIG. 5A, a block diagram of an embodiment of the usage platform 500A is shown. In various embodiments, the usage platform 500A comprises one or more portals 502A-N, a user interface 514A, a searching module 520A, a posting module 530A, a client content manager 504A, and a client content database 505A. In certain embodiments, the usage platform 500A further comprises any combination of the following elements: a link manager 530A, a service manager 540A, a user profile manager 510A and user profile database 511A, an advertisement manager 506A and advertisement database 507A. Various components of the usage platform can be in communication with one or more other components of the platform as indicated by the dark traces linking components in FIG. 5A.

Any of the service manager 540A, link manager 530A, searching module 520A, posting module 530A, user interface 514A, client content manager 504A, user profile manager 510A, and advertisement manager 506A of the usage platform 500A can be separate components or modules, or can be combined in any manner in a single module or multiple combined modules. Any of the services, components or modules of the usage platform 500A can comprise any type and form of executable instructions, such as a program, application, process, task, service or library and may be implemented using any type and form of programming language, scripts or applications.

The usage platform 500A can run or operate on one or more servers 114, which is in communication with a network 104. The usage platform can provide a user interface 514A and one or more portals 502A-N to a plurality of users to register, access and use any of the services of the platform. A user can be a client of the video networking system 5, an administrator of the system, or an authorized user, e.g., a user authorized to provide and/or remove advertisements from an advertisement database 507A, or a user authorized to access a user profile database 511A. The usage platform can receive various types of content, e.g., client data, client video clips, client requests, metadata, advertisements, music, electronic mail, via a network 104 and portals 502A-N. The user interface 514A can include a content manager which processes or routes content, e.g., client data, client queries, advertisement data, etc., received or transmitted via network 104. The usage platform 500A can store one or more types of content. For example, client content can be routed to a client content manager 504A and stored in a client content database 505A. Advertisement data can be provided to an advertisement manager 506A for storage in an advertisement database 507A. The user interface 514A can also include a profiler which monitors a user's use of the usage platform 500A and creates a user profile, e.g., a record of a user's preferred settings of the system, selected links, selected ads, etc. The user profile can be stored in a user profile database 511A and managed by a user profile manager 510A. The client content manager 504A, advertisement manager 506A, and user profile manager can be used to manage, edit and control the content of their associated database. The service manager 540A can manage and provide to users applications for execution on the user's computing device or an intermediary computing device, e.g., an intermediary server. The service manager can also monitor operation of and services provided by the usage platform 500A and provide a record of service efficiency, service errors, and/or system use of the usage platform 500A.

In certain embodiments, the advertisement manager 506A provides an engine for controlling, managing and/or delivering advertisements from the advertisement database 507A to one or more users or clients 222 accessing the usage platform 500A. The advertisement manager can post ads via the user interface 514A. In some embodiments, the advertisement manager 506A selects ads from the advertisement database based on a user's user profile. The usage platform can provide an advertisement toolkit to allow marketers and advertisers to interface with the advertisement manager 506A. In certain embodiments, the usage platform creates and stores user metrics relating to a user's interaction with ads posted by the usage platform.

In further detail, the user interface 514A comprises an ingestion component to receive or ingest content. In some embodiments, the user interface 514A further comprises a transcoding component that transcodes received content. The ingestion component can provide an interface and mechanism for uploading or receiving content via any type and form of protocol. The ingestion component can include any type and form of executable instructions, logic or function for performing any of the ingestion operations described herein. In one embodiment, the ingestion component provides a browser-based media upload interface for uploading media via HyperText Transfer Protocol (HTTP) or File Transfer Protocol (FTP). In some embodiments, the ingestion component provides for bulk upload of multiple media files, assets or content from one or more sources, such as servers. For example, the ingestion component can use any type and form of bulk or batch FTP transfers to upload multiple media files. In certain embodiments, the ingestion component interfaces, integrates or communicates with an external system or application to obtain or transfer media. For example, the ingestion component may interface with a content management system (CMS) or a digital asset management (DAM) system. The ingestion component can provide any ingested content to any type and form of storage or memory accessed by the usage platform 500A internal or external to the platform.

In various embodiments, the usage platform 500A can receive content, e.g., client profiles 134, client video clips 430A-N, client data, client queries, advertisements, multimedia data, from any source. In some embodiments, the usage platform 500A receives content from a server via a network 104. In some embodiments, the usage platform receives content from a web site via a network. In some embodiments, the usage platform receives content of any type and form of Really Simple Syndication (RSS) feeds, such as publication of blog entries, news headlines and podcasts. In some embodiments, the usage platform receives content via any third party content provider. The usage platform 500A can receive ads from any type and form of advertiser, ad network, marketer or publisher.

The transcoding component includes any type and form of executable instructions, logic or function for converting media content from one format or codec to another format or codec. In some embodiments, the transcoding component automatically converts ingested media content to a predetermined format or codec for use by the usage platform 500A. In one embodiment, the process of transcoding comprises the digital-to-digital conversion of media from one format or codec to another format or codec. In some embodiments, the transcoding component upgrades, or converts a low definition video to a high definition video. In another embodiment, the transcoding component changes received media content from one bit rate to another bit rate, for example decreasing the bit rate of the received media. In some embodiments, the transcoding component converts from a lossless format to a lossy format. In other embodiments, the transcoding component decodes a first format into an intermediate format and then encodes the intermediate format into a second format. The transcoding component may support the encoding, decoding, conversion or translation of any media format and/or bitrate, including but not limited to Flash Video format (FLV) and Windows Media Video format (WMV).

The client content database 505A, user profile database 511A, and ad database 507A can be any type or form of storage to store data representative of received or platform-generated content. In one embodiment, a database comprises software and storage adapted for storing and managing data representative of received or platform-generated content. A database can reside on the server 114, or on another device that communicates with the server 114. In some embodiments, a database resides on multiple servers in a server farm.

The client content manager 504A provides any type and form of interface and mechanism for identifying, managing, maintaining, providing, or otherwise supporting the use of client content stored in the client content database 505A. The client content manager 504A can use any type and form of database or tracking system to identify and track the stored content. The client content manager can also include thumbnail generation and video sizing for generating a different sized version of a media file, e.g., a thumbnail of a client's video clip. In one embodiment, client content manager 504A automatically generates a thumbnail media file for any client content received and stored in the client content database 505A. In some embodiments, client content manager automatically generates one or more different versions of a media file, each having a different size. In some embodiments, the client content manager 504A receives a media file and modifies the media file to have a different size. In certain embodiments, the client content manager sizes the video based on the size and resolution of a display device on which the client content will be displayed.

In certain embodiments, the client content manager 504A performs metadata extraction and metadata management. The client content manager 504A can provide an interface and mechanism for extracting any information and/or metadata associated with received content, e.g., metadata transferred with a video. In some embodiments, the client content manager 504A automatically extracts or otherwise obtains metadata from media files. The metadata can include data identifying title or filename, client name, client number, production date, runtime, format and/or bit rate information regarding a media file.

The client content manager 504A can further comprise logic, function and/or operations to create, edit, modify or otherwise manage any information and/or metadata associated with client content stored in client content database 505A. In one embodiment, the metadata management service provides an interface to extend, create or provide metadata fields associated with client content, such as any of the following fields: title, short description, long description, professional interests, social interests, keywords, thumbnail, available date, expiration data and geography restrictions.

In certain embodiments, the advertisement manager 506A provides functionality and support to monetize delivery of internet-based advertisement content to a user accessing the usage platform 500A. The advertisement manager 506A can provide an interface and configuration mechanism to design, configure, or otherwise create and use any type and form of format for advertising. An ad may comprise any visual or graphical information, representation or display. An ad may include video, audio, data, text, graphics, pictures, HTML, DHTML, Flash or web page content, applets, programming language, scripts, uniform resource locators, web-based links, or any combination thereof. The ad format can include any type and form of video effects or overlays such as a bug style ad format or video curtain type of ad format. An ad format may specify the type, location, and duration of an ad. For example, an ad format may specify the ad as a pre or post-roll video. In some embodiments, the advertising formats include any of the formats supported, specified or identified by the Interactive Advertising Bureau (IAB) and/or any of the IAB standards or guidelines.

The advertisement manager 506A can interface, communicate and coordinate, e.g., via a portal 502, with any advertisement network provider or third party advertisement provider, also referred to as an ad network. An ad network can include any type and form of aggregator or broker of advertising inventory for many web sites. In one embodiment, the ad network includes any of the advertisement services and products provided by Lightingcast. In another embodiment, the ad network includes any of the advertisement services and products provided by DoubleClick. In some embodiments, the advertisement system interfaces to ad networks provided by Google or Yahoo. The advertisement manager 506A can include any type and form of application programming interface, programming language, and tools and use any type and form of one or more communication, networking or application layer protocols to interface or communicate with an ad network.

The user profile database 511A can comprise any type or form of database that stores information associated with users of the platform 500A. Information associated with a user can be collected by the user profile manager 510A, processed, and provided to the database 511A for storage. The user profile database 511A can include any type and form of attribute, characteristic or information regarding each user. In some embodiments, the user profile manager 510A monitors each user's interaction with the usage platform 500A via the user interface 514A and gathers data to creates user profiles for each of the users. The user profile manager 510A can format the collected data for storage in the database 511A.

The user interface 514A can comprise any type and form of user interface for providing, displaying or otherwise accessing the functionality, services, logic or operations provided by the usage platform 500A. In various embodiments, clients 222 interact with the usage platform 500A through the user interface 514A. As an example, a client 222 can provide client information, preferences, client-generated data, queries, and review video clips or client videos via the user interface 514A. In some embodiments, one or more users access the user interface 514A through web portals 502A-N. In various embodiments, the user interface 514A comprises a graphical user interface, a web based user interface, or a browser-based interface.

In various embodiment, the usage platform 500A provides online a plurality of services and functionalities, e.g., those depicted in FIGS. 5A-5D. As illustrated in FIG. 1B, a server can host data and applications for the website or web portal 100, e.g., a client generated content (UGC) database 117, a video clip database 119, a post information module 102, and a browse information module 106. The usage platform 500A can also include services such as e-mail, news and weather services. In certain embodiments, the server 114 provides video streaming capabilities. In some embodiments, the server 114 comprises a shared server, e.g., a server farm, cloud or other shared site or portal hosting solution. In some embodiments, the server comprises a private server. In various embodiments, the server 114 provides online access to studio computers 200, hosts 220 and clients 222 to various features of the video networking system 5. In various embodiments, the usage platform can be configured for different presentations to users of the usage platform.

FIG. 5B is a block diagram of an embodiment of a usage platform 500 according to client type. Clients having undergone an interview and having viewed online and selected their favorite video clips can create online one or more online profiles using the usage platform. Clients can also assign different privacy levels to various user-generated-content and client videos. For example, a client can create a “public profile”, a “professional profile” and a “personal profile.” Registered members of the video networking system 5 will be able to add client generated content to their profiles or alter their profiles at any time.

Users of the usage platform can be members 504 or non-members 502 of the video networking system 5. Clients having undergone the registration process can be members 504. However, in certain embodiments, non-members 502 can use the usage platform without prior registration. In some embodiments, non-members 502 can access the web portal 100 and perform searches using a limited search engine 503. In some embodiments, non-members can access the search tool 503 to perform limited or unlimited searches for profiles according to a name entry tool 512, key word(s) entry tool 514, and/or image recognition entry tool (not shown), and can view the public profiles of the clients identified by the search tool 503 using a public profile tool 516. The non-members search can be limited to the information designated as “public” by members 504. Non-members 502 can be granted access to browse and view the “public” information of members 504, and send members a message. In certain embodiments, non-members 502 can also utilize a send messages tool 510 to send a message to any one, some, or all clients identified in the search results. Non-members can also be provided access to the registration module 101 for the purposes of registering and becoming a member of the video networking system 5.

Users having gone through the registration process can automatically become members 504. Members be provided with greater information management functionalities 505, e.g., they can manage their privacy settings using a privacy settings tool 517, send and receive messages using a communications tool 518, pre-authorize invitation acceptance from a category of other members using an acceptance tool 520, e.g., pre-authorize acceptance of all invitations from members working for a specific company, send multiple invitations with a multiple invitations tool 522, upload client generated content with a content modification tool 528, and upload client generated media files with a media files tool 530. Additional or fewer information management tools can be provided to members by the usage platform, and the tools can be upgraded, phased in and phased out over time. In various embodiments, members can also perform various types of searches using a member search module 507. Members 504 can access the web portal 100 and perform a search using a member search engine 507. A member's search can spans the “public” information of other members, the “professional” information of other members in the member's own professional network, and the “personal” information of other members in the member's own private network. As an example, a member can search client profiles according to name(s) of other members using a name search tool 512, search for keyword(s) and/or phrase(s) appearing in the profile of other members using a keyword search tool 514, can view public profiles using a public profile tool 516, can view the professional profiles of other members in the member's own professional network using a professional profile tool 516, and can view the private profile of other members in the member's own private network using a private profile tool 540. Members can find and browse other members' profiles, e.g., videos and client generated content, can browse the “public” information in the profiles of other members, and can send to and receive from other members one or more messages. If a member 504 has completed a registration process, e.g., chosen a number of conversational themes and been assigned a number of conversational topics which are encoded on a V-ticket, but has not participated in a video interview, the member can still be part of a network. However, the member's client profile will not contain a client video and may not appear in certain search results. In some embodiments, a client can choose to substitute one or more still photos or videos filmed by the client for the client video.

In various embodiments, members can assign privacy levels to the information they provide to the video networking system 5 for subsequent posting online An example of a graphical user interface which can be used to assign privacy levels to various types of client information is shown in FIG. 5E. Members can choose from a plurality of privacy levels to assign to a plurality of networks, e.g., three privacy levels corresponding to three networks. As an example, a member can construct “public,” “professional,” and “personal” networks with corresponding privacy settings. A public network can grant access to a member's own public-designated information to all users of the usage platform weather they are members 504 or non-members 502. A professional network can grant access to a member's own professional-designated information to only those other members belonging to the member's professional network. A personal network can grant access to a member's own personal-designated information to only those other members belonging to the member's personal network. Additional networks, e.g., “family,” “church,” “team,” “reading group,” can be created by a member 504, and any network can be deleted by a member. Each network added by a client can generate a new privacy setting for designating a privacy level of client information. In various embodiments, the setting of privacy levels for a member's information determines the visibility of that information to the various networks. The usage platform can also include a contact information tool for setting privacy levels for various modes and information permitting another member to contact the member, as depicted in FIG. 5E.

In various embodiments, the usage platform provides an invitation tool 522 which is configured to allow any member 504 to invite one or more other members to one or more of the member's networks, e.g., personal and professional networks. In certain embodiments, guests are required to register into the networking system 5, if a non-member 502, to accept invitations by members and join the network to which they were invited. In certain embodiments, members are permitted access to see who belongs to another member's professional network. In some embodiments, when a guest joins a member's network, the guest will be permitted access to all information of all members belonging to the network which the members have designated with a privacy level for that network. For example, members that belong to a professional network of the inviting member have visibility into content that has been made visible to the professional network by each network member's “professional” privacy settings. As another example, members that belong to a private network of the inviting member have visibility into content that has been made visible to the private network by each member's “private” privacy settings. In some embodiments, each member can govern whether each member of a network is permitted to see who else belongs in the network.

FIG. 5C is a block diagram of an embodiment of the usage platform 582 according to basic functionalities. In certain embodiments, basic functionalities of the usage platform comprise (1) posting information with a posting tool 550, whereby a client 222 can post client-generated-content and media in addition to the produced client video, and (2) searching for information with a searching tool 559, whereby clients search online for and browse other members' profiles. Posting information on the usage platform can be used for business or professional networking purposes 552, e.g., by companies 553, professionals 554 and students 555, as well as for personal networking purposes, e.g., for social relationship 557 and dating 558. Searching profiles on the usage platform can be done for business or professional networking purposes 560, for companies 561, professionals 562, and students 563, and for personal purposes 564, e.g., for social relationships 565 and dating 567.

FIG. 5D is a block diagram of an embodiment of the usage platform 584 according to client type. The usage platform can be used by companies 585, Professionals 586 Students 587, singles 588 and employers 589. Further aspects of the usage platform 584 according to client type are described in the applications below.

### III.G. Applications

Client videos produced with the systems and according to the methods described herein can be included in a client profile 134 for managed distribution by the video networking system 5. The videos and client profiles can be used in a variety of contexts and for a variety of purposes such as social networking, business networking, intra-company cross-office networking, dating, and recruiting. Examples of uses and applications are described in this section.

### III.G.1. Usage by Client Type

In certain embodiments and in reference to FIG. 5D, the usage platform 584 provides companies 585 services comprising cross office staffing 590, cross-office collaborations 591, employee-client relationship management 593, and improved HR utilization 594. Companies that have multiple offices across different cities, states or countries can leverage the video networking system 5 as a tool to better connect its employees with each other. The usage platform 584 can be particularly useful in cross-staffing situations such as when an employee is needed to work as part of a team in another office. When selecting an employee from another office, some assurance that there will personal affinity amongst the other team members is often desired and can be important to allow a fast integration of the employee and reduce ramp-up time. Companies that span many locations often demand employees from different cities to work together in a cross-office collaborative environment. In such situations, having a sense for the other team members' personalities can be especially helpful for all team members. Such familiarity or compatibility would allow for a more efficient team dynamic and could increase productivity.

In some circumstances, clients of a company do not meet the company's employees despite interacting with them extensively and regularly over email and phone. The online video networking system 5 can help give a client of a company a sense for the employees they are working with, resulting in improved client -employee loyalty and overall client-company relationship management.

Through the ability of quickly gaining insight into employee personality and soft skills, companies can improve their human resource utilization which can boost their overall productivity.

In certain embodiments and in reference to FIG. 5D, the usage platform 584 provides professional 586 services including, but not limited to, cross-geographical work opportunities 595, cross-geographical collaboration opportunities 596, self promotion to employers 597, business networking opportunities 598, and client relationship management 593. Professionals seeking to work outside of their own geographical area might benefit from the online video networking system 5, because the usage platform allows their potential clients to gain a level of familiarity with the professional by making an online personality assessment. Professionals and geographically remote clients can therefore have an opportunity to forge much stronger client-relationships. Professionals seeking to collaborate on projects with other professionals may find the video networking system 5 very helpful for developing a sense of those they are working with. The video networking system 5 can facilitate a smoother interaction, an improved relationship and more productive collaboration. Professionals can advance their careers through finding attractive positions at new companies with the ability of communicating online to potential employers their soft-skills and personality traits. Professionals lacking time and resources to travel to professional organization networking events may find the video networking system 5 helpful for participating in virtual networking opportunities through searching for other professionals with specific criteria and screening them through their videos. Professionals can use the video networking system 5 as a powerful tool to attract clients by communicating certain personal characteristics via the client video to potential clients. Such a tool can improve client attraction and loyalty and may avoid the need for numerous in-person meetings, reducing costs. Professionals can also assess potential clients to determine whether the client should be accepted in a business relationship.

In certain embodiments and in reference to FIG. 5D, the usage platform 584 provides student 587 services including, but not limited to, self-promotion to employers 597, social networking 572, business networking 598 and job hunting and company selection 595, and study opportunities 573. The video networking system 5 can provide improved self-promotion to potential employers and result in a better success rate at interviews through pre-screening. The video networking system 5 can provide an effective and efficient social networking tool for students to seek out classmates or colleagues at an academic institution. The video networking system 5 can provide for better selection of potential employers through screening employees working at a specific company.

In certain embodiments and in reference to FIG. 5D, the usage platform 584 provides singles 588 services including, but not limited to, dating 571. Singles seeking to meet other singles may find the video networking system 5 especially helpful in screening potential companions. The video networking system 5 can provide a much better screening tool than certain traditional processes using still pictures. By using the online video networking system 5, singles can make much better selections of people online and avoid false positives (avoiding bad surprises) as well as false negative (missing a potentially fruitful encounter).

In certain embodiments and in reference to FIG. 5D, the usage platform 584 provides employer 570 services including, but not limited to, recruiting 571. Employers can benefit from performing advanced searches to find potential candidates. The video networking system 5 can be especially helpful in screening such candidates to avoid interviews with candidates with whom there is little personal affinity.

### III.G.2. Examples

The following examples indicate how the video networking system 5 can be used for personal gain.
1. Mike is looking for a job:
Mike would like to find the right job for himself. He can't seem to find a good match despite the numerous interviews he gets offered. He posted a link to his video on a job search website, and got an email from an employer that was very impressed by his calm, focused, and confident demeanor. The employer had a good idea what Mike was like before inviting him for an interview, which went more smoothly than previously. The expectations were aligned before the meeting, and the interview confirmed the match.
2. Rachel would love to work on a NYC project:
Rachel works in the Montreal office, and would like nothing more than being staffed on a project out of NYC. She cant seem to get the NY managers to pick her for their projects despite her qualifications. She sent the NY managers an invite to her network and after seeing her video they just loved her outgoing personality. In fact she would be the perfect person to manage a difficult client they are dealing with right now. Off she goes to NY.
3. George is sure that Mary is a perfect match for Joe:
George has been telling Joe about Mary for the past year, but he cant seem to be able to convince him to meet with her. Joe is skeptical. George needs to show Joe what Mary is like. George tells Joe to check Mary's video online. Joe is convinced! Mary is charming, friendly, and Joe just loves the way she smiles.

### III.G.3. Business Considerations

There are three market categories that can generate financial opportunities from the video networking system 5 described herein. These markets categories can include (1) direct, (2) indirect, and (3) derivative markets.

Direct markets can generate revenues from client video and client information sales. Sales can be generated from clients 222 interested in posting their client profiles online for professional or personal reasons and performing basic searches. Sales can also be generated from corporations, professionals, and students. Corporations wishing to have videos of their employees online and make use of the usage platform can subscribe to the video networking system 5. Professionals wishing to have videos of themselves online and make use of the usage platform can subscribe to the video networking system 5. Students wishing to have videos of themselves online and make use of the usage platform can subscribe to the video networking system 5.

Indirect markets can generate revenues from membership sales for products providing additional functionalities within the video networking system 5. For example, clients 222 mainly interested in certain advanced search functionalities, e.g., business recruiting or dating functionalities, could subscribe to advanced search or networking functionalities in these areas. Employers can benefit from performing advanced searches to find potential candidates. An advanced searching tool can be particularly helpful in screening candidates to avoid multiple in-person interviews with candidates with whom there is little personal affinity. Singles seeking to meet other singles may find advanced searching tools especially helpful in screening potential companions. In various embodiments, advanced searching tools for the video networking system 5 can provide improved screening techniques compared to traditional processes which utilize pictures and CV's or resumes.

Derivative markets can generate revenues from advertisement contracts, sales of reports, and sales of specialized data. Such revenue can come form clients 222 interested in taking advantage of data collected by the video networking system 5 and the traffic generated. For example, corporations may wish to post advertisements for viewing by targeted audiences. Additional derivative sales can be related to data mining, e.g., production of marketing reports that could be useful to companies' marketing divisions, organization visibility, e.g., affiliate marketing programs to gain further visibility with a targeted population on the web, and sponsorships, e.g., sponsorships by companies desiring to gain visibility and credibility as employers of choice on the web.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

We claim:

1. A method of producing a video clip of a subject by automatically switching between a plurality of cameras having different fields of view of the subject, the method comprising:
(a) receiving, by a computing device, a first video feed from a first camera having a first field of view of a subject;
(b) identifying, by the computing device, a first duration of a plurality of durations for receiving the first video feed from the first camera; and
(c) switching, by a video switcher of the computing device responsive to receiving at least the first duration of the first video feed from the first camera, to receiving the second video feed from the second camera, the second camera having a second field of view of the subject.

2. The method of claim 1, further comprising steps of:
(d) identifying, by the computing device, a second duration of the plurality of durations for receiving the second video feed from the second camera; and
(e) switching, by the video switcher, the computing device to receiving the first video feed from the first camera responsive to receiving at least the second duration of the second video feed.

3. The method of claim 2, further comprising:
repeating steps (a)-(e); and
storing, by a video production system of the computing device, a plurality of video segments from the first video feed and the second video feed to form a video clip.

4. The method of claim 2, further comprising directing, by the computing device, the second camera to perform one of a fade-out or a fade-in on the subject.

5. The method of claim 1, wherein step (a) further comprises initiating, by the computing device, receiving of the first video feed at one of a predetermined point or a random point during a communication by the subject.

6. The method of claim 1, further comprises directing, by the computing device, the first camera to perform a fade-in on the subject upon initiating the receiving of the first video feed.

7. The method of claim 1, wherein step (b) further comprises determining, by the computing device, a random duration for the first duration.

8. The method of claim 1, wherein step (b) further comprising obtaining, by the video switcher, the first duration from the plurality of durations stored in a database.

9. The method of claim 1, further comprising controlling, by the computing device, one of a rate or a duration of fade-in or fade-out of the first camera or the second camera.

10. The method of claim 1, wherein the first field of view is directed to the subject's body and the second field of view is directed to the subject's head.

11. The method of claim 1, further comprising generating, by a video production system of the computing device, a video clip from a combination of at least the first duration of the first video feed and at least the second duration of the second video feed.

12. A system for producing a video clip of a subject by automatically switching between a plurality of cameras having different fields of view on the subject, the system comprising:
a computing device receiving a first video feed from a first camera having a first field of view on a subject, the computing device in communication with a second camera having a second field of view of the subject;
a switcher identifying a first duration of a plurality of durations for receiving the first video feed from the first camera; and
wherein responsive to receiving at least the first duration of the first video feed from the first camera the switcher switches the computing device to receiving the second video feed from the second camera.

13. The system of claim 12, wherein the switcher identifies a second duration of the plurality of durations for receiving the second video feed from the second camera and receiving the first video feed from the first camera responsive to receiving at least the second duration of the second video feed.

14. The system of claim 13, wherein a video production system of the computing device stores a plurality of video segments from the first video feed and the second video feed to form a video clip.

15. The system of claim 13, wherein upon switching to the second camera the computing device directs the second camera to perform one of a fade-out or a fade-in on the subject.

16. The system of claim 13, wherein the computing device initiates receiving of the first video feed at one of a predetermined point or a random point during a communication by the subject.

17. The system of claim 12, wherein the computing device directs the first camera to perform a fade-in on the subject upon initiating the receiving of the first video feed.

18. The system of claim 12, wherein the computing device generates a random duration for the first duration.

19. The system of claim 12, wherein the computing device obtains the first duration from a database storing the plurality of durations.

20. The system of claim 12, wherein the computing device controls a rate of fade-in or fade-out upon switching between the first camera and the second camera.

21. The system of claim 12, wherein a video production system of the computing device generates a video clip from storing at least the first duration of the first video feed and at least the second duration of the second video feed.
